(19) United States
(12) Patent Application Publication
(10) Pub. No.: US 2026/0061606 A1
(43) Pub. Date: Mar. 5, 2026

(54) FORCE SENSITIVE END EFFECTOR

(71) Applicant: Aescape, Inc., New York, NY (US)

(72) Inventors: Eric A. Litman, Brooklyn, NY (US); James S. Bowen, Long Branch, NJ (US); Nicholas Akiona, New York, NY (US); Kamil Taufique Saigol, New York, NY (US); Andrea Bajo, Washington, DC (US); Cynthia Lynne Morgan, New York, NY (US)

(21) Appl. No.: 19/259,944

(22) Filed: Jul. 3, 2025

Related U.S. Application Data
(63) Continuation-in-part of application No. 18/368,411, filed on Sep. 14, 2023.
Application No. 18/368,411 is a continuation-in-part of application No. 18/184,825, filed on Mar. 16, 2023, now Pat. No. 12,214,509.
(60) Provisional application No. 63/668,105, filed on Jul. 5, 2024.

(51) Int. Cl. B25J 9/16

(52) U.S. Cl. CPC B25J 9/1633

(57) ABSTRACT

A robotic massage system includes a robotic arm. An end effector is positioned at the end of the robotic arm. The end effector includes a plurality of contact sensors embedded in the end effector. The robotic arm is controlled to engage a deformable body with the end effector. The force sensors embedded in the end effector provide force feedback indicating a contact patch where the end effector is contacting the deformable body.

### CROSS REFERENCE TO OTHER APPLICATIONS

This application is a continuation in part of U.S. patent application Ser. No. 18/368,411 entitled ROBOTIC MASSAGE END EFFECTOR filed Sep. 14, 2023, which is incorporated herein by reference for all purposes, which is a continuation in part of U.S. patent application Ser. No. 18/184,825 entitled ROBOT SYSTEM TO PERFORM COORDINATED BODY WORK filed Mar. 16, 2023, now U.S. Pat. No. 12,214,509 which is incorporated herein by reference for all purposes.

This application also claims priority to U.S. Provisional Patent Application No. 63/668,105 entitled FORCE SENSITIVE END EFFECTOR filed Jul. 5, 2024 which is incorporated herein by reference for all purposes.

### BACKGROUND OF THE INVENTION

Being able to sense force is important in the context of interaction of a robot with a deformable body, such as when performing a robotic massage. It would be beneficial to have more accurate force sensing to facilitate delivering higher quality treatment.

### BRIEF DESCRIPTION OF THE DRA WINGS

Various embodiments of the invention are disclosed in the following detailed description and the accompanying drawings.

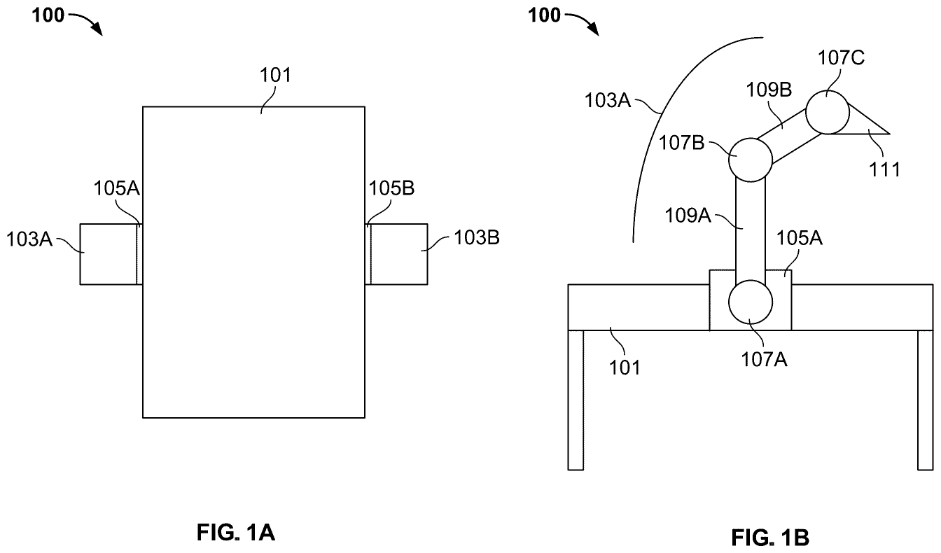

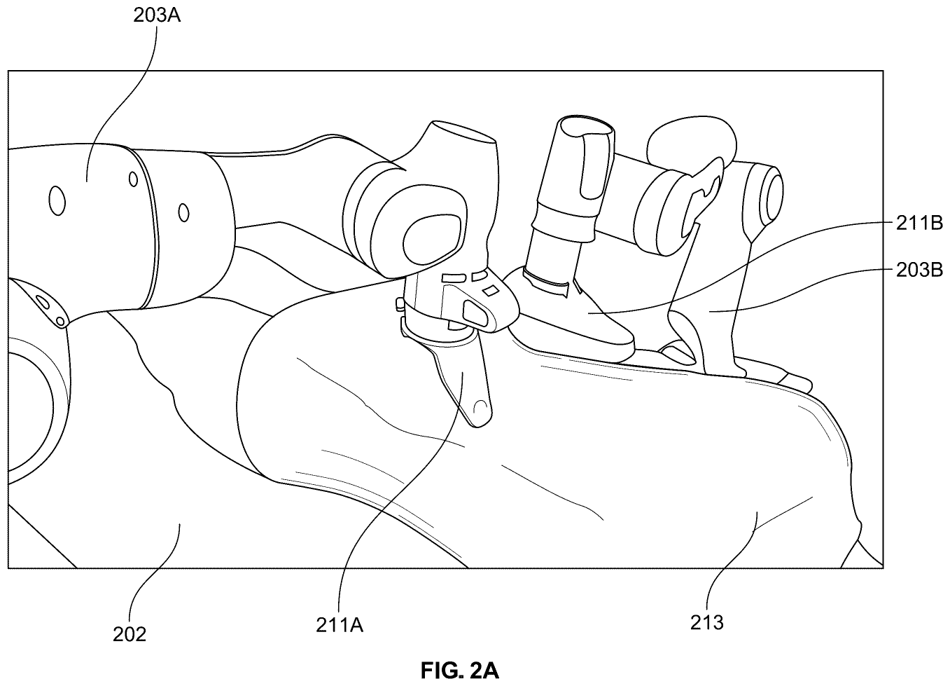

FIGS. 1A-1B show top and side views, respectively, of a robot system that can be used to perform a massage, according to an embodiment.

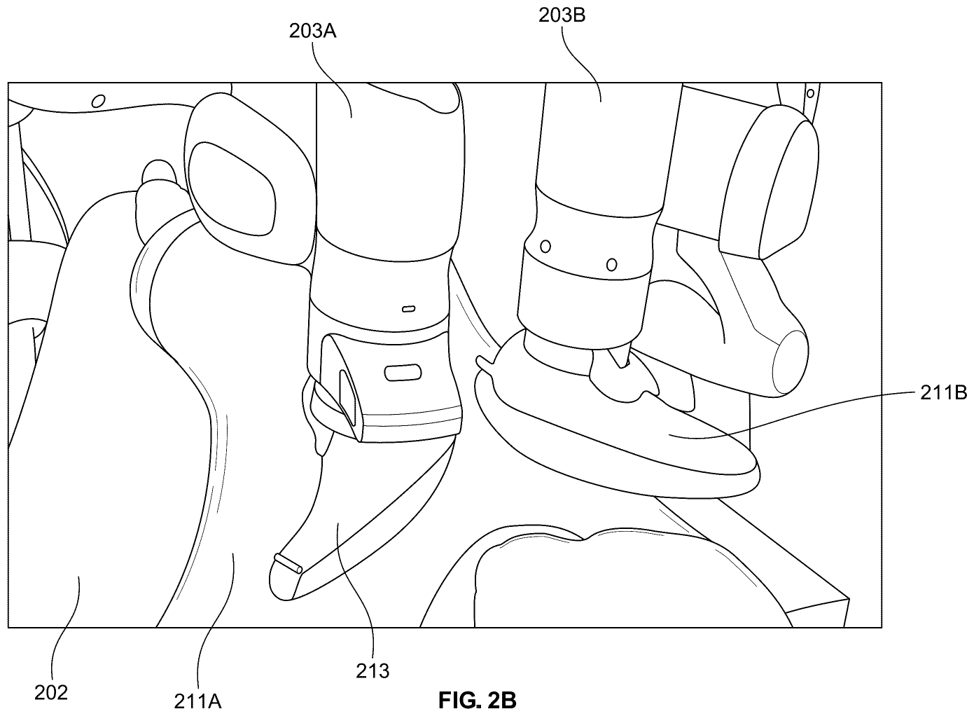

FIGS. 2A-2B show example illustrations of portions of a robot system including two robotic arms, according to an embodiment.

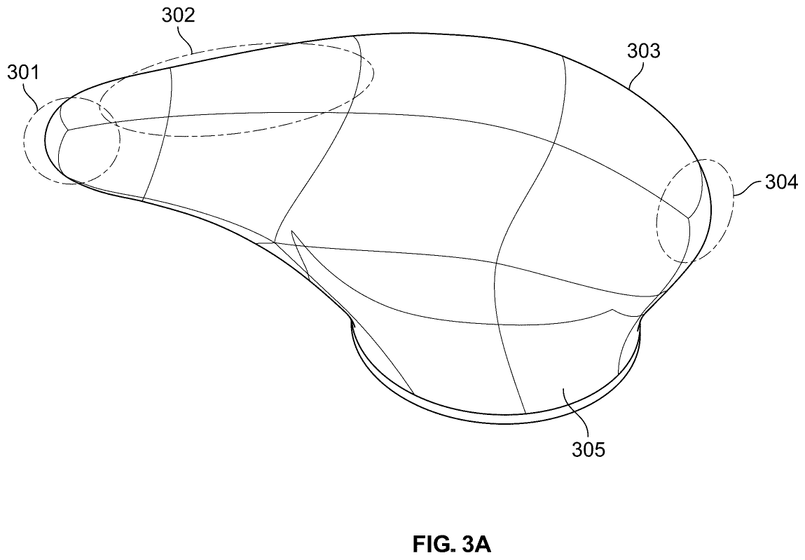

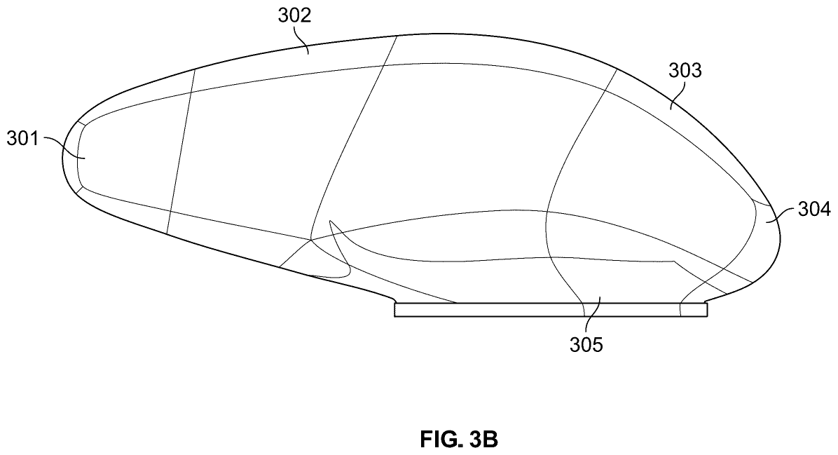

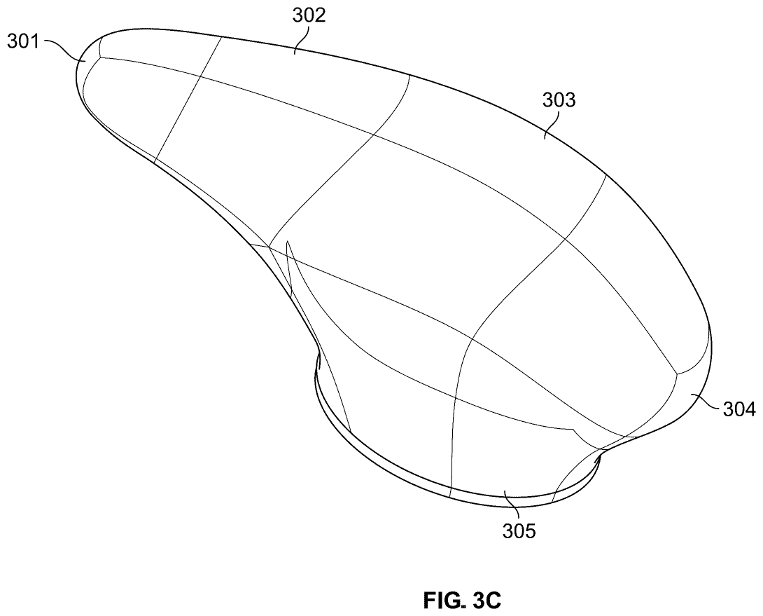

FIGS. 3A-3C show various perspective views of an end effector, according to an embodiment.

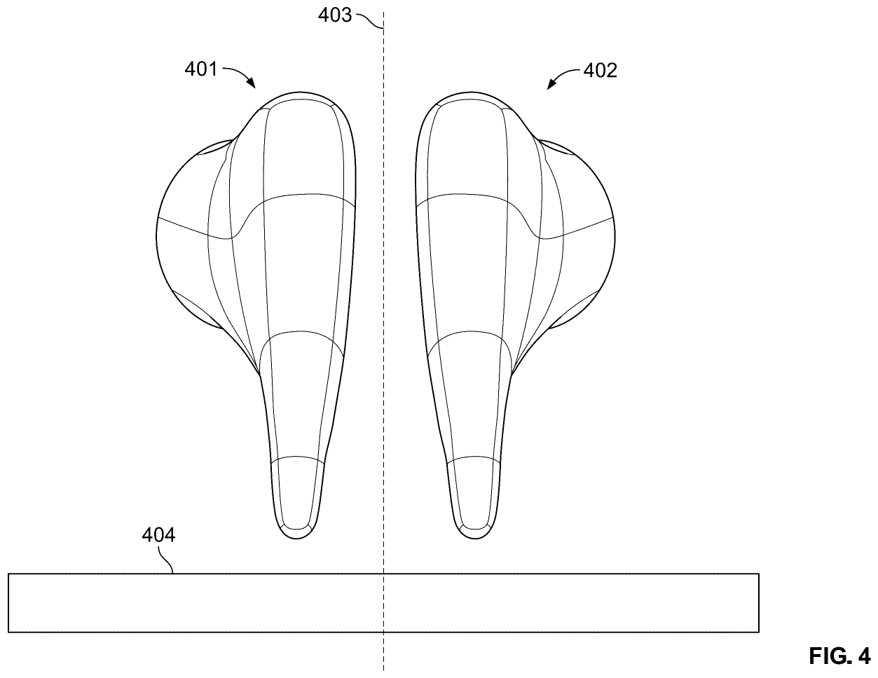

FIG. 4 shows end effectors mirrored across a plane perpendicular to a table, according to an embodiment.

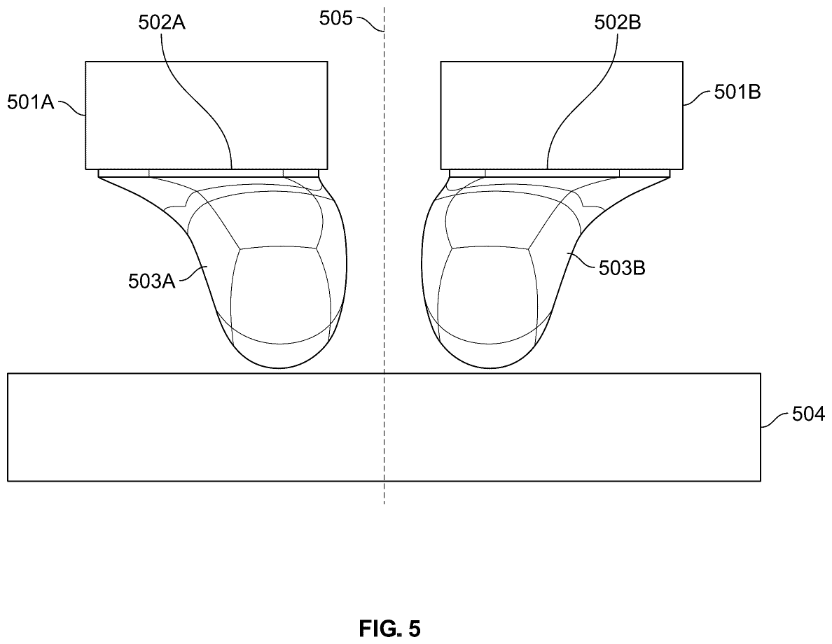

FIG. 5 shows end effectors coupled to links of robotic arms via end effector flanges, according to an embodiment.

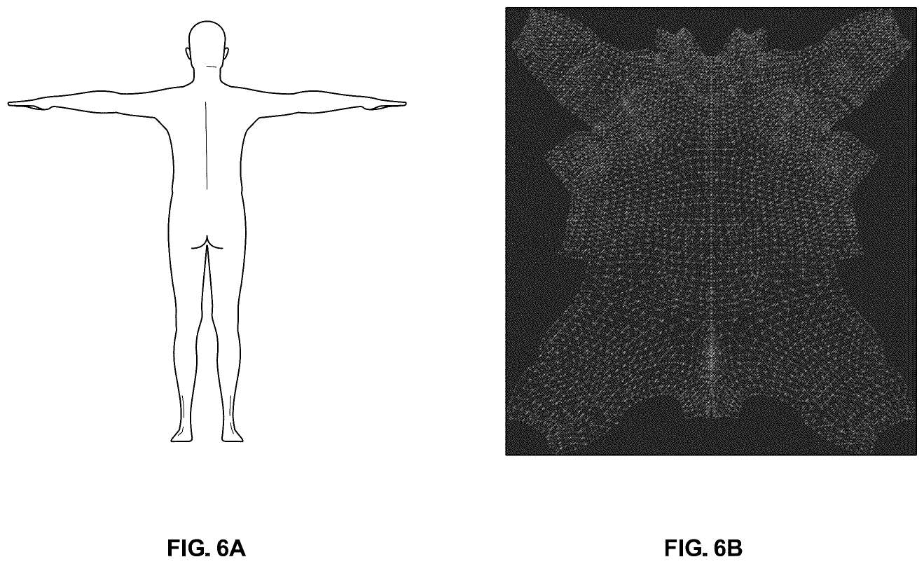

FIGS. 6A-6B show an example of a three-dimensional (3D) structural representation of a human body, and a two-dimensional (2D) texture map of the human body, respectively, according to an embodiment.

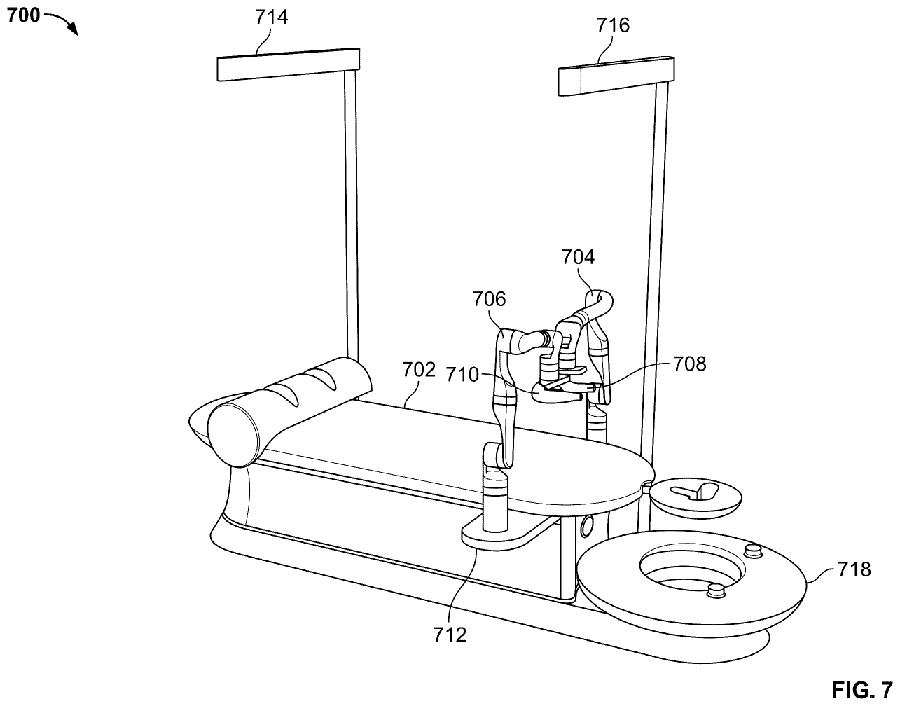

FIG. 7 illustrates an embodiment of a robotic massage system.

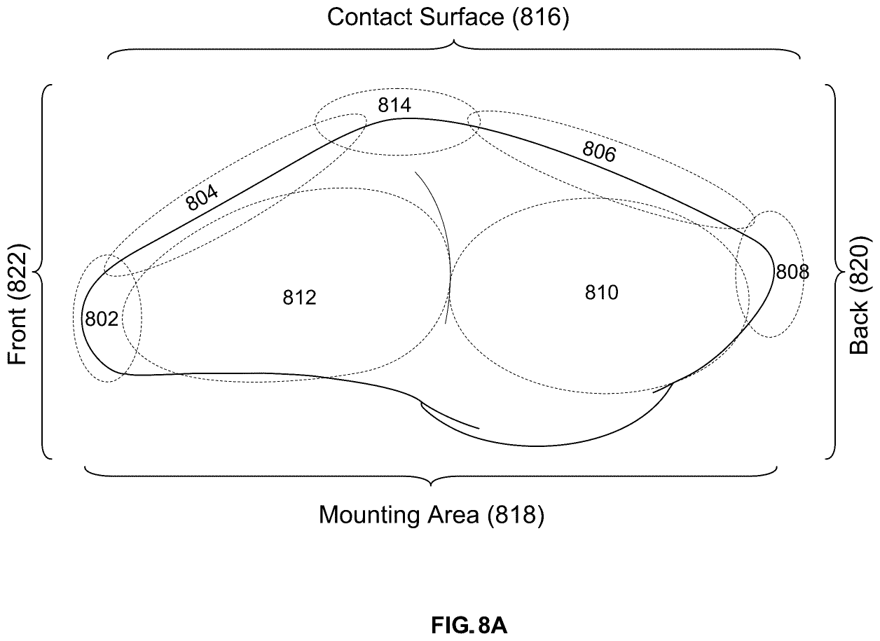

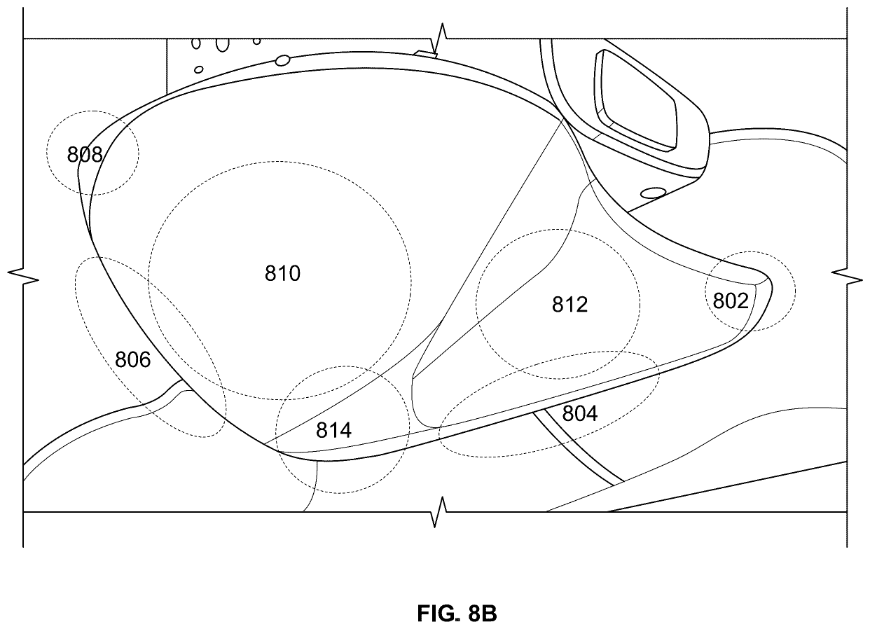

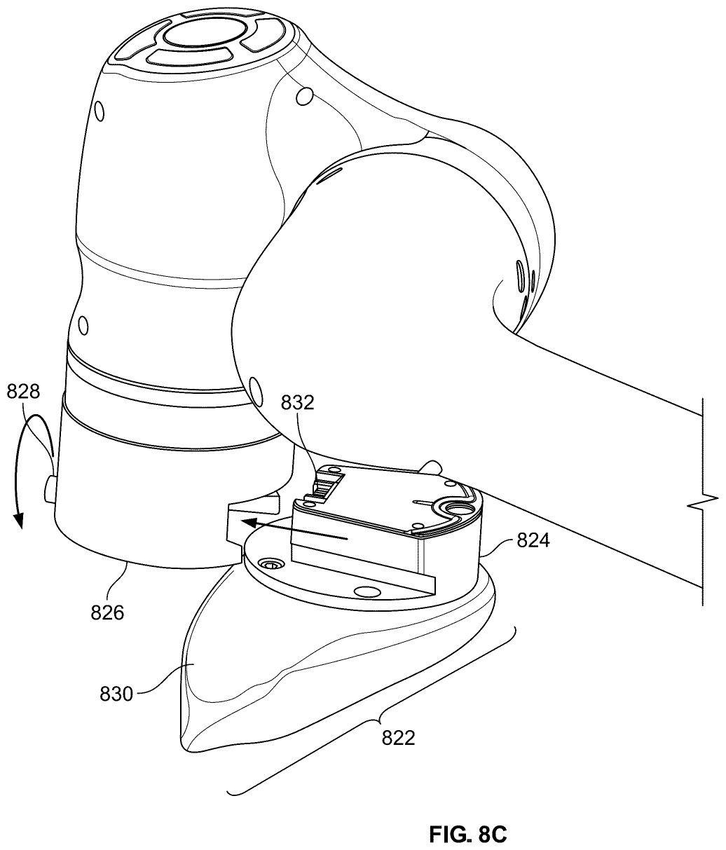

FIGS. 8A-8B illustrate embodiments of an end effector.

FIG. 8C illustrates an embodiment of an end effector mounting mechanism.

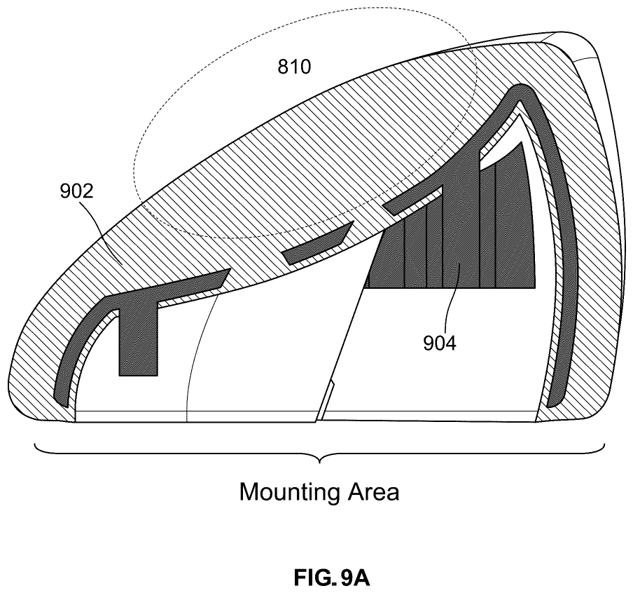

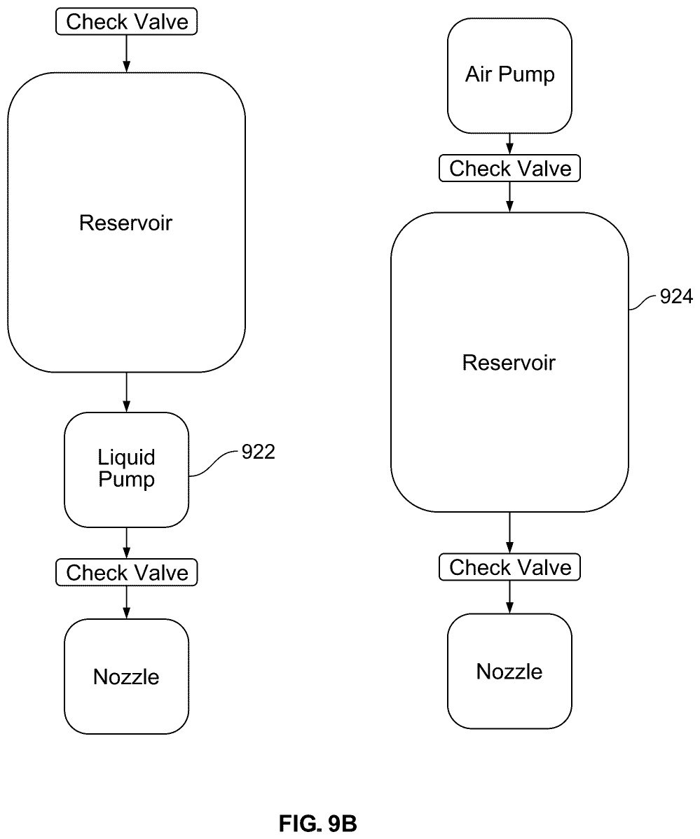

FIG. 9A illustrates an embodiment of exterior material thickness of an end effector.

FIG. 9B illustrates embodiments of a variable lubricant sprayer architecture.

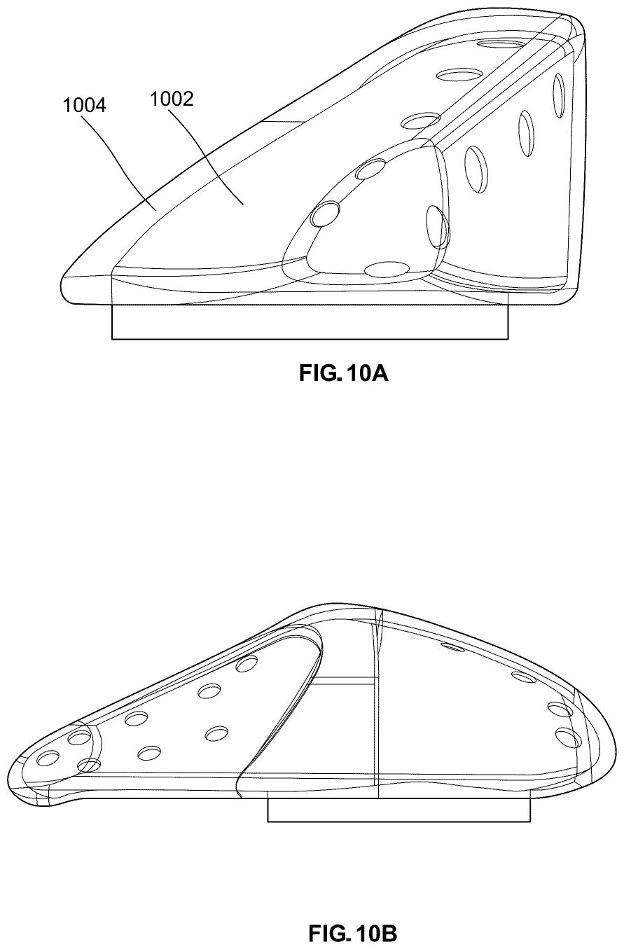

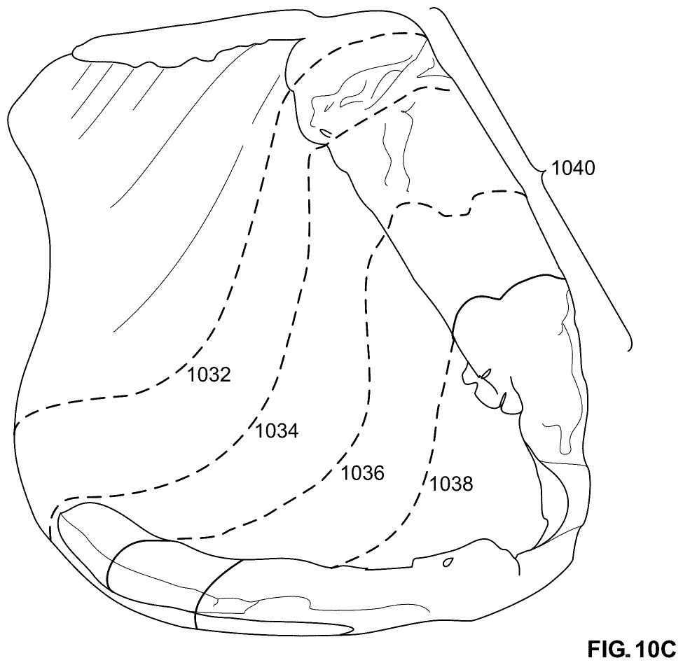

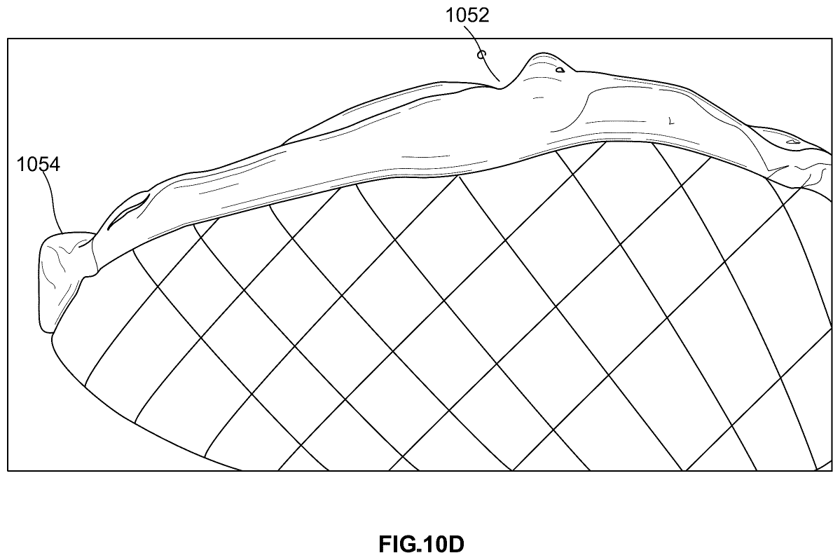

FIGS. 10A and 10B illustrate embodiments of views of an end effector.

FIG. 10C illustrates an embodiment of a topography of an internal structure of an end effector.

FIG. 10D illustrates an embodiment of shaping of an internal structure of an end effector.

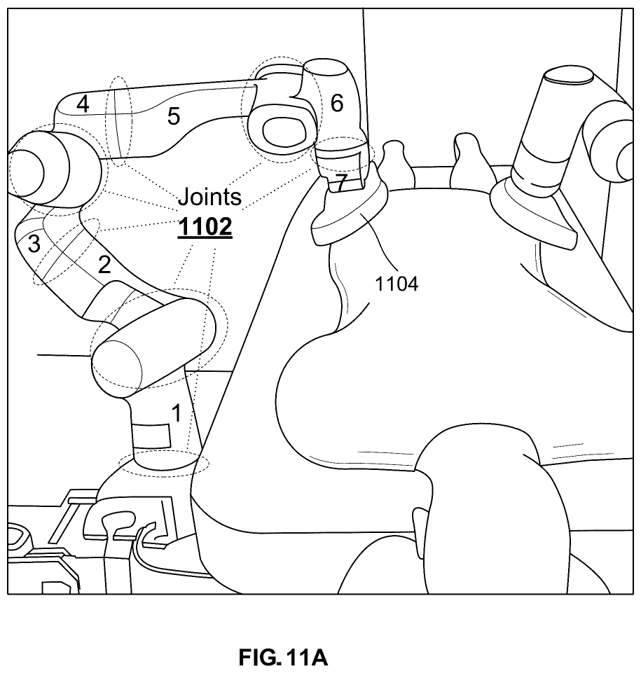

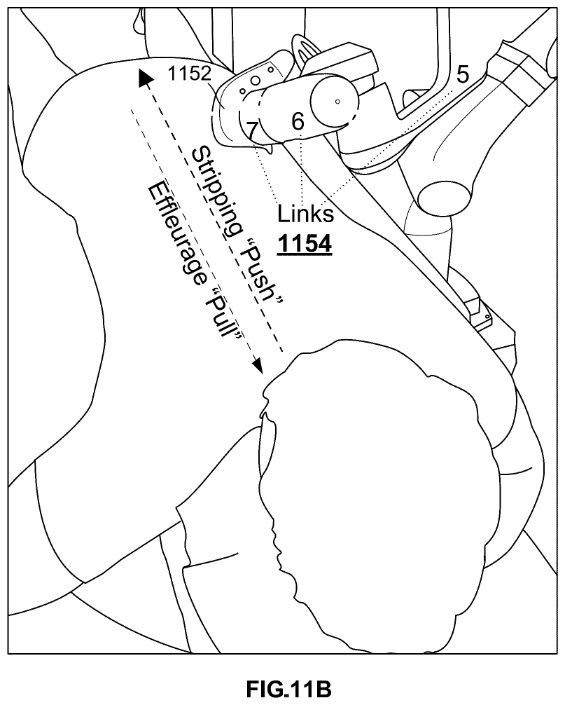

FIG. 11A illustrates an embodiment of a robotic arm.

FIG. 11B illustrates an embodiment of implementing robotic strokes using an end effector.

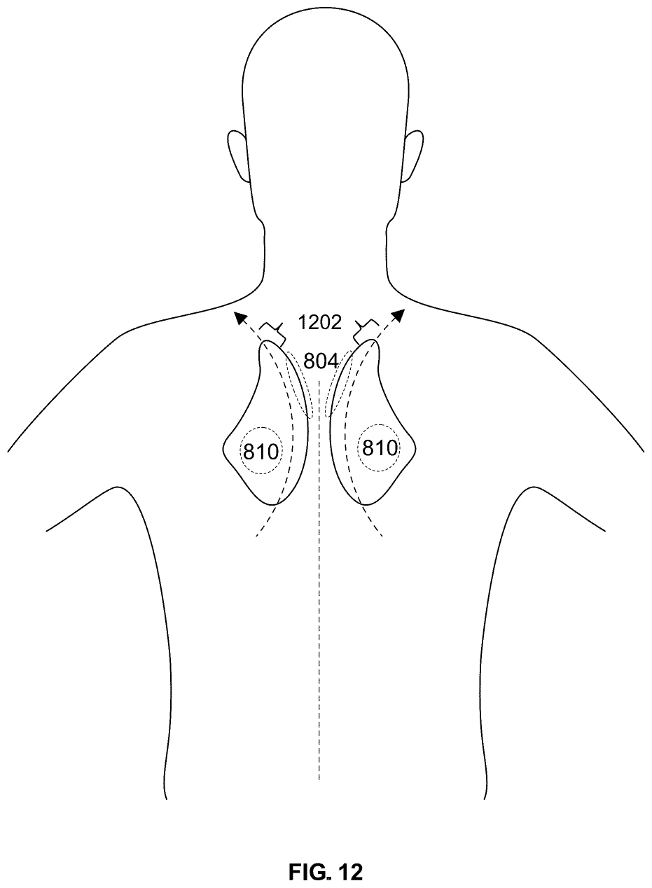

FIG. 12 illustrates an embodiment of performing a symmetric massage stroke.

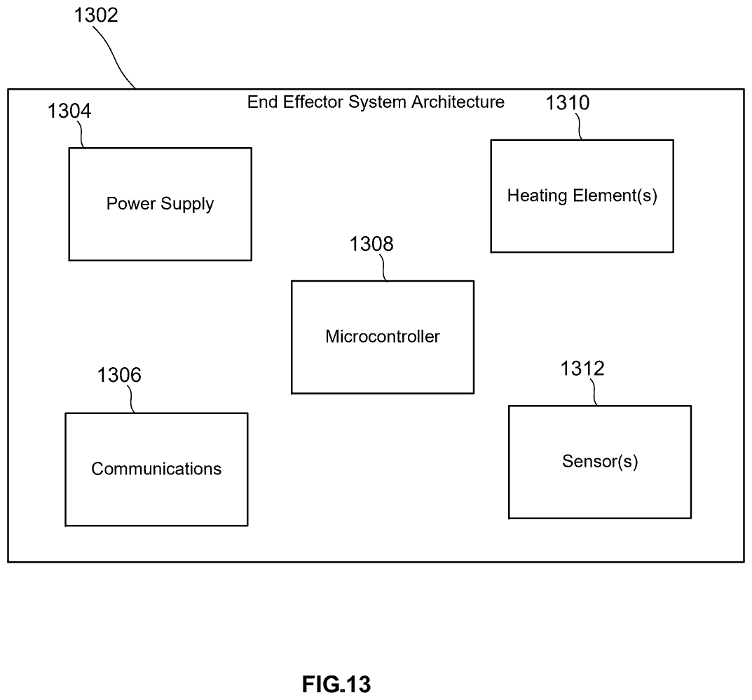

FIG. 13 illustrates an embodiment of a system architecture of an end effector.

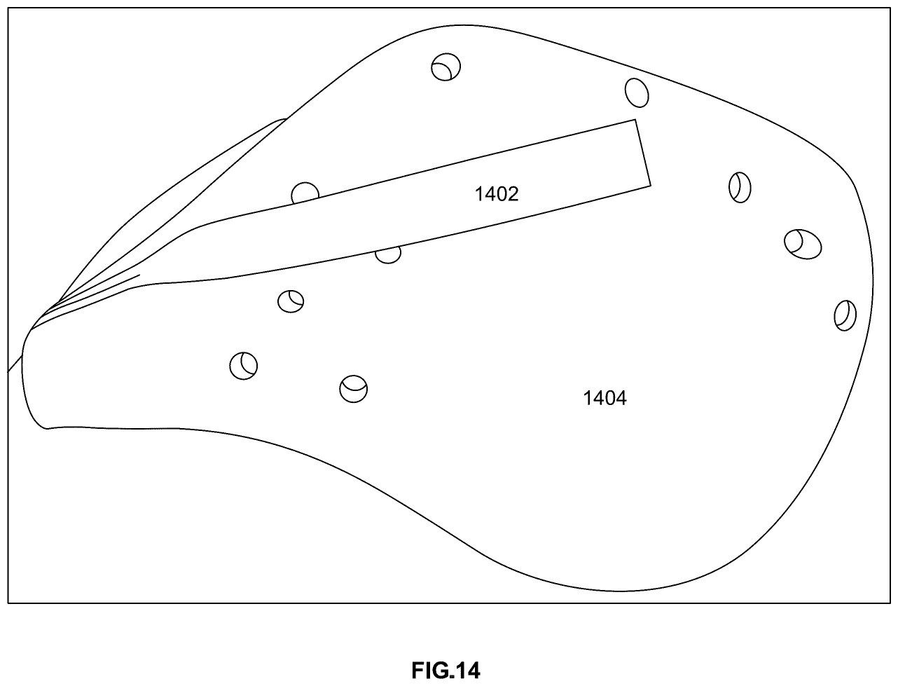

FIG. 14 illustrates an embodiment of heating elements of an end effector.

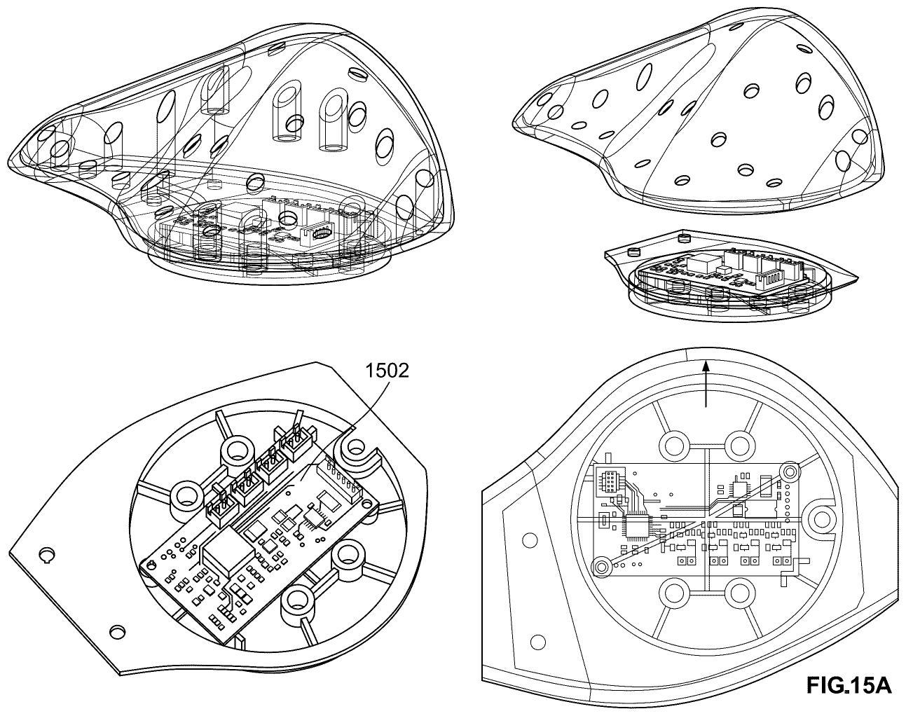

FIG. 15A illustrates various perspective views of portions of an end effector.

FIG. 15B illustrates embodiments of end effector exits.

FIG. 16 illustrates an exploded-view diagram of an embodiment of an end effector.

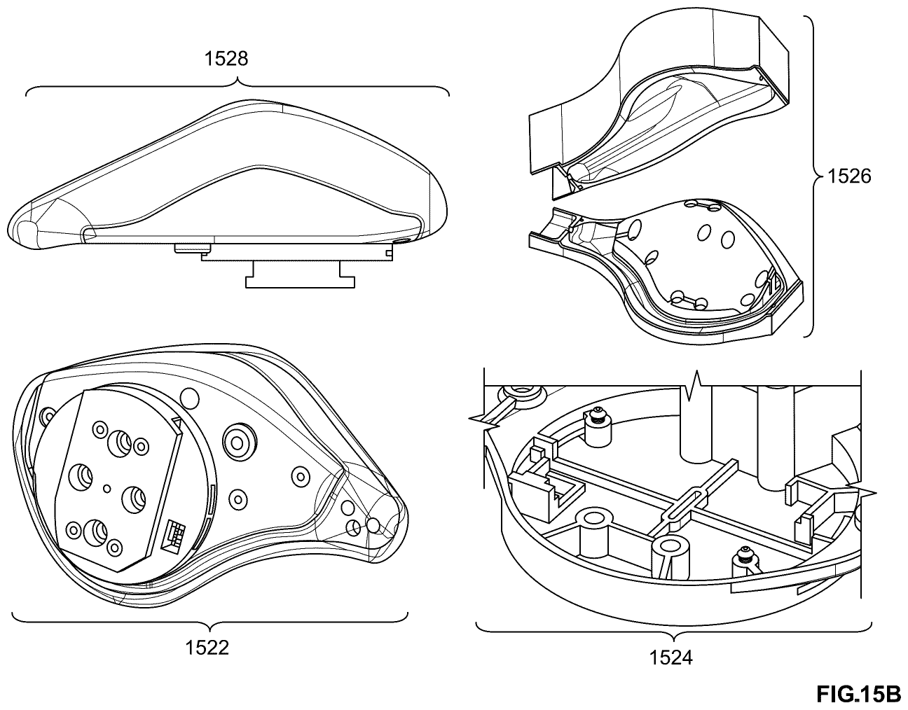

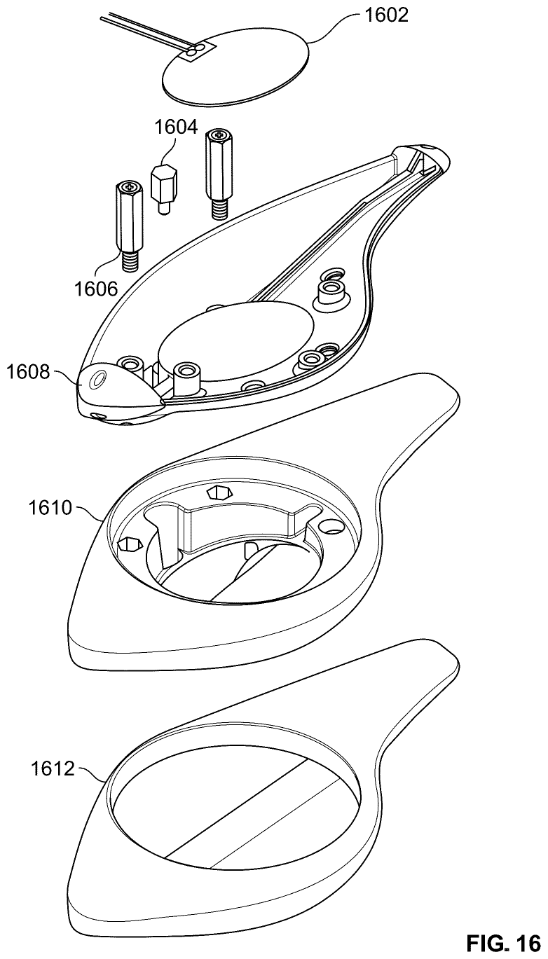

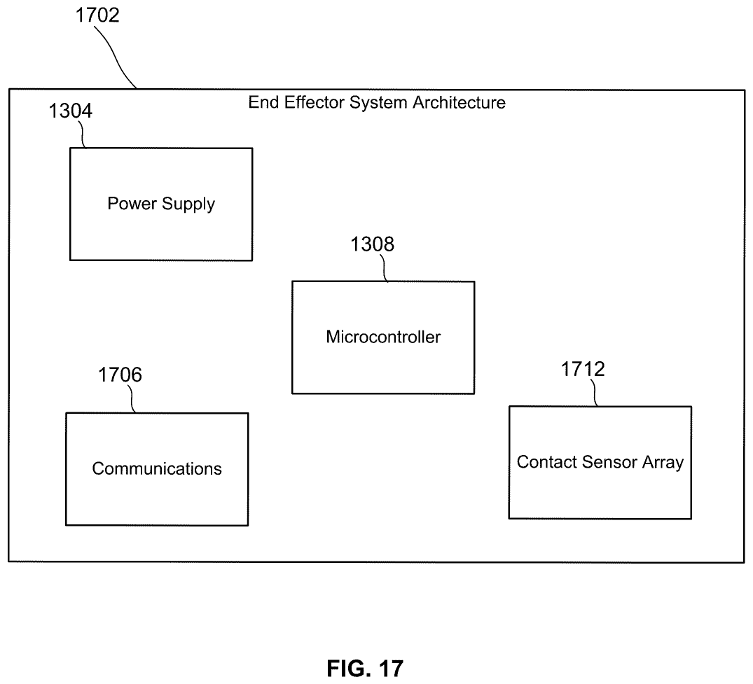

FIG. 17 is a block diagram illustrating an embodiment of an end effector with integrated contact sensing.

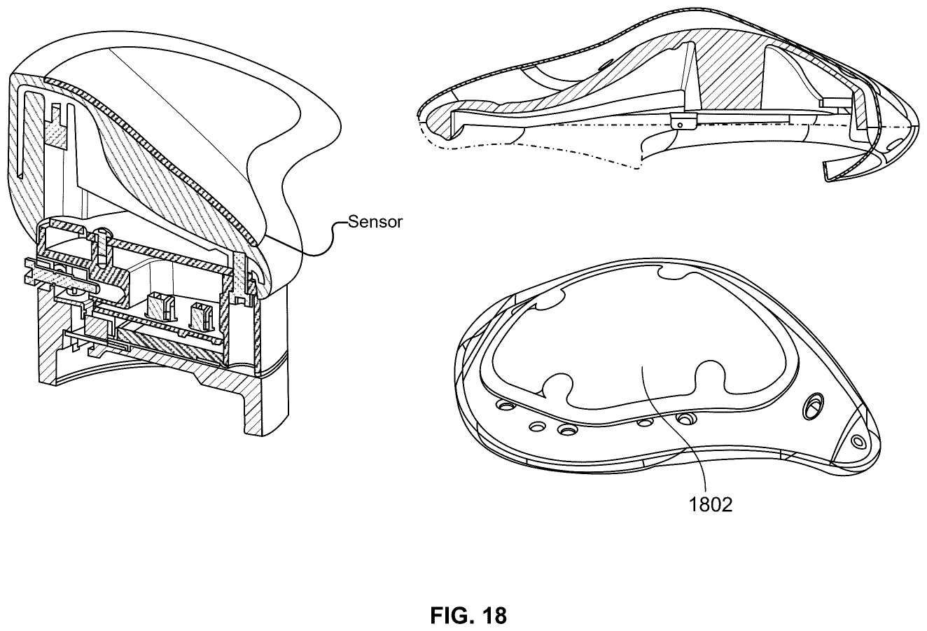

FIG. 18 illustrates an embodiment of integration of force-sensitive resistor materials in an end effector.

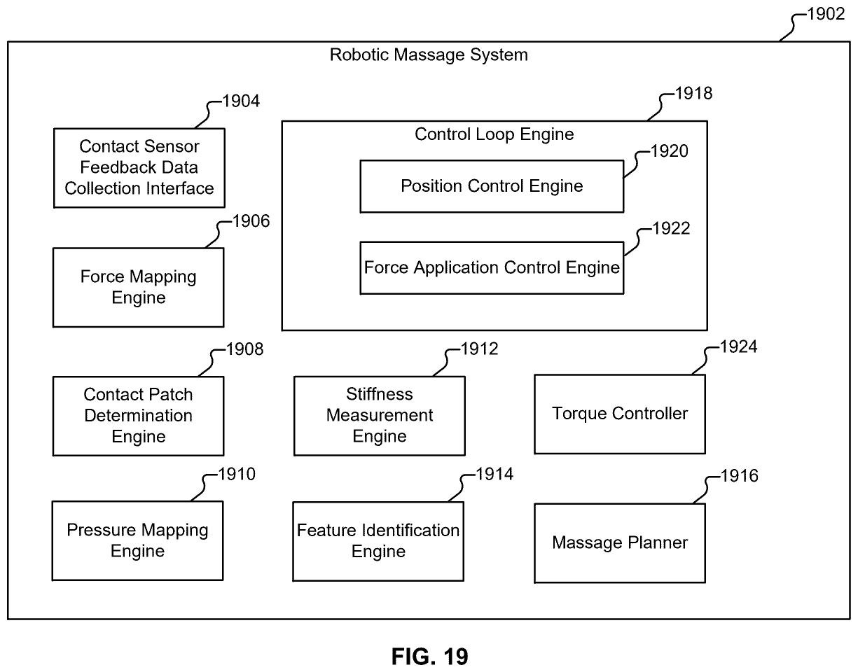

FIG. 19 is a block diagram illustrating an embodiment of a system for utilizing force feedback detected at an end effector using embedded contact sensors.

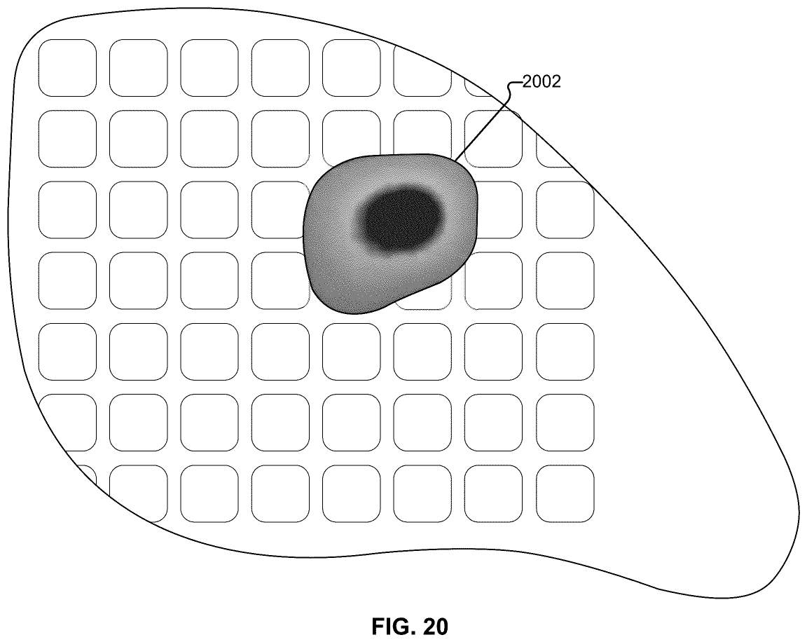

FIG. 20 illustrates an embodiment of a force map.

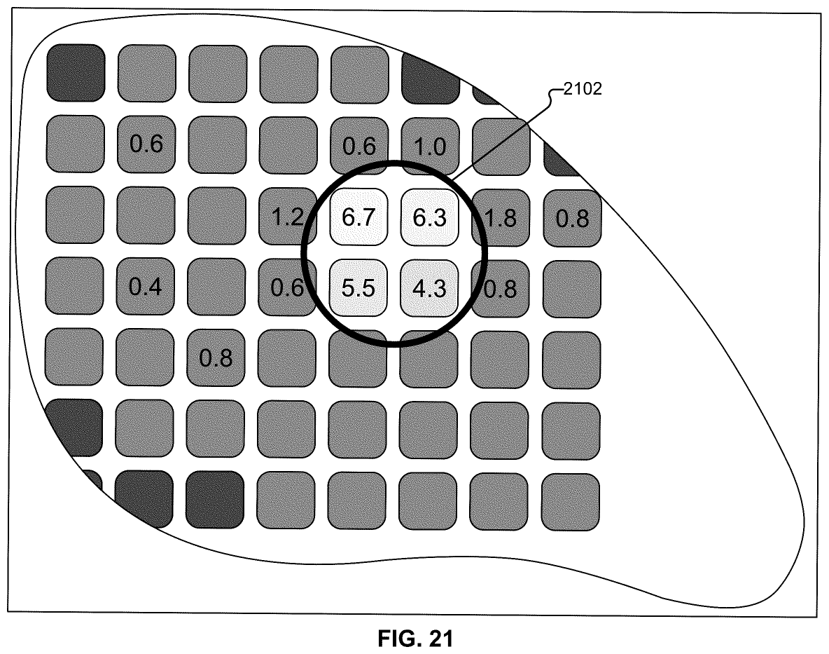

FIG. 21 illustrates an embodiment of force readings output from embedded contact sensors in response to interaction between an end effector and a deformable body.

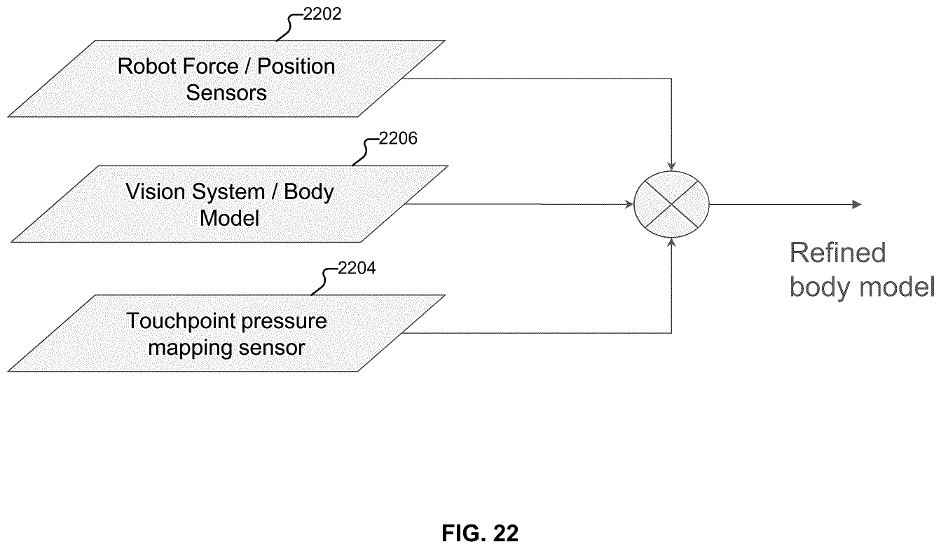

FIG. 22 illustrates an embodiment of sensor fusion with contact mapping information from force/touch sensitive end effectors.

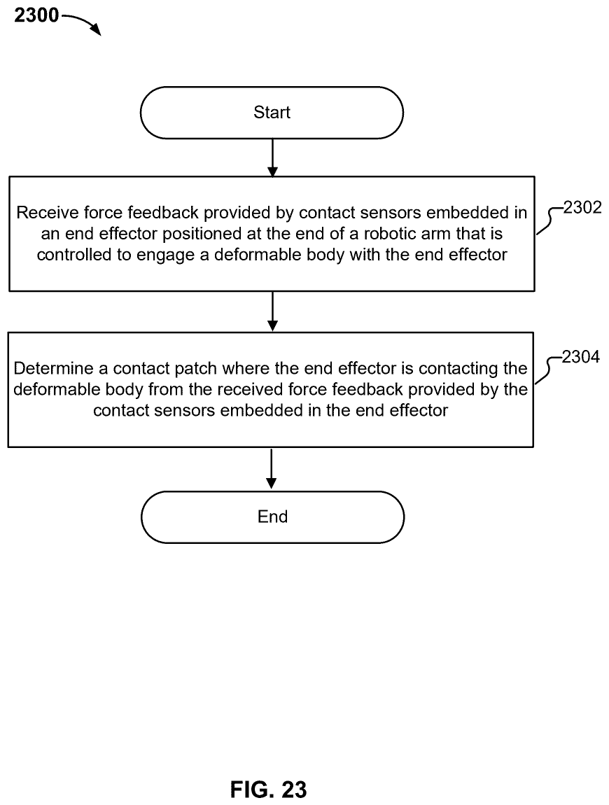

FIG. 23 is a flow diagram illustrating an embodiment of a process for determining a contact patch using contact sensors embedded in an end effector coupled to a robotic manipulator.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In an embodiment, an apparatus includes a support structure configured to support an object. The apparatus further includes a first robotic arm coupled to the support structure. The first robotic arm includes a first end effector having a first shape. The apparatus further includes a second robotic arm coupled to the support structure. The second robotic arm is separate from the first robotic arm and has a second shape that mirrors the first shape when observed from a common perspective. At least one of the first end effector or the second end effector is asymmetric about at least one two-dimensional plane that is perpendicular to an end effector plane of the at least one of the first end effector or the second end effector. The apparatus further includes at least one processor operatively coupled to the first robotic arm and the second robotic arm. The at least one processor is configured to perform coordinated body work on the object using the first robotic arm and the second robotic arm.

In an embodiment, a non-transitory, processor-readable medium stores code representing instructions executable by a processor to receive a signal representing an instruction to perform a massage. The non-transitory, processor-readable medium further stores code to send at least one signal to cause at least one of a first robotic arm of a robot system or a second robotic arm of the robot system to perform the massage on an object. The robot system includes a support structure. The robot system further includes the first robotic arm. The first robotic arm is coupled to the support structure and includes a first end effector with a first shape. The robot system further includes a second robotic arm coupled to the support structure. The second robotic arm is separate from the first robotic arm and includes a second end effector having a second shape that mirrors the first shape when observed from a common perspective. At least one of the first end effector or the second end effector is asymmetric about at least one two-dimensional plane that is perpendicular to an end effector plane of the at least one of the first end effector or the second end effector.

In an embodiment, a method includes receiving, via at least one processor of a robotic system, a signal representing an instruction to perform a massage. The method further includes sending, via the at least one processor, at least one signal to cause a robotic arm of the robot system to perform the massage on an object. The robot system includes a support structure and the robotic arm. The robotic arm is coupled to the support structure and includes an end effector that is asymmetric about at least one two-dimensional plane that is perpendicular to an end effector plane of the end effector.

In some implementations, a robot system can be used to perform coordinated body work. In some instances, coordinated body work refers to rubbing, tapping, kneading, and/or the like a body (e.g., human, animal, etc.) in a coordinated fashion (e.g., a massage). The robot system can include a support structure for an object, such as a support structure for a human, animal, mechanical device, and/or the like to lay. The robot system can also include any number (e.g., one, two, three, four, etc.) of robotic arms (e.g., coupled to the support structure) for performing the coordinated body work on the object. The robotic arms can each include an end effector that makes contact with the object to perform the coordinated body work. The robotic arms can perform any type of coordinated body work, such as an effleurage, petrissage, friction, tapotement, vibration, and/or the like.

FIGS. 1A and 1B show top and side views, respectively, of a robot system 100 that can be used to perform a massage, according to an embodiment. FIG. 1A shows a support structure 101, couplers 105A, 105B, and robotic arms 103A, 103B. The support structure can support an object, such as a human, animal, and/or the like. In some instances, the support structure is a bed (e.g., a massage bed), table, or other suitable platform.

The robotic arms 103A and 103B are each coupled to the support structure 101 via couplers 105A and 105B, respectively. In some instances, robotic arm 103A is separate (e.g., physically separate) from robotic arm 103B. For example, robotic arm 103A is coupled to a first side (e.g., left side) of support structure 101, and robotic arm 103B is coupled to a second side (e.g., right side) of support structure 101 that is different than the first side.

As shown in FIG. 1B, the robotic arm 103A includes an end effector 111, links 109A, 109B, and joints 107A, 107B, 107C. Joints 107A, 107B, and 107C act as pivot points for the robotic arm 103A. One or more of the joints 107A, 107B, 107C can include one or more brakes. In some implementations, when a brake is enabled, the joint for that brake will be locked/will not pivot or otherwise be repositioned (e.g., electronically and/or mechanically prevented from moving in one or more ways), and when the brake is disabled, the joint for that brake will be unlocked/able to pivot or to otherwise be repositioned. In some implementations, when a brake is enabled, the joint for that brake will not be locked/will pivot or otherwise be repositioned, and when the brake is disabled, the joint for that brake will be locked/not able to pivot or otherwise be repositioned. The joints 107A, 107B, 107C can be configured to allow for rotary movement around any number of axes (e.g., one, two, three, etc.).

The joints 107A, 107B, and 107C are interconnected via the links 109A, 109B. Joint 107A is coupled to coupler 105A, and joint 107C is coupled to end effector 111 (e.g., via an attachment not shown in FIGS. 1A and 1B). Together, the joints 107A, 107B, 107C and links 109A, 109B enable the end effector 111 to make contact with an object and perform coordinated work.

The end effector 111 can be any type of end effector, such as a gripper, a roller, a suction cup, a powered tool, a massage tool, and/or the like. In some implementations, an end effector refers to an implement sized, shaped, and engineered to contact a body with a desired force, touch feel, and/or the like. In some implementations, the end effector 111 is shaped for performing a massage technique, such as pinning, rolling, stretching, grabbing, gliding, kneading, and/or the like. In some instances, the end effector 111 has an irregular shape and/or is asymmetric about at least one two-dimensional plane (e.g., an end effector plane, a two-dimensional plane that passes through a center of at least one mounting flange of the end effector 111, etc.) of the end effector 111. In some instances, the end effector 111 is asymmetric about one or more two-dimensional planes from a plurality of two-dimensional planes intersecting the end effector 111.

Although not shown in FIG. 1B, robotic arm 103B can have a structure similar to that of robotic arm 103A. For example, robotic arm 103B can include a plurality of joints interconnected with a plurality of brakes (e.g., similar to joints 107A, 107B, 107C and links 109A, 109B), and an end effector (e.g., similar to end effector 111). In some instances, robotic arms 103A and 103B have substantially the same end effector (accounting for slight variations that can occur due to manufacturing and use).

Although FIG. 1B shows robotic arm 103A as including three joints and two links, in other implementations, any number of joints and links can be used (e.g., six joints and five links, seven joints and six links, etc.). Additional details related to a robotic device that can be used to implement one or more coordinated body works discussed herein are discussed in U.S. patent application Ser. No. 17/959,777, filed Oct. 4, 2022 and titled “METHOD AND SYSTEM FOR ELECTROMECHANICAL SAFETY FOR ROBOTIC MANIPULATORS,” the contents of which are incorporated herein by reference in their entirety.

Although not shown in FIGS. 1A and 1B, in some instances, the robot system 100 includes a fixed base. The fixed base can be fixed, permanently attached, or removably attached to a base structure, support structure, massage table, floor, wall, ceiling, movable carriage, or other structure. The fixed base can be attached to a rail system, block, or other structure movably attached to a rail/translation system, allowing the robot system 100 to be moved along the side of a table, chair, wall, floor, or other structure.

Although not shown in FIGS. 1A and 1B, in some instances, the support structure 101 includes at least one track. Coupler 105A, coupler 105B, robotic arm 103A and/or robotic arm 103B can be coupled to the at least one track, allowing coupler 105A, coupler 105B, robotic arm 103A and/or robotic arm 103B to slide along support structure 101. In some instances, the support structure 101 includes a first track along a first side (e.g., left side) of the support structure 101 and a second track along a second side (e.g., right side) of the support structure 101.

For example, robotic arm 103A and/or coupler 105A can be attached to the first track, enabling robotic arm 103A and/or coupler 105A to slide along the first track, and robotic arm 103B and/or coupler 105B can be attached to the second track, enabling robotic arm 103B and/or coupler 105B to slide along the second track. In some instances, the first track is not mechanically connected to the second track, enabling each of the robotics arms 103A and 103B to operate independently. In some instances, the first rack is mechanically connected to the second track.

Although not shown in FIGS. 1A and 1B, the robot system 100 can include a processor. The processor can be, for example, a hardware based integrated circuit (IC) or any other suitable processing device configured to run and/or execute a set of instructions or code. For example, the processor can be a general-purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC) and/or the like. In some implementations, the processor can be configured to execute, perform, or cause performance of any of the methods and/or portions of methods discussed herein. The processor can be housed at any one or more components of the robot system 100, or somewhere different than the robot system 100. Signals sent by the processor can be communicated to one or more components of the robot system 100 (e.g., via a system bus), such as robotic arm 103A, robotic arm 103B, a joint, and link, and/or the like. In some instances, the processor is communicably coupled (e.g., via one or more wired and/or wireless networks) to robotic arm 103A and/or 103B.

Although not shown in FIGS. 1A and 1B, the robot system 100 can include a memory. The memory can be, for example, a random-access memory (RAM), a memory buffer, a hard drive, a read-only memory (ROM), an erasable programmable read-only memory (EPROM), and/or the like. The memory can be configured to store data used by the processor to perform the techniques discussed herein. In some instances, the memory can store, for example, one or more software programs and/or code that can include instructions to cause the processor to perform one or more processes, functions, and/or the like. In some embodiments, the memory can include extendible storage units that can be added and used incrementally. In some implementations, the memory can be a portable memory (for example, a flash drive, a portable hard disk, and/or the like) that can be operatively coupled to the controller. In some instances, the memory can be remotely operatively coupled with the robot system 100. For example, a remote database device (not shown in FIGS. 1A and 1B) can serve as a memory and be operatively coupled to the robot system 100. The memory is operatively coupled to the processor.

FIGS. 2A and 2B show example illustrations of portions of a robot system including two robotic arms, according to an embodiment. FIGS. 2A and 2B include robotics arms 203A and 203B. The robotic arms 203A and 203B include end effectors 211A and 211B, respectively, that can make contact with an object 213 on a support structure 202 to perform a massage.

FIGS. 3A-3C show various perspective views of an end effector (e.g., end effector 111), according to an embodiment. The end effector can include multiple different contact surfaces that are distinct from one another, and that can be used for different purposes/modalities. These contact surfaces can have various shapes and/or properties, e.g., for applying different pressures to an object during coordinated body work. For example, as shown in each of the different views from FIGS. 3A-3C, the end effector can include a portion 301 having a first contact surface (e.g., for focused work), a portion 302 having a second contact surface (e.g., for stripping) different from the first contact surface, a portion 303 having a third contact surface (e.g., for compressions and/or effleurage) different from the first and second contact surfaces, and a portion 304 having a fourth contact surface (e.g., for high force stripping) different from the first, second, and third contact surfaces. The end effector can also include an end effector flange 305 (e.g., to function as coupler for a joint such as joint 107C in FIG. 1B). The end effector can be made of any material, such as rubber, plastic, silicone, nitrile, vinyl, neoprene, and/or the like.

As used herein, an end effector “having a shape” can refer to the end effector having a shape that is substantially consistent/uniform across at least a portion thereof, and does not necessarily refer to an overall shape of the end effector as a whole. In other words, the end effector, in some embodiments. may be said to “have” multiple different shapes, each shape being associated with a different portion of the end effector. In other embodiments, an end effector can have a substantially consistent/uniform shape globally (e.g., the end effector may have an overall oval shape, an overall ellipsoid shape, etc.).

In some implementations, an end effector of a first robotic arm (e.g., robotic arm 103A) and an end effector of a second robotic arm (e.g., robotic arm 103B) are mirrored across a plane, such as a plane perpendicular to a support structure (e.g., support structure 101). For example, FIG. 4 shows end effector 401 and end effector 402 mirrored across a plane 403 perpendicular to a table 404, according to an embodiment.

In some implementations, mirrored, asymmetrical end effectors allow for the close symmetrical contact between the left and right sides of an object without them or the robot arms they are mounted on colliding. For example, FIG. 5 shows an end effector 503A coupled to the last link 501A of a robotic arm via an end effector flange 502A, and an end effector 503B coupled to the last link 501B of a robotic arm via an end effector flange 502B. In some implementations, the end effectors 503A, 503B can be mirrored across a plane 505 perpendicular to a structure 504 (e.g., a body that is being massaged and/or a table or other support structure).

In some implementations, strokes (e.g., of end effectors) can be mirrored using a two-dimensional (2D) texture map or a representation of a three-dimensional (3D) surface (e.g., of a human body). FIG. 6A shows an example of a 3D structural representation of a human body, and FIG. 6B shows a 2D texture map of the human body. In some instances, the 3D structural representation can be captured using, for example, a body scan. In some implementations, the 2D texture map can be generated based on the 3D structural representation. For example, the 3D structural representation can be mesh unwrapped into UV space, allowing for mirroring directly related to the surface of the skin, and the spine and/or center of the body can be represented in the 2D texture map and/or in the 3D structural representation (e.g., using a line, spline, and/or the like), to facilitate mirroring between, for example, the left and right sides of the body. Note, however, that mirroring can occur around/about any arbitrary line or curve in UV space or any coordinate frame or plane in cartesian space. In some instances, symmetrical and/or mirrored strokes can be performed by multiple end effectors using the 3D structural representation and/or the 2D texture map as a reference frame.

A robot system (e.g., robot system 100) can be used to perform coordinated body work, such as a coordinated massage. Although discussions herein mention massages as an example, other types of coordinated works can also be performed, such as assembling a mechanical device, performing a medical procedure, and/or the like. In some implementations, a processor of the robot system can send an electronic signal (e.g., to robotic arms 103A and/or 103B) to cause a robotic arm(s) (e.g., to robotic arms 103A and/or 103B) to perform the coordinated body work.

### Pin and Stretch Technique

In some implementations, the coordinated body work can include a pin and stretch technique. For example, a first end effector of a first robotic arm can pin a first region (e.g., lower back) of a body, and a second end effector of a second robotic can apply a pressure to stretch a second region (e.g., upper back) of the body away from the first region of the body. In some instances, the pin and stretch technique can stretch/elongate a muscle(s) of a body by applying at least two points of contact with forces that includes components acting in opposing directions. The first and second end effectors can be both moving, or one of the first or second end effector can be moving while the other is substantially fixed. In some instances, pin and stretch can be performed using more than two end effectors/points of contact.

In some instances, the first end effector applies pressure on the left glute of a human, and the second end effector applies a pressure on the right upper back (or vice versa) to stretch a muscle(s) and the forces along (versus normal to) the body that are directly in line with a muscle(s). In some instances, the first and second end effectors apply pressure on the same side of the body at two different locations on an erector muscle. The tangential directions of force can largely correspond to opposite directions along the erector muscle.

In some instances, a first end effector engages a relative position on the body to keep an anchor point or muscle taut as the second end effector applies force in the opposing direction. In some instances, the first end effector applies some downward force to the muscle, then moves slightly in a direction opposite the second end effector to help elongate the muscle/body from first end effector.

In some instances, a first end effector of a first robotic arm (e.g., robotic arm 103A) can apply a first pressure to a first location of an object during a predefined period of time, while a second end effector of a second robotic arm (e.g., robotic arm 103B) can apply a second pressure to a second location of the object (e.g., different than the first location) during the predefined period of time such that at least a portion of the first pressure opposes at least a portion of the second pressure within a common plane. In some instances, the first and second end effectors make contact with the object to apply the first and second pressures via a region of the first and second end effector (e.g., region 304 of FIGS. 3A-3C).

### Mother Hand Technique

In some implementations, the coordinated body work can include a mother hand technique. In some instances, a first end effector is used to perform therapeutic work on a body, while the second end effector is used to provide a stabilizing and/or calming element. For example, while a first end effector is used to perform a stroke on the body, the second end effector is used to apply some nominal force (e.g., less than the pressure provided by the first end effector at the same time) at a position on the body. The pressure on the body provided by one end effector can be low relative to the pressure on the body provided by the other end effector (e.g., less than, at least 10% less than, at least 25% less than, at least 50% less than, at least 75% less than, at least 90% less than, and/or the like).

In some implementations, a substantially (e.g., within 1%, within 5%, within 10%, etc.) singular force or pressure is provided by the mother hand. In others, the force provided by the mother hand can vary/be pulsating (e.g., periodically, sporadically, in relation to the stroke being performed, etc.). For example, the pressure or force provided by the mother hand can increase while the other end effector/robotic arm is moving and/or returning to the start position of a stroke, similar to how a therapist might be leaning some of his/her weight onto the patient and need to rest more weight on the mother hand when relieving pressure on a retract/return stroke.

In some implementations, the position of the mother hand may also move slightly (e.g., within a singular region and/or less than an inch) over the course of the stroke or during a retract of the other end effector I robotic arm between multiple passes of a stroke. The slight position and force adjustments of the mother hand during a therapeutic stroke can distract the user from some of the more intense work and make them feel more comfortable.

In some instances, a first end effector of a first robotic arm (e.g., robotic arm 103A) can perform a first contacted motion across a first region of an object (e.g., human) while applying a first set of pressures to the object, while a second end effector of a second robotic arm (e.g., robotic arm 103B) can perform a second contacted motion across a second region of the object (e.g., different than the first region) while applying a second set of pressures. Each pressure from the second set of pressures can be greater than an associated co-occurring pressure from the first set of pressures. Said differently, a pressure provided by a portion of the first contacted motion at a time can be less than the pressure provided by the portion of the second contacted motion occurring at the same time. In some instances, the first and second end effectors make contact with the object to apply the first and second sets of pressures via respective regions of the first and second end effector. In some implementations, a contacted motion refers to motion of an end effector during which the end effector is in contact with the object.

### Symmetric Technique

In some implementations, the coordinated body work can include a symmetric technique. The symmetric technique allows the same work to be performed on the left and right side of the body at substantially (e.g., within 1 second of each other, within 2 seconds of each other, etc.) the same time. A first end effector can apply a stroke at a first region (e.g., left side) of an object, and the second end effector can apply the stroke at a second region (e.g., right side) of the object at the same time, where the strokes are substantially identical (e.g., +/−20%) in shape/trajectory to one another, and/or mirror each other. In some implementations, the strokes mirror across the spine of a body. In some implementations, the strokes mirror relative to a muscle and/or anatomical landmark.

In some implementations, representations of the trajectories of the first end effector and/or second end effector are stored in barycentric space. In some instances, the mirrored strokes are represented in cartesian coordinates. For example, a plane may be defined using the axis of the spine and a z-axis (e.g., a vertical axis, such as the long axis of a leg of the support structure 101 of FIG. 1B) of the support structure to create a plane, where the strokes are mirrored relative to the plane. The mirrored strokes in cartesian coordinates are then remapped to barycentric coordinates using a body model (e.g., from a body scan) of an object. Alternatively or in addition, strokes can be mirrored in UV space, e.g., based on a two-dimensional (2D) map generated relative to a surface of a body.

In some instances, a first end effector of a first robotic arm (e.g., robotic arm 103A) can perform a first contacted motion across a first region of an object during a predefined period of time, while a second end effector of a second robotic arm (e.g., robotic arm 103B) can perform a second contacted motion across a second region of the object different than the first region of the object. The first contacted motion can substantially (e.g., within 1%, within 5%, within 10%, within 25%, within 50%, and/or the like) mirror the second contacted motion relative to a portion (e.g., spine, muscle, landmark, etc.) of the object. In some instances, the first and second end effectors make contact with the object to perform the first and second contacted motions via a region of the first and second end effector (e.g., region 304 in FIGS. 3A-3C).

### Walking Compression Technique

In some implementations, the coordinated body work can include a walking compression technique. The walking compression technique can provide alternating compressions across a region of an object, resembling a walking pattern. For example, the first end effector and second end effector can be used to alternatively provide pressures, where the location of each pressure changes and progresses from a start location (e.g., left side of upper back) to an end location (e.g., right side of lower back). In some implementations, the walking compression technique can be used to warm up the back of a human (e.g., going from upper back and progressing towards the glutes). In some instances, the walking compression technique can be performed prior to a subsequent coordinated body work (e.g., pin and stretch, mother hand, symmetric).

In some implementations, a first end effector of a first robotic arm (e.g., robotic arm 103A) can apply a first set of pressures to a first region of an object during a first time period. Additionally, a second end effector of a second robotic arm (e.g., robotic arm 103B) can apply a second set of pressures to a second region of the object different from the first region of the object during the second time period. The second time period can have no overlap with the first time period, or overlap partially with the first time period (e.g., overlap includes the end of the first time period but not the beginning of the first time period). Additionally, the first end effector can apply a third set of pressures to a third region of the object different from the first region of the object during a third time period subsequent to the first time period. The third time period can have no overlap with the second time period, or overlap partially with the second time period (e.g., overlap includes the end of the second time period but not the beginning of the second time period). Additionally, the second end effector can apply a fourth set of pressures to a fourth region of the object different than the second region during a fourth time period subsequent to the second time period. The fourth time period can have no overlap with the third time period, or overlap partially with the third time period (e.g., overlap includes the end of the third time period but not the beginning of the third time period). In some instances, the first and second end effectors make contact with the object to apply the first, second, third, and/or fourth sets of pressures via a region of the first and second end effector (e.g., region 304 in FIGS. 3A-3C).

In addition to the pin and stretch, mother hand, symmetric, and walking compression techniques, the robot system can be used to perform any other type of coordinated body work. For example, asymmetrical effleurage can be performed. In some implementations, a first end effector (e.g., from robotic arm 103A) can apply a first contacted motion across a first region of an object during a first period of time, and a second end effector (e.g., from robotic arm 103B) can apply a second contacted motion across a second region of the object that substantially mirrors the first region about a portion (e.g., spine, muscle, anatomical landmark) of the object during a second period of time different than (e.g., after) the first period of time. For example, a first end effector can make contact with and go down a left side of a spine. Thereafter, the second end effector can make contact with and go down a right side of the spine. Such a process can be repeated any number of times. In some instances, the first and second end effectors make contact with the object to apply the first and second contacted motions via a region of the first and second end effector (e.g., region 304 in FIGS. 3A-3C).

In some implementations, an erector stretch can be performed. In some implementations, a first end effector (e.g., from robotic arm 103A) applies a first pressure to a first location of an object during a range of time. During a first sub-range of time included in the range of time, a second end effector (e.g., from robotic arm 103B) applies a second pressure to a second location of the object. During a second sub-range of time included in the range of time, the second end effector applies a third pressure to a third location of the object that is closer to the first location than the second location is to the first location (i.e., the first location is closer to the third location than the first location is to the second location). The second sub-range of time can be after the first sub-range of time. In some instances, the first and second end effectors make contact with the object to apply the first, second, and third pressures via a region of the first and second end effector (e.g., region 304 in FIGS. 3A-3C). As an example, the first end effector can apply a pressure(s) to a human's upper back. During that time, the second end effector can apply a pressure(s) to the human's lower back, then apply a pressure(s) to the human's middle back. In some instances, the second sub-range of time can be before the first sub-range of time. For example, the first end effector can apply a pressure(s) to a human's upper back. During that time, the second end effector can apply a pressure(s) to the human's middle back, then apply a pressure(s) to the human's lower back.

In some implementations, an end effector (e.g., end effector 111) contacts a region of an object using a first portion of the end effector. Thereafter, the end effector contacts the region and/or a different region using a second portion of the end effector different than the first portion. For example, after the end effector has begun applying pressure to a portion of a body, the end effector can rotate and/or rub along the object such that a different portion of the end effector is making contact with the body. In some implementations, after the end effector is applying compression to a region of an object, the end effector can rotate while maintaining contact with the object. In some implementations, after the end effector is applying compression to a region of an object, the end effector can rotate without maintaining contact with the object. In some instances, the end effector makes contact with the object to rotate and/or rub via any region(s) of the end effector.

In some instances, a first end effector (e.g., from robotic arm 103A) and second end effector (e.g., from robotic arm 103B) can perform repeated stripping along a muscle of a body. For example, the first and second end effectors can strip along a right erector of a human, each end effector moving a predetermined length (e.g., approximately five inches) at a time and moving down the body to gradually traverse the right erector. In some instances, a first end effector performs a first contacted motion across a first region of an object. Thereafter, a second end effector performs a second contacted motion across a second region of the object different than the first region of the object, where a portion of the first region intersects with a portion of the first region. Such a process can be repeated any number of times (e.g., until a muscle has been stripped). In some instances, the first and second end effectors make contact with the object to perform the first contacted motion and the second contacted motion via a region of the first and second end effector (e.g., region 304 in FIGS. 3A-3C).

In some instances, a first end effector (e.g., from robotic arm 103A) and second end effector (e.g., from robotic arm 103B) can be used to perform synchronized rocking motions or oscillations to an object. Where the object is a human, such rocking and/or oscillations can improve blood flow and muscle relations. The rocking and/or oscillations can be in any direction, such as up and down and/or left to right. For example, a first end effector can apply a first force to an object in a first direction. Thereafter, the second end effector can apply a second force to the object in a second direction different than the first direction (e.g., opposite from the first direction; after the first end effector has stopped applying the first force). Such a process can be repeated any number of times. In some instances, the first and second end effectors make contact with the object to apply the first and second forces via a region of the first and second end effector (e.g., region 304 in FIGS. 3A-3C).

In some instances, a first end effector (e.g., from robotic arm 103A) and second end effector (e.g., from robotic arm 103B) can be used to perform tapotement. For example, the first end effector can make a first contacted motion at a first region of the object while a second end effector does not make contact with the object. Thereafter, the second end effector can make a second contacted motion at a second region of the object different from the first region of the object while the first end effector does not make contact with the object. Such a process can be repeated any number of times. In some instances, the first and second end effectors make contact with the object to make the first and second contacted motions via a region of the first and second end effector (e.g., region 304 in FIGS. 3A-3C).

In some implementations, a first end effector (e.g., from robotic arm 103A) and second end effector (e.g., from robotic arm 103B) can massage the glutes and/or legs (e.g., upper legs, calves, etc.) of a human. The first and second end effectors can make contact with the glutes and/or legs via a region of the first and second end effector (e.g., regions 305 and/or 306 in FIGS. 3A-3C). In some implementations, a first end effector and second end effector can massage the shoulders of a human. The first and second end effectors can make contact with the shoulders via a region (e.g., region 301 of FIGS. 3A-3C) of the first and second end effector.

In an embodiment, an apparatus comprises: a support structure (e.g. support structure 101) configured to support an object; a first robotic arm (e.g., robotic arm 103A) coupled to the support structure, the first robotic arm including a first end effector (e.g., end effector 111) having a first shape; a second robotic arm (e.g., robotic arm 103B) coupled to the support structure, the second robotic arm separate from the first robotic arm and having a second shape that mirrors the first shape when observed from a common perspective. Alternatively or in addition, the first shape may be both rotated and mirrored, relative to the second shape, when viewed from a common perspective. At least one of the first end effector or the second end effector may be asymmetric about at least one two-dimensional plane thereof; and at least one processor operatively coupled to the first robotic arm and the second robotic arm, the at least one processor configured to: perform coordinated body work (e.g., massage) of the object using the first robotic arm and the second robotic arm.

In some embodiments, an apparatus comprises a first robotic arm (e.g., robotic arm 103A) including a first end effector (e.g., end effector 111) having a portion with a first shape, and a second robotic arm (e.g., robotic arm 103B) separate from the first robotic arm and including a second end effector, the second end effector having a portion with a second shape that substantially mirrors the first shape when observed from a common perspective. For example, the portion of the first end effector with the first shape may occupy between about 80% and about 99%, or between about 50% and about 90%, or between about 25% and about 75%, or between about 50% and 100%, or between about 75% and 100% of the surface of the first end effector, and similarly, the portion of the second end effector with the second shape may occupy between about 80% and about 99%, or between about 50% and about 90%, or between about 25% and about 75%, or between about 50% and 100%, or between about 75% and 100% of the surface of the second end effector.

In some embodiments, an apparatus comprises (1) a first end effector (e.g., end effector 111) having a first surface with a first shape and a second surface with a second shape, and (2) a second end effector having a first surface with a third shape that mirrors the first shape of the first end effector when observed from a common perspective, and a second surface with a fourth shape. In some such implementations, during operation of the apparatus, the first surface of the first end effector and the first surface of the second end effector are in contact with a body, and the second surface of the first end effector and the second surface of the second end effector are not in contact with the body.

In some implementations, performing the coordinated body work includes: sending a first signal to cause the first end effector to apply a first pressure to a first location on the object during a predefined period of time; and sending a second signal to cause the second end effector to apply a second pressure to a second location on the object different than the first location and during the predefined period of time, such that at least a portion of the first pressure opposes at least a portion of the second pressure within a common plane.

In some implementations, performing the coordinated body work includes: sending a first signal to cause, during a period of time, the first end effector to perform a first contacted motion across a first region of the object while applying a first set of at least one pressure to the object; and sending a second signal to cause, during the period of time, the second end effector to perform a second contacted motion across a second region of the object while applying a second set of at least one pressure to the object, each pressure from the second set of at least one pressure being greater than an associated co-occurring pressure from the first set of pressures.

In some implementations, performing the coordinated body work includes: sending a first signal to cause, during a predefined period of time, the first end effector to perform a first contacted motion across a first region of the object; and sending a second signal to cause, during the predefined period of time, the second end effector to perform a second contacted motion across a second region of the object different than the first region of the object, the first contacted motion substantially mirroring the second contacted motion relative to a portion of the object.

In some implementations, performing the coordinated body work includes: causing the first end effector to apply a first set of pressures to a first region of the object during a first time period; causing the second end effector to apply a second set of pressures to a second region of the object different from the first region of the object, during a second time period that overlaps with the first time period; causing the first end effector to apply a third set of pressures to a third region of the object different from the first region of the object and during a third time period subsequent to the first time period; and causing the second end effector to apply a fourth set of pressures to a fourth region of the object different from the second region of the object and during a fourth time period subsequent to the second time period. In some implementations, when a maximum pressure value from the first set of pressures is applied to the first region of the object, and a second pressure value from the second set of pressures is applied to the second region of the object, the second pressure value being less than the maximum pressure value. In some implementations, when a maximum pressure value from the first set of pressures is applied to the first region of the object, the first end effector is maintained at a first position within the first region of the object, and when a minimum pressure value from the first set of pressures is applied to the first region of the object, the first end effector moves along the first region of the object.

In some implementations, performing the coordinated body work includes: sending a first signal to cause, during a first period of time, the first end effector to perform a first contacted motion across a first region of the object; and sending a second signal to cause, during a second period of time different than the first period of time, the second end effector to perform a second contacted motion across a second region of the object different than the first region of the object, the first region substantially mirroring the second region about a portion of the object.

In some implementations, performing the coordinated body work includes: sending a first signal to cause, during a range of time, the first end effector to apply a first pressure to a first location of the object; sending a second signal to cause, during a first sub-range of time included in the range of time, the second end effector to apply a second pressure to a second location of the object; and sending a third signal to cause, during a second sub-range of time included in the range of time different the first sub-range of time, the second end effector to apply a third pressure to a third location of the object, the third location being closer than the second location to the first location.

In some implementations, performing the coordinated body work includes: sending a first signal to cause, at a first time, the first end effector to contact a region of the object using a first portion of the first end effector; and sending a second signal to cause, at a second time different than the first time, the first end effector to contact the region of the object using a second portion of the first end effector different than the first portion.

In some implementations, performing the coordinated body work includes: causing the first end effector to apply compression to a region of the object at a first time; and subsequent to the first time, causing the first end effector to rotate while maintaining contact with the object.

In some implementations, the apparatus further includes: a third robotic arm coupled to the support structure and operatively coupled to the at least one processor, the third robotic arm being separate from the first robotic arm and the second robotic arm, the third robotic arm including a third end effector that is asymmetric about at least one two-dimensional plane that is perpendicular to an end effector plane of the third end effector. In some implementations, the apparatus further includes: a fourth robotic arm coupled to the support structure and operatively coupled to the at least one processor, the fourth robotic arm being separate from the first robotic arm and the second robotic arm, the fourth robotic arm including a fourth end effector that is asymmetric about at least one two-dimensional plane that is perpendicular to an end effector plane of the fourth end effector.

In some implementations, the support structure includes at least one track, and at least one of the first robotic arm or the second robotic arm is slidably coupled to the at least one track.

In some implementations, the first end effector is not symmetric about any two-dimensional plane that passes through a center of at least one first mounting flange associated with at least one of the first end effector or the first robotic arm, and the second end effector is not symmetric about any two-dimensional plane that passes through a center of at least one second mounting flange associated with at least one of the second end effector or the second robotic arm.

In some implementations, performing the coordinated body work includes: sending a first signal to cause, during a first period of time, the first end effector to perform a first contacted motion across a first region of the object; and sending a second signal to cause, during a second period of time after the first period of time, the second end effector to perform a second contacted motion across a second region of the object different than the first region of the object, a portion of the first region intersecting with a portion of the second region.

In some implementations, performing the coordinated body work includes: causing the first end effector to make a first contacted motion at a first region of the object during a first time period; causing the second end effector to not make contact with the object during the first period of time; causing the second end effector to make a second contacted motion at a second region of the object different from the first region of the object during a second time period after the first time period; causing the first end effector to not make contact with the object during the second period of time; causing the first end effector to make the first contacted motion at the first region of the object during a third time period after the second period of time; causing the second end effector to not make contact with the object during the third period of time; causing the second end effector to make the second contacted motion at the second region of the object during a fourth time period after the third period of time; and causing the first end effector to not make contact with the object during the fourth period of time.

In some implementations, performing the coordinated body work includes: causing the first end effector to apply a first force to the object in a first direction at a first time; causing the second end effector to apply a second force to the object in a second direction substantially opposite to the first direction at a second time after the first time; causing the first end effector to apply a third force to the object in the first direction at a third time after the second time; and causing the second end effector to apply a fourth force to the object in the second direction at a fourth time after the third time.

In an embodiment, a non-transitory, processor-readable medium stores code representing instructions executable by a processor to receive a signal representing an instruction to perform a massage; and send at least one signal to cause at least one of a first robotic arm (e.g., robotic arm 103A) of a robot system or a second robotic arm (e.g., robotic arm 103B) of the robot system to perform the massage on an object, the robot system including: a support structure (e.g., support structure 101); the first robotic arm, coupled to the support structure and including a first end effector having a first shape; and the second robotic arm coupled to the support structure, the second robotic arm separate from the first robotic arm and including a second end effector having a second shape that mirrors the first shape when observed from a common perspective. At least one of the first end effector or the second end effector is asymmetric about at least one two-dimensional plane that is perpendicular to an end effector plane of the at least one of the first end effector or the second end effector.

In some implementations, sending the at least one signal includes: sending a first signal to cause the first end effector to apply a first pressure to a first location on the object during a predefined period of time, and sending a second signal to cause the second end effector to apply a second pressure to a second location on the object different than the first location and during the predefined period of time, such that at least a portion of the first pressure opposes at least a portion of the second pressure within a common plane.

In some implementations, performing the massage includes: sending a first signal to cause, during a period of time, the first end effector to perform a first contacted motion across a first region of the object while applying a first set of pressures to the object; and sending a second signal to cause, during the period of time, the second end effector to perform a second contacted motion across a second region of the object while applying a second set of pressures to the object, each pressure from the second set of pressures being greater than an associated co-occurring pressure from the first set of pressures.

In some implementations, performing the massage includes: sending a first signal to cause, during a predefined period of time, the first end effector to perform a first contacted motion across a first region of the object; and sending a second signal to cause, during the predefined period of time, the second end effector to perform a second contacted motion across a second region of the object different than the first region of the object, the first contacted motion substantially mirroring the second contacted motion relative to a portion of the object.

In some implementations, performing the massage includes: causing the first end effector to apply a first set of pressures to a first region of the object during a first time period; causing the second end effector to apply a second set of pressures to a second region of the object different from the first region of the object, during a second time period that overlaps with the first time period; causing the first end effector to apply a third set of pressures to a third region of the object different from the first region of the object and during a third time period subsequent to the first time period; and causing the second end effector to apply a fourth set of pressures to a fourth region of the object different from the second region of the object and during a fourth time period subsequent to the second time period.

In some implementations, performing the massage includes: sending a first signal to cause, during a first period of time, the first end effector to perform a first contacted motion across a first region of the object; and sending a second signal to cause, during a second period of time different than the first period of time, the second end effector to perform a second contacted motion across a second region of the object different than the first region of the object, the first region substantially mirroring the second region about a portion of the object.

In some implementations, performing the massage includes: sending a first signal to cause, during a range of time, the first end effector to apply a first pressure to a first location of the object; sending a second signal to cause, during a first sub-range of time included in the range of time, the second end effector to apply a second pressure to a second location of the object; and sending a third signal to cause, during a second sub-range of time included in the range of time different the first sub-range of time, the second end effector to apply a third pressure to a third location of the object, the third location being closer than the second location to the first location.

In some implementations, performing the massage includes: sending a first signal to cause, at a first time, the first end effector to contact a region of the object using a first portion of the first end effector; and sending a second signal to cause, at a second time different than the first time, the first end effector to contact the region of the object using a second portion of the first end effector different than the first portion.

In some implementations, the robot system further includes: a third robotic arm coupled to the support structure and operatively coupled to the at least one processor, the third robotic arm being separate from the first robotic arm and the second robotic arm, the third robotic arm including a third end effector that is asymmetric about at least one two-dimensional plane that is perpendicular to an end effector plane of the third end effector.

In some implementations, the support structure includes at least one track, and at least one of the first robotic arm or the second robotic arm is slidably coupled to the at least one track.

In an embodiment, a method, comprises: receiving, via at least one processor of a robotic system (e.g., robot system 100), a signal representing an instruction to perform a massage; and sending, via the at least one processor, at least one signal to cause a robotic arm (e.g., robotic arm 103A) of the robot system to perform the massage on an object, the robot system including: a support structure (e.g., support structure 101); and the robotic arm, coupled to the support structure and including an end effector that is asymmetric about at least one two-dimensional plane that is perpendicular to an end effector plane of the end effector.

In some implementations, the robotic arm is a first robotic arm and the end effector is a first end effector, the robot system further including a second robotic arm coupled to the support structure, the second robotic arm including a second end effector that is asymmetric about at least one two-dimensional plane that is perpendicular to an end effector plane of the second end effector, and wherein the sending the at least one signal further causes the second robotic arm to perform the massage. In some implementations, performing the massage includes: sending a first signal to cause the first end effector to apply a first pressure to a first location on the object during a predefined period of time; and sending a second signal to cause the second end effector to apply a second pressure to a second location on the object different than the first location and during the predefined period of time, such that at least a portion of the first pressure opposes at least a portion of the second pressure within a common plane. In some implementations, performing the massage includes: sending a first signal to cause, during a period of time, the first end effector to perform a first contacted motion across a first region of the object while applying a first set of pressures to the object; and sending a second signal to cause, during the period of time, the second end effector to perform a second contacted motion across a second region of the object while applying a second set of pressures to the object, each pressure from the second set of pressures being greater than an associated co-occurring pressure from the first set of pressures. In some implementations, performing the massage includes: sending a first signal to cause, during a predefined period of time, the first end effector to perform a first contacted motion across a first region of the object; and sending a second signal to cause, during the predefined period of time, the second end effector to perform a second contacted motion across a second region of the object different than the first region of the object, the first contacted motion substantially mirroring the second contacted motion relative to a portion of the object. In some implementations, performing the massage includes: causing the first end effector to apply a first set of pressures to a first region of the object during a first time period; causing the second end effector to apply a second set of pressures to a second region of the object different from the first region of the object, during a second time period that overlaps with the first time period; causing the first end effector to apply a third set of pressures to a third region of the object different from the first region of the object and during a third time period subsequent to the first time period; and causing the second end effector to apply a fourth set of pressures to a fourth region of the object different from the second region of the object and during a fourth time period subsequent to the second time period. In some implementations, performing the massage includes: sending a first signal to cause, during a first period of time, the first end effector to perform a first contacted motion across a first region of the object; and sending a second signal to cause, during a second period of time different than the first period of time, the second end effector to perform a second contacted motion across a second region of the object different than the first region of the object, the first region substantially mirroring the second region about a portion of the object. In some implementations, performing the massage includes: sending a first signal to cause, during a range of time, the first end effector to apply a first pressure to a first location of the object; sending a second signal to cause, during a first sub-range of time included in the range of time, the second end effector to apply a second pressure to a second location of the object; and sending a third signal to cause, during a second sub-range of time included in the range of time different the first sub-range of time, the second end effector to apply a third pressure to a third location of the object, the third location being closer than the second location to the first location. In some implementations, performing the massage includes: sending a first signal to cause, at a first time, the first end effector to contact a region of the object using a first portion of the first end effector; and sending a second signal to cause, at a second time different than the first time, the first end effector to contact the region of the object using a second portion of the first end effector different than the first portion.

In some embodiments, an apparatus includes a support structure configured to support an object, a first robotic arm coupled to the support structure and including a first end effector, a second robotic arm coupled to the support structure, the second robotic arm separate from the first robotic arm and including a second end effector, and at least one processor operatively coupled to the first robotic arm and the second robotic arm. The at least one processor is configured to perform coordinated body work on the object using the first robotic arm and the second robotic arm. The coordinated body work includes sending a first signal to cause, during a predefined period of time, the first end effector to perform a first contacted motion across a first region of the object. The coordinated body work also includes sending a second signal to cause, during the predefined period of time, the second end effector to perform a second contacted motion across a second region of the object different than the first region of the object, the first contacted motion substantially mirroring the second contacted motion relative to a portion of the object.

In some implementations, at least one of the first end effector or the second end effector is asymmetric about at least one two-dimensional plane that is perpendicular to an end effector plane of the at least one of the first end effector or the second end effector.

In some implementations, the support structure includes at least one track, and at least one of the first robotic arm or the second robotic arm is slidably coupled to the at least one track.

In some implementations, at least one of: (1) the first end effector is not symmetric about any two-dimensional plane that passes through a center of at least one first mounting flange associated with at least one of the first end effector or the first robotic arm, or (2) the second end effector is not symmetric about any two-dimensional plane that passes through a center of at least one second mounting flange associated with at least one of the second end effector or the second robotic arm.

The modifications listed herein and other modifications can be made by those in the art without departing from the scope of the disclosure. Although subject matter has been described herein with reference to specific embodiments, the invention(s) is not limited to the above embodiments and the specific configurations shown in the drawings. For example, some components shown can be combined with each other as one embodiment, and/or a component can be divided into several subcomponents, and/or any other known or available component can be added. The processes are not limited to those shown in the examples. Those skilled in the art will appreciate that the invention(s) can be implemented in other ways without departing from the substantive features of the invention. For example, features and embodiments described above can be combined with and without each other. The present embodiments are therefore to be considered in all respects as illustrative and not restrictive. Other embodiments can be utilized and derived therefrom, such that structural and logical substitutions and changes can be made without departing from the scope of this disclosure. This Specification, therefore, is not to be taken in a limiting sense, along with the full range of equivalents to which such claims are entitled.

The following are further embodiments of an end effector for robotic massage.

Described herein are further embodiments of end effectors (also referred to herein as “touchpoints”) for robotic massage. Embodiments of the end effector described herein affect the manner in which a robotic massage system interacts with a deformable body, such as a person.

Existing solutions for robotic massage may be overly simplified or overly complex. For example, existing massage guns may have simplistically shaped end effectors that are overly generalized and not effective for multiple types of massage. As another example, some existing robotic massage systems include end effectors that attempt to emulate a human hand. This can be complex and challenging to implement. For example, while having robotic “fingers” may have a high degree of configurability, they may also be more complex and difficult to control.

Embodiments of the end effector described herein provide an improvement over existing touchpoints by integrating multiple body parts (that would be used by a masseuse) into a unique end effector shape that is able to replicate many different ways to interact with a person.

In some embodiments, the touchpoint described herein is an asymmetric design that has multiple surfaces that correspond to different surfaces of a massage therapist's body (e.g., various parts of their hands or arms) that the massage therapist would use when performing massage.

Embodiments of the end effector described herein include various components/aspects/facets which will be described in further detail below, including, without limitation:
External Shape
Internal Structure
Material Selection and Interaction of Selected Materials
External Coating
Heating and Sensing Elements Internal to the end effector

The various components of the end effector are designed and selected to provide a comprehensive and effective massage experience. In various embodiments, the various components of the touchpoint are designed based on considerations such as, without limitation:
Massage content and the massage tools needed to implement various types of massage strokes
Therapeutic effect and comfort
Variability between subjects
Robotic limitations, such as minimally specified hardware and collision avoidance.

### Robotic Massage System Overview

FIG. 7 illustrates an embodiment of a robotic massage system. In this example, robotic massage system 700 includes various components. For example, system 700 includes a bed or platform or table 702 that a participant or subject rests on. In this example, system 700 further includes two robotic arms 704 and 706, one on each side of the table. While an example robotic massage system with two robotic arms is shown in this example for illustrative purposes, the robotic massage system may be variously adapted to accommodate any other number of robotic arms, as appropriate. As shown in this example, the arm includes one or more segments or links that are interconnected by a set of joints. In some embodiments, there are one or more controllable motors or actuators at each of the joints, which allows the links to be moved, thereby allowing the robotic arms to be articulated. At the ends of each of the arms 704 and 706 are, respectively, end effectors 708 and 710 (also referred to herein as touchpoints). In some embodiments, the end effector is a removable device that is attached to a wrist of the robotic arm. The end effector makes contact with the deformable body of the person. As will be described in further detail below, the end effector is shaped for performing various massage techniques, such as pinning, rolling, stretching, grabbing, etc.

In this example, the bases of the robotic arms (that are on the ends opposite of the end effectors) are attached to a rail system. For example, the bases of the arms are pivotably attached to base 712. In this example, base 712 is connected to a linear rail system embedded within the bed. The rail system is a controllable system that allows the base 712 (and thus the arms) to translate linearly along the length of the bed 702. In some embodiments, there is a single base (e.g., plate) that both arms are connected to, and both arms move linearly together when the plate is moved along the linear rail. In other embodiments, the arms are independently translatable along the length of the bed/table. For example, each arm is attached or mounted to its own base plate, which in turn is attached to its own individual rail.

The combination of the controllable linear rail system, as well as the controllable motors in the robotic arms described in this example, allows the end effectors to be positioned to reach any part of the subject's body. In this way, the end effector may be positioned to perform a task such as making physical contact with specific points on a subject's body, where the robotic arm and end effector are controlled (e.g., in an automated or computerized manner) to provide a certain pressure at those targeted points on the subject's body.

In various embodiments, the hardware of the robotic massage system, such as the end effectors, robotic arms, and linear rail, are controlled by one or more controllers that send commands (e.g., torque commands) to actuators of the hardware (e.g., the robotic arms). Torque commands are one example type of interface for controlling a robot. Other types of interfaces may be utilized, as appropriate. In some embodiments, the controller is controllable via a computing device such as an embedded tablet and controls 718 (example of an input device for receiving user commands and presenting information) that a user may interact with (e.g., via graphical user interfaces displayed on the tablet, physical controls, voice commands, eye tracking, etc.). Other examples of input devices include, in various embodiments, joysticks, 3D mice, microphones, tablets/touchscreens, buttons, game controllers, handheld remotes, etc. In some embodiments, the hardware is controlled automatically by a networked computer system of the robotic massage system.

In this example, the robotic massage system also includes sensors housed above the table at 714 and 716. In some embodiments, the sensors include vision components situated above the table. In some embodiments, the vision components are utilized by the robotic massage system to generate a view of a subject's body, as well as a characterization of the tissue of the body. Examples of imagery generated by the sensors include depth cameras, thermographic imagery, visible light imagery, infrared imagery, 3D (three dimensional) range sensing, etc. In some embodiments, the overhead structures used to hold the sensors also include lights for lighting the participant's body.

### Exterior Form of the End Effector

In some embodiments, the touchpoint described herein is a monolithic structure that includes multiple surfaces (also referred to herein as “tools” or “interaction regions”), where different surfaces of the touchpoint may be used to accomplish different massage purposes. For example, the touchpoint has an asymmetric shape that allows the same touchpoint to deliver various types of contact with a user, by orienting the end effector into a desired position using the robotic arm so that the appropriate surface on the end effector is in contact with the user. For example, the endpoint includes multiple surfaces (also referred to herein as “tools” for implementing different types of massages) that provide different massage effects based on the type of surface, the location of the tool on the end effector, and the angle of the tool. As one example, each surface emulates a different portion of a massage therapist's hand or arm. Based on how the robotic arm and end effector touchpoint are oriented, different surfaces of the touchpoint will engage with the patient or subject to create various different force or pressure profiles.

The combination of different tools on the same touchpoint allows the robotic massage system to provide a broad set of massage content (e.g., different types of massage strokes), and a broad set of ways of interacting with a person. Further, the tools and surfaces of the touchpoint are designed to provide broad sets of massage content and ways of interacting with a person in a condensed space.

In some embodiments, the placement of those tools takes into account robotic limitations. This provides a minimal-sized hardware, removing the need to have motors that create large amounts of force if not needed.

Embodiments of the end effector described herein include a 3-dimensional shape that is used as part of a robotic massage system. In some embodiments, two mirror-image touchpoints are mounted to the ends of robotic arms on either side of a person lying prone on a table. In some embodiments, each end effector embodies a number of segments throughout that mimic the feel or effect of different massage techniques delivered by a massage therapist.

In some embodiments, surfaces/tools of an end effector refer to different parts of the body. In some embodiments, there is a correlation or mapping between the different tools or surfaces of the end effector and a portion of the body that a massage therapist uses. For example, the segments correspond to various portions of a massage therapist's arm or hand.

The shape of the end point is not necessarily limited to mapping what a human therapist does. For example, even though the human hands are dexterous and can move in various angles, a human therapist may still be limited by the shapes and sizes of their hands and fingers.

While example mappings or correlations to massage therapist usages are described for illustrative purposes, the tools may be used for other massage purposes. For example, tilting over parts of the tool will result in certain surfaces being provided, allowing different types of massage strokes to be performed. For example, broader stripping with higher specificity can be provided. As another example, the different surfaces of the end effector map or correlate to different types of massage techniques (e.g., focused, broad, or pinpointed compression, effleurage, cupping, broad stripping, etc.).

The various surfaces are designed to provide various types of functionality, such as with respect to strokes, with respect to force performance, etc.

In some embodiments, the end effector includes a solid inner skeleton shape, covered by a soft compressible material. In some embodiments, the skeleton's size and shape along with the thickness and shape of an outer soft material at each of the segments result in a touch that can be controlled through design. For example, the skeleton and outer surface can be shaped and sized to replicate a human-like touch mimicking the hand, knuckles, forearm, elbow, thumb, palm or a cupped hand.

FIG. 8A illustrates an embodiment of an end effector. As shown in this example, the touchpoint includes seven different areas or segments, where each area corresponds to a part of an arm or hand of a massage therapist and/or a type of massage technique. While in this example, a touchpoint with seven tools is shown, the touchpoint may have any number of segments. In this example, a perspective view of the end effector is shown. For purposes of clarity, the portion of the end effector that contacts the user is referred to as the “contact surface” 816 of the touchpoint. In some embodiments, region 814 corresponds to the “top” of the contact surface of the end effector. The mounting area (also referred to herein as the “underside” or “bottom”) of the end effector (which is where the end effector connects to a robotic arm) refers to the portion of the end effector shown at 818. The “back” of the end effector refers to the portion of the end effector shown at 820. The “front” of the end effector refers to the portion of the end effector shown at 822.

In this example, the end effector includes the following features/tools:

Focused Compression (Thumb) (802): In some embodiments, this region is also on a pointed-out portion of the end effector, where the pointing out is designed such that the thumb region is able to reach parts of the body such as the neck, without having other parts of the end effector or robotic arm (e.g., linkages) colliding with the user. In some embodiments, the thumb segment facilitates focused compression. In various embodiments, the thumb provides a focused area for trigger point compressions, upper trap work, cross-body work, etc.

The following are further embodiments of the focused compression segment. In some embodiments, the focused compression segment replicates the press of the thumb. It can be used in a direct downward force, or its sides can be used (allowing it, for example, to press against the side of a person's neck). In some embodiments, this segment is a long slender shape, with soft material that helps distribute pressure at the tip.

Blade (of Hand) (804): In some embodiments, the local surface of the blade portion of the tool has both flatter and sharper portions, where, for example, the blade portion has an edge. Depending on the angling of the tool (which may be adjusted by adjustment of the robotic arm) a different portion of the blade tool can be utilized and put in contact with the user's surface. For example, by angling or tilting the touchpoint over, the edge of the tool can be put in contact with the user, allowing it to be used to perform specific types of work, where, for example, because that edge is elongated, broader stripping can be performed while having high specificity. In various embodiments, the blade segment is a focused area that facilitates stripping on the next, stripping up the back, leg work, etc.

The following are further embodiments of the blade segment of the end effector. In some embodiments, this segment embodies a soft ridge, located, for example, along the top edge of the end effector, replicating the side of the hand from the base of the little finger to the wrist. This creates a long thin surface, and may be used, in various embodiments, for gentle stripping, a sliding motion, for applying pressure to the shoulder blades, etc. In some embodiments, the highest area of pressure along the length of the ridge mimics the side of the metacarpophalangeal joint of the little finger (the MP joint located at the base of the little finger), the point at which the proximal phalange meets the metacarpal bone.

Broad Stripping (Forearm and Forearm-to-Elbow) (806): In some embodiments, the forearm segment facilitates broad stripping and compression. This includes facilitating pin and stretch, horizontal motions along the legs, etc.).

In some embodiments, the broad stripping segment is formed by a ridge on the end effector that replicates a massage therapist's forearm from the wrist to the elbow. In some embodiments, this segment provides a longer surface to create a lower friction movement.

In some embodiments, in addition to replicating broad strokes, this segment may also be used in tandem with a second robot arm to create a pin-and-stretch movement, where a touchpoint of a robot arm on one side of the massage table steadies the body, while the broad stripping segment on the other side slides away in a broad stroke to stretch the body.

In some embodiments, the forearm ridge extends to the stripping (pinpointed compression/elbow) segment 808 (described below), to replicate a massage therapist's movement that starts with the forearm and ends with the elbow. In some embodiments, the end of the broad stripping segment (e.g., the end of the end effector that is near the pinpointed compression segment 808) incorporates a bump, to replicate the feel of the lateral and medial epicondyles that are at the end of the humerus (upper arm) and the styloid process of the radius and ulna bones of the forearm.

Stripping (Pinpointed Compression/Elbow) (808): In some embodiments, the elbow segment facilitates pinpointed compression. In some embodiments, the elbow segment provides a high-intensity area, facilitating, in various embodiments, high-intensity stripping, trigger point compressions, cross-fiber stretching, etc. In some embodiments, a far end of this region of the end effector includes a bump to replicate the bump at the end of a therapist's elbow.

In some embodiments, the stripping segment is designed to create a high-pressure point, simulating the touch or the press of a massage therapist's elbow. A direct press of the elbow results in concentrated pressure on the body exerted, for example, by the distal end of the ulna bone.

Effleurage (Palm) (810): In some embodiments, the palm provides a relaxation area. In various embodiments, the palm segment facilitates relaxing effleurage, transition strokes, mother hand, etc.

In some embodiments, the effleurage segment mimics the feel of a massage therapist's palm, including the touch of the array of eight carpal bones in the wrist. In some embodiments, the segment is a concave shape, resulting in most pressure being applied at the edges, less in the center of the segment. In the hand, pressure from the wrist bones is being made primarily by the pisiform bone (on the little finger side) and the trapezium (on the thumb side).

Cupping (Cupped Hand) (812): In some embodiments, the cupped hand tool is locally concave (while the general shape is convex). In some embodiments, the cupped hand portion of the tool is used as a support area, such as for asymmetric work. For example, suppose massage is to be performed on the legs. The concavity of the cupped hand portion of the tool allows the end effector to be braced around the leg to provide support when force is being applied in another direction (e.g., sideways). For example, the cupped hand provides support such as leg support, leg effleurage, etc.

As another example, the concavity of the cupped hand portion of the tool is beneficial to avoid collisions where the two legs are next to each other, and the end effector is to reach the inside or interior surface of the leg (e.g., side of leg facing the other leg).

In addition to providing bracing, the cupped hand tool is also used to perform massage content. For example, the exterior curvature is used for the legs to provide, for example, broad effleurage. With the concave shape, the cupping hand tool can provide broader contact with less force, without requiring deformation to make contact.

In some embodiments, the massage system's two robot arms can work in unison, with one arm steadying the body. The cupping segment can be used, for example, to steady the inner thigh while the second robot arm delivers the massage. In some embodiments, the cupping segment is curved to mimic a cupped hand, and in various embodiments is designed as a planar curve or a concave shape.

Broad Compression (Knuckles and Elbow) (814): In this example, the knuckle or “top” portion of the end effector is the highest force area that can be used (e.g., 200+ Newtons of pressure directly under the arm). The forearm and elbow portions are similarly designed to provide a high force given joint configurations of the robotic arm. In some embodiments, the knuckle segment facilitates broad compression. In some embodiments, the knuckle segment is a high-force area that facilitates power compressions, high-force stripping, etc.

In some embodiments, the knuckle segment, which mimics knuckles as well as fingertips, creates focused points of contact. In some embodiments, it replicates the touch of a massage therapist's closed hand, either a clenched first or clenched fingers, or extended fingers with fingertips being the points of touch. In some embodiments, this segment of the touchpoint is designed to feel similar to the massage therapist's touch using the metacarpophalangeal joints (knuckles at the base of the fingers), the interphalangeal joints (joints between the fingers' bones), and fingertips. In some embodiments, this segment can also be used to mimic the touch of a massage therapist's elbow.

FIG. 8B illustrates an embodiment of an end effector. In this example, a perspective view of the touchpoint, as attached to an end of the robotic arm, is shown. In this example, the numbered regions correspond to the numbered regions described in conjunction with FIG. 8A.

Some massage motions may involve the use of multiple segments, such as transitioning from one segment to the next. For example, broad compressions may be supported by both the knuckles and elbow segments. Broad stripping may be facilitated by not only the forearm, but also transitioning from the forearm segment to the elbow segment.

For example, the various tools support different types of therapeutic or interaction events, such as focused compression (thumb), blade (side of hand), broad compression (knuckles, elbow), broad stripping (forearm, forearm to elbow), pinpointed compression (elbow), effleurage segment (palm), cupping (cupped hand), etc.

### Exterior Material Selection

The following are embodiments of material selection for the exterior surface of the end effector. In some embodiments, the exterior of the end effector is a shell that surrounds an internal structure, further details of which are described below. As one example, exterior material is over-molded over an internal skeleton.

The following are example factors that are taken into consideration with respect to material selection:
Biocompatibility of materials that are being used
Longevity—how well materials handle, for example, shear forces
Manufacturability—manufacturability of material while having a certain lifespan

In various embodiments, determining material selection for feel (e.g., to feel similar to a human hand or to provide a luxurious experience or to provide a similar level of intensity) includes selecting material durometer, as well as the “give” of the material (e.g., elasticity, deformation properties, etc.). In some embodiments, give relates to the stiffness of the durometer. In some embodiments, the durometer/hardness for a material such as silicone provides an indirect metric for give. In some embodiments, give is a result of both the stiffness and the depth of the material—that is, how the contact surface deforms under a certain amount of force. The “give’ of the material and the curvature of the surface play a factor in the feel that the touchpoint creates. For surfaces that cover a broader area, deeper amounts of silicone allow the surface to deform more and feel softer, as compared to other areas that have less depth of material (and less “give” as a result). The relationship between material depth and stiffness determine the relative “give.”

Different materials may engage in various ways, and there may be various tradeoffs when selecting material(s) that cover the touchpoint, such as between firmness, luxuriousness of feel, thickness, durability, etc.

For example, the material will wear down over time. The thicker the material, the more stretch there is from the shear forces that are experienced by the material. In some embodiments, the area and durometer of the exterior material are selected based on durability. For example, durometer is accounted for with varying depth of material, where for a stiffer or higher durometer material, a greater depth of the material (e.g., silicone) may be used. For example, one tool may have a thinner material depth (e.g., 10 mm), while another tool may have a thicker material depth (e.g., 22.5 mm). In some embodiments, there is a minimum thickness in order to distribute the shear forces. This is due in part to the distribution of force across a large enough area of the internal skeleton so that the exterior material (e.g., silicone) is not peeled away from the skeleton.

One example of an external material for the end effector is silicone. As one example, silicone with a durometer in a range of 5 A-50 is selected for the exterior material. Other examples of exterior materials include rubber, rubber foams, high density foam, flexible or elastic resins, PTFE or other fluoropolymers, or any biocompatible elastomer such as a polyurethane, as appropriate.

In some embodiments, the determination of the material and its durometer is based on performing pressure mapping. For example, the material is selected such that the pressure imparted via the material mimics the pressure profiles of massage therapists.

In some embodiments, the end effector is characterized by using a pressure map. Strokes similar to that performed by a therapist are performed using the appropriate or correlated tools on the end effector. The pressure profiles that are observed are mimicked to provide a similar distribution of pressure and intensity as compared to a human therapist. Such pressure and intensity profiling may also be used to determine the size and material selection of the various areas of the touchpoint.

In some embodiments, the same material is used across the entire end effector. For different portions (e.g., tools) of the end effector, different combinations of durometer/material thickness may be utilized. As one example, the same durometer of material is used around the entire end effector, but with different tools having different thicknesses (that is, as one example, the durometer is the same for all tools, but the thickness may vary between tools).

For example, varying the thickness of the material provides different effects. Keeping the same durometer for the entire shape provides for ease of manufacture. Different exterior material thicknesses, in conjunction with the structure of the internal skeleton, provide a therapeutic effect desired given the shape (of a tool) for a single durometer. In some embodiments, the durometer is selected for durability of the touchpoint (with a bias towards durability with respect to therapeutic content).

In some embodiments, durability of the end effector is determined based on the selected durometer of the exterior material. Providing a therapeutic benefit for therapeutic content is determined by thickness and also internal structure, which impacts how the material will compress or relax as the end effector interacts with the subject's body.

In some embodiments, the specification of the material (e.g., material selection, durometer, and/or thickness) is determined based on the properties of the internal structure (e.g., skeleton) of the end effector.

As described above, the thickness of the exterior material is varied in some embodiments depending on the tool. For example, thin or medium thickness of the focused compression section (e.g., thumb) may allow for more versatility based on the robot arm pressure being applied. The thickness within an individual segment may also vary. As one example, as part of the effleurage segment (e.g., palm), a thicker silicone may be used generally, while the portion of the palm emulating carpal bones of the outer edge of the wrist (which provide the most pressure) has a thinner amount of silicone at the outer edges so that they may be felt.

FIG. 9A illustrates an embodiment of exterior material thickness of an end effector. In this example, a cross-section of an end effector is shown. In this example, the cross-section illustrates different thicknesses for different portions or segments of the end effector, as well as varying thickness within a single tool.

In this example, a silicone coating (example of selected exterior material, as described above) is shown at 902. As shown in this example, there is a varying thickness to the exterior silicone across the end effector (that is, the exterior material is not of uniform thickness around the end effector). The thickness may vary between tools, to allow operation in different manners. For example, the material may be thinner for the tools corresponding to the knuckle or the blade. For the palm portion, more (e.g., thicker) material is used to provide a softer feel. A greater thickness of material tends to provide a softer, more luxurious feel, while less material (lower thickness) tends to provide a higher intensity (e.g., greater, more direct transfer of force, with less buffering) to provide an added type of therapeutic effect. The thickness may also vary within an individual tool, an example of which is described in further detail below.

As shown above, different tools have corresponding depths (which may vary within an individual tool as well). For example, there may be a range of different millimeters of depth (e.g., between 1 mm-50 mm) relative to the exterior surface of the endpoint (including the material), where there may be greater depth for areas such as the palm. For other areas, such as the knuckle or blade, the depth may be lower (corresponding to thinner material). This allows for a greater specificity of force to be transferred (as there is less cushioning from the exterior material and more interaction with the more rigid internal structure). Care should be taken with respect to the amount of thickness of the exterior material, as having too low thickness may reduce the durability of the material, where it may wear faster and rip because the material is too thin.

The following is another example of determining material thickness for a given tool based on pressure mapping. For a given tool, the pressure map for various depths is determined. This profile of pressure versus depth is then compared to the pressures observed or measured for human therapists. A depth (which in turn determines material thickness) is then determined based on matching to the pressures applied by a human therapist.

As one example, referring to the example of FIG. 9A, consider the palm area 810. In this example, the exterior side of the palm surface is convex, and has an outward curvature. The inner side of the exterior surface of the palm sits in a depression formed by the inner skeleton 904 (further details of which are described below). When this portion of the palm is contacted against a subject's body, the exterior portion of the silicone material will deform inwards towards the interior of the end effector, flattening the protruding curvature until there is a more even, broader surface.

The pressure mapping is used to determine an amount of applied pressure (to the user's surface) given an amount of material thickness. The material thickness, where it is, and its uniformity may then be determined based on matching that area's pressure to the pressure applied by a human therapist. Within a tool, the pressure that is applied is designed to be relatively uniform to match what a human therapist would do.

By varying exterior material thickness (in conjunction with the shape of the more rigid internal skeleton), the engagement or pressure profile of the surface is not completely uniform across the entirety of the overall surface of the end effector. This facilitates providing both relaxation and increased muscle engagement. This variation within the material thickness of the tool also changes engagement of the end effector with the user when performing strokes that have both directionality and/or varying pressure.

For example, suppose that the blade portion of the tool is being utilized. At a beginning of a stroke, when pushing of the end effector is initially commencing, a relatively flat portion of the tool is being used, resulting in a uniform pressure profile initially across that area of the tool. As the tool is pushed down further, the silicone will deform across the surface, resulting in a varying pressure profile on the actual body, depending on how much the end effector is pushed down, which causes engagement of the muscle in different ways. In this way, the same tool may be used to feel both broad and light, as well as higher force and specific.

The varying pressure profile for the tool also allows for the exterior material to be better pushed. For example, consider stripping strokes down the back. When stripping is being performed, it would be desirable if the end effector is pulling the muscle, and dragging it, as the extension of the muscle provides a release of the muscle, which increases blood flow, and will provide a therapeutic benefit to the subject.

If the end effector were completely flat, when pushing down, this would result in sliding, and a lower level of friction. In some embodiments, the variation in the surface of the tool takes into account the friction on the surface of a garment that the user wears when performing massage. Further details of such a garment, as well as friction compensation/management, are described below.

By allowing variability, the material can be caused to bunch in a manner similar to the way in which the hand does, where when the masseuse pushes down with their hand, their tissue will bunch up about their bones. The exterior material will bunch up against portions of the inner structure. For example, the inner structure may have an overall global shape with localized variations such as cut-outs, protuberances, etc. in particular areas to facilitate bunching of material.

### Friction Management

In some embodiments, the end effector is designed to manage friction, such as to provide, as the end effector slides or moves across the subject's body, a desired coefficient of friction (or for the coefficient of friction to be within a range). A certain amount of friction is desired, to create a certain amount of slip on the body at all times throughout a massage. For example, a coefficient of friction of zero, which is no friction, would result in no actual engagement of muscles, where dragging and pulling of the end effector against the user's body would not occur. Too high of a coefficient of friction however will cause irritation or bunching up of the subject's surface.

The following are various embodiments of management of friction between the exterior surface of an end effector and the body.

While an exterior material such as silicone provides flexibility, in some embodiments, the properties of the exterior material are augmented to provide a desired range of coefficient of friction. For example, an overwrap may be used to reduce friction when sliding stroke movements are being implemented.

### Covering

As one example, a cover is applied to the end effector when performing a massage. In some embodiments, the cover is disposable. As one example, a vinyl cover is placed over the touchpoint. LDPE (low-density polyethylene) material and fabric are other examples of coverings that may be applied. The covering provides the desired coefficient of friction.

### Coating/Wrapping

In some embodiments, the end effector is coated or wrapped with another material as part of the manufacturing process. For example, an LDPE plastic film, TPU (thermoplastic polyurethane), or a paralene film is wrapped over the end effector. The wrapping may involve applying multiple pieces of wrapping to the end effector. This results in an additional discrete surface forming over the silicone, where the wrapping provides the desired coefficient of friction.

### Treating/Doping

In some embodiments, the exterior material is doped or treated with another material that causes the exterior surface of the end effector to have a desired coefficient of friction when in contact with the subject.

For example, the endpoint is dipped or infused with another material to cause the surface properties of the silicone to change. As one example, silicone is injected or impregnated with another material to change its properties. This causes the properties of the upper layer of the silicone exterior to be changed via introduction of another chemical compound. Examples of compounds used to dope silicone include, in various embodiments, tungsten for radiopacity, peroxide catalyst additives for higher consistency in manufacturing, cross-linking by condensation using PDMS (polydimethylsiloxane), excess saline and tin for improved sealant properties, or combined with phenyl groups for its low friction properties.

### Lubricant

As another example, a consumable such as a lubricant or oil is applied to the user and/or the end effector. As one example, the touchpoint includes attachments such as an aerosolizer and sprayer, as well as a reservoir containing a lubricant. The lubricant is aerosolized and sprayed onto the body to provide a lubricated version of the massage. As the robotic arms move along the body, the lubricant is sprayed over the user's body, which is then distributed and spread out. In some embodiments, implementing a stroke includes a step of applying lubrication to the person and distributing it, before resuming regular massage content.

As another example, lubricant is applied to the end effector. For example, the robotic system includes a reservoir of lubricant that an end effector is dipped in. In some embodiments, the lubricant is heated in the reservoir. As another example, the lubricant is sprayed onto the end effector.

As the lubricant may dry or be absorbed (which would affect the amount of friction between the end effector and the subject's surface), in some embodiments it is re-applied, where massage plans are adapted based on the reduction in lubricant over time. Lubricant may also be re-applied as the subject's body absorbs lubricant (where there may be variation between people in the rate at which their bodies absorb lubricant).

FIG. 9B illustrates embodiments of a variable lubricant sprayer architecture. In the example of FIG. 9B, two example sprayer architectures are shown. In some embodiments, the variable architecture supports swapping of pumps. In some embodiments, the pump architecture is swappable. For example, the architecture may be swapped between a liquid pump 922 versus an air pump 924. In some embodiments, the variable sprayer architecture includes swappable nozzle heads. In some embodiments, different spray nozzle heads provide different types of outlets, such as different numbers of outlets, different outlet shapes, etc. The different types of spray nozzle heads may be used to support various types of lubricant atomization.

### Garment

The coefficient of friction is dependent on both the end effector's surface, as well as the user's body. There is variation between people, such as different amounts of hair on the bodies, which can result in different amounts of friction between the end effector and different users.

In some embodiments, to provide a more predictable or controlled experience, as part of the massage, the user wears a shirt/leggings or other type of controlled massage clothing or garment. The controlled garment provides a normalized or standardized surface that the robotic massage system interacts with, removing variation across user surfaces.

The controlled garment assists in normalizing the amount of friction that the endpoint experiences with respect to the subject. For example, the use of a shirt removes hair that the end effector could catch on. Further, if a lubricant is used as described above, the use of the garment also allows a predictable lubricant absorption rate (where the skin of different users may absorb lubricant at different rates). Coverings and coatings described above may be selected for controlled garments, providing greater consistency across individuals, as they now effectively have the same “skin” from the perspective of the end effector. In some embodiments, rather than performing lubrication, a coating or film is on the end effector, which is paired with a controlled clothing. This controls for the variations across users' skin to control for the overall experience, where the variability in the surface among subjects is eliminated (as both the properties of the end effector surface, as well as the surface of the subject that the end effector interacts with, are controlled). Examples of materials that a garment (e.g., shirt) is made of include polyester, elastane, nylon, etc. In some embodiments, the garment is a blend of materials with different percentages/ratios of individual materials in the blend. In some embodiments, the coefficient of friction between the garment and the end effector is adjusted by varying the material selection and composition of the garment and/or the exterior material of the end effector (which may also be wrapped, lubricated, etc.).

In some embodiments, the user is fully enclothed in a garment. In some embodiments, the user is partially covered by the garment(s). For example, the user may be mostly clothed, except for areas such as the neck. In this case, a hybridized friction management for the massage may be performed, where differing amounts of lubricant are applied based on where the user is or is not covered by garments. Other embodiments of garments include hooded clothing (e.g., to cover regions such as the neck), body suits, specialized socks, multi-piece garments, etc.

### Interior Structure

In some embodiments, the end effector includes an internal structure that exterior materials (such as that described above) are molded over.

FIGS. 10A and 10B illustrate embodiments of an internal structure of an end effector. In some embodiments, the end effector includes an internal structure 1002, referred to herein as an internal “skeleton” of the end effector. As one example, the inner structure is a rigid, skeletal-type structure that provides support for the exterior material (1004).

Different perspective views of an end effector are shown in the examples of FIGS. 10A and 10B. In the example of FIG. 10A, a view from the “front” of the end effector is shown. In FIG. 10B, a side profile of the end effector is shown.

The internal skeleton structure may be made from various materials. In various embodiments, the internal structure is created from a 3D (three dimensional) printed plastic, aluminum, casted material, etc. In some embodiments, the material used for the internal structure is determined based on thermal properties, where in some embodiments, the touchpoint includes heating elements, further details of which are described below.

In some embodiments, the internal structure is smooth or flat. In other embodiments, the internal structure is a variable skeleton, where the surfaces of the skeleton are not necessarily smooth or flat, but may have various ridges, protuberances, lips, gaps, etc., which impact how the exterior material will compress or relax depending on how the end effector is being put in contact with the subject's body.

In some embodiments, the internal skeleton is dynamically adjustable. For example, actuators are placed inside the skeleton that cause various portions of the skeleton to change, allowing the shape (globally and/or locally) of the end effector to be dynamically changed. For example, the actuated interior skeleton may be configured to change the pressure profiles of the end effector.

In some embodiments, the interior structure or skeleton is designed in conjunction with the amount of material thickness across its surface. For example, the skeleton is designed with concavities and ridges to determine where there should be more or less material.

FIG. 10C illustrates an embodiment of a topography of an internal structure of an end effector. In some embodiments, negative space is introduced in the skeleton where thicker material is to be used. Contours of the interior skeleton of the palm tool are shown (contour lines 1032, 1034, 1036, and 1038) in this example, where the local region of the internal structure corresponding to the palm is concave, allowing for a relatively higher degree (and depth) of exterior material thickness, which provides more support, a more luxurious feel, etc. As one example, as the global surface of the end effector has various local regions for different types of tools, the global inner structure also has local skeleton regions that correspond to the tools described above (e.g., knuckle skeleton, palm skeleton, elbow skeleton, etc.).

On more therapeutic surfaces that provide, for example, higher force compressions and stripping, the skeleton is more pronounced (e.g., with ridge 1040 of the inner skeleton) to provide a higher level of engagement with tissue as the end effector moves along the body.

As described above, the amount of exterior material to be used varies depending on the tool type. In some embodiments, the palm and the cupped hand tools have a relatively thicker amount of material, where the thumb, knuckle, and elbow are relatively thinner. In some embodiments, the inner skeleton is shaped (e.g., with various local topographies) to accommodate for the desired varying exterior material thickness. For example, to allow for thicker material, the corresponding portion of the inner skeleton is made more concave, where concavity corresponds to depth.

In some embodiments, the interfaces between two tools are also designed to account for transitions between two tools. For example, at transition points between surfaces, the skeleton is designed so that when the end effector is rotated by the arm to transition from one surface to the next, the rotation will cause the material to be bunched up, providing a softer space. This provides increased engagement to hook into muscles, similar to as what would occur when a human therapist uses their bones. This provides a more bone-based skeleton approach.

By allowing variability of the material thickness, in conjunction with coordinated shaping of the internal structure, the material can be caused to bunch in a manner similar to the way in which the hand does, where when a therapist pushes down with their hand, their tissue will bunch up about their bones. Having cut outs or gaps along portions of the inner skeleton will cause the exterior material (e.g., silicone) to bunch up against portions of the inner structure.

For example, the inner structure includes a protuberance or hook (e.g., formed by placing various ridges and concavities in the inner structure), where pushing the end effector into the body will cause the material in front of the ridge to compress and bunch up the material—that is, the specificity or shaping of detail portions of the inner skeleton allows the inner structure to push into the material, and into the user's tissue. As one example, a Y-shaped portion of the inner structure will cause exterior material to be bunched up when the end effector is pushed along a person's body. In some embodiments, a Y-shape or L-shape with a pocket is used to implement the portion of the inner skeleton corresponding to the knuckle. This allows for more focused pressure to be created, as well as to emulate grabbing by a bone. In some embodiments, an L-shaped structure located towards the elbow side of the end effector allows motions to be performed that are similar to that of driving with the of the palm of the CMC (carpometacarpal) joint.

That is, what is felt by the user is a function of the force transferred through both the internal structure of the end effector and the exterior material (which will have a certain durometer and thickness).

FIG. 10D illustrates an embodiment of shaping of an internal structure of an end effector. As described above, the shape of the internal structure will cause the exterior material to compress or stretch or relax in various ways when manipulating the end effector (e.g., moving the tool relative to a person's body, transitioning between tools, etc.). In this example, a gap 1052 is introduced between two surfaces/tools (e.g., between the knuckle and forearm tools), so that when the end effector is rolled, a ridge is disengaged. For example, when forearm stripping is performed, the ridge is not engaged. In some embodiments, the ridge at the base of the palm creates variability in traction/grabbing of effleurage strokes.

In some embodiments, a similar gap is placed at the “back” of the end effector at elbow tool location 1054. This will allow the elbow to have increased grip for stripping strokes without requiring as much angular difference on the surface. The variable skeleton described herein allows a smooth outward shape and form (which is based on the exterior material), while allowing for various pressure profiles based on the compression or relaxation of the material relative to the inner structure (which may have various concavities, convexities, protuberances, ridges, gaps, lips, etc. that affect how the exterior material compresses or relaxes).

### Mounting of the End Effector

The example of FIG. 8B illustrates an embodiment of an end effector mounted on a robotic arm. In some embodiments, the end effector is rigidly linked to an end of the arm. In other embodiments, the end effector is rotatably attached to the last link of the arm. For example, there is a motor at the end of the arm that controllably rotates the orientation of the end effector.

In some embodiments, the “underside” or “bottom” of the touchpoint (mounting area) includes a plate or other connector that rigidly connects the touchpoint to an end of a robotic arm. In this example, the touchpoint's position relative to the arm is fixed (although it may be rotated about an axis). Additional degrees of freedom for adjusting the position and orientation of the touchpoint may be introduced by introducing more links of the robotic arm.

In some embodiments, due to the asymmetry of the end effector, there are different end effector variants for the left and right arms. For example, the left end effector and the right end effector are mirrors of each other when mounted on the arms.

In some embodiments, each end effector has a specific mounting interface or mounting pattern (e.g., robotic flange mounting pattern) so that it cannot be mounted incorrectly to the wrong arm, and so that it cannot be mounted in the wrong orientation on an arm. For example, in some embodiments, the mount is asymmetrical. The specific mounting pattern ensures that an end effector is attached to the appropriate arm in the correct orientation.

In some embodiments, the mounting position (where the end effector mounts to the last link of a robotic arm) is centered towards an end (e.g., “front” or “back”) of the endpoint. In some embodiments, the asymmetrical mounting position reduces collisions.

As described above, in some embodiments, the end effector is connected to an end of an arm via a mounting adapter. In some embodiments, the mounting adapter includes a mounting pattern that forces an asymmetric and specific mounting configuration to prevent incorrect mounting of the end effector.

In some embodiments, the mounting adapter includes a flange. In some embodiments, electric connections (further details and embodiments of which are described below) come through the bottom of the flange. In some embodiments, the use of such a mounting adapter facilitates switching out of the touchpoint in the field.

FIG. 8C illustrates an embodiment of an end effector mounting mechanism. In this example, mounting or attachment of an end effector to a robot arm is shown. In the example of FIG. 8C, an end effector 822 is shown. In this example, the end effector includes a mounting portion 824. Mounting portion 824 includes channels that slot into a receiving portion 826 of a robotic arm. The receiving portion 826 includes flanges in this example. When the mounting portion 824 of the end effector 822 is pushed into the end of the flange of receiving portion 826 of the arm, the mounting portion 824 slots into the receiving portion 826, resulting in a type of press fit. To secure the end effector to the arm, the receiving portion 826 includes a screw 828. As one example, mount 824 includes a threaded insert that receives the screw 828, causing the screw to be pulled in when it is turned or tightened. After inserting of the end effector, turning of the screw secures the end effector to the arm. This results in a rigid mount between the end effector and the arm with a single connection. In this example, the screw is used to lock in the dovetail that forms when slotting the mounting portion 824 into the receiving portion 826. Unscrewing or loosening the screw 828 releases the end effector, allowing the end effector to be slid out and removed.

In some embodiments, to prevent the screw 828 from falling out when the end effector is not attached, the receiving portion 826 includes a mounted piece of metal that holds or locks the screw in place. As shown in this example, to mount the end effector, mounting portion 824 of the end effector is slid into the receiving portion 826 of the arm. The screw 828 is tightened to secure the end effector to the arm. To remove or release the end effector, the screw is unscrewed. The locking or holding mechanism attached to the screw prevents the screw from falling out of receiving portion 826. In some embodiments, actuated or automated locking is performed. For example, motors or other actuators are used to secure the end effector to the arm. As one example, a motor is used to drive the screw. Other examples of securing mechanisms include cam mechanisms to lock the end effector to the arm.

In the example of FIG. 8C, end effector 822 also includes electrical connector 832. When the end effector is inserted into the slot of arm receiving portion 826, the electrical connector is also slid in. The electrical connector provides an electrical connection between the arm and the end effector, facilitating communications between the robotic system and components of the end effector such as the heating elements, electrical components, etc. which, for example, are embedded in portion 824 of the end effector. In some embodiments, receiving portion 826 includes a receptor or receptacle for connecting or coming in contact with electrical connector 832.

In some embodiments, the end effector mounting mechanism is configured to connect to a specific arm (e.g., left arm or right arm). For example, the insertion interface of the end effector determines which arm an end effector can insert into. As one example, the mounting portion 824 is shaped to be inserted into a specific arm. Another example insertion interface for determining which arm the end effector is able to mount to is the electrical connector. In some embodiments, the electrical connector is shaped or constructed to be unique to a specific arm. For example, the shape of electrical connector 832 dictates whether the end effector attaches to the right arm or the left arm (such as in the example two arm system shown in FIG. 7). This prevents the end effector from being attached to an incorrect arm, and ensures that an end effector is only attachable to an appropriate arm. As one example, the receiving portion 826 of the arm includes a corresponding piece that an appropriately shaped end effector electrical connector would slot into. If the end effector's electrical connector is not compatible with the receptacle in the arm's receiving portion 826 (e.g., because a user is attempting to mount an end effector to the wrong arm), then the end effector is prevented from being slotted in completely. This further results in a gap that prevents the screw 828 from being able to reach the threaded insert in mounting portion 824 (preventing the end effector from being locked to the arm). Further, the end effector is not able to form an electrical connection to the arm. This allows control of which arm (or arms) the end effector is able to connect to.

In some embodiments, the end effector 822 is constructed as a single piece or consumable. At its end of life, the entire end effector is swapped out with a new end effector. In other embodiments, the end effector is modular, where sub-portions may be substituted out or replaced. For example, interaction portion 830 of the end effector is swappable (e.g., to replace a worn-down piece with a new piece or a different shaped piece).

As described above, the end effector 822 includes electrical connector 832 that facilitates an electrical connection between the robotic system and the end effector. In some embodiments, an electrical connection between the robotic system and the end effector is required before a massage is allowed to commence. For example, the robotic system prevents or prohibits a massage from initiating if an electrical connection is not established between the robotic system and the end effector.

In some embodiments, the end effector includes an electronics board (e.g., printed circuit board (PCB)) that is used to control various elements of the end effector (e.g., heating elements, sensors, etc.). In some embodiments, when the end effector is connected, connectivity to the electronics board is verified. In some embodiments, a registration process is performed. As one example, an end effector is associated with one or more identifiers, such as a serial number, model identifier, etc. For example, the registration process involves the robotic system obtaining a hardware identifier of the end effector (e.g., by the end effector automatically pushing or providing the hardware information, or the robotic system pulling such hardware information by requesting it from the end effector) and recording such as information to identify or determine what end effector is attached to a given arm.

One example of hardware information includes a model number or an end effector version identifier. For example, suppose that there are multiple versions of end effectors that can be attached to the arm (e.g., different tools with different purposes). When a particular end effector is mounted, the version of the attached end effector is registered with the robotic massage system. This allows the robotic massage system to be aware of, or otherwise determine, the type of the end effector that is attached to a robotic arm. In some embodiments, the version information is used to determine what massage content is to be performed. For example, different massage content may involve the use of different corresponding types of end effectors. As one example, registering and determining of what type or version of end effector is attached is used by the robotic massage system to prevent the performing of a massage using an inappropriate type of end effector.

In some embodiments, when switching out different end effectors, when the electrical connection is formed (e.g., after the end effector has been slid into place, and the electrical connector 832 is coupled to the corresponding receptor in the receiving portion 826 of the arm), the registration process is performed in response so that the robotic massage system is able to determine what end effector is connected to the robotic arm.

### Minimizing Strain on the Robotic Arm

As described above, in various embodiments, a robotic arm of the robotic massage system is composed of a series of links that are interconnected at joints. The joints act as pivot points for the robotic arm. The joints may be powered with motors or actuators that allow various portions of the arm to rotate about various axes. For example, the motors at the various joints allow the arm various degrees of freedom. An end effector is attached to an end of the robotic arm (e.g., via an attachment). In some embodiments, the end effector is coupled to a joint. In other embodiments, the end effector is coupled to an end of a link (e.g., via an attachment). The combination of the joints, links, and motors allows the arm to be manipulated into various positions that allow the end effector to make contact with various portions of the subject's body, as well as perform various types of massage work.

The amount of force applied by the end effector to the subject is a function of the configuration of the arms and the various actuators that are operating. For example, the motors of the arm are sent torque control commands, where the forces imparted by the motors are transmitted in part along the arm to the end effector. The forces provided by the motors cause, for example, the end effector to be pushed or pulled along the user's body (depending on the stroke being applied). Due to the forces being applied, various portions (e.g., joints and/or links) of the arm may experience varying amounts of forces and strain (as force is transmitted from the actuators, through the links and joints, etc.). For example, various levers may result based on how the various segments of the arms are oriented relative to each other when the arm is in a certain configuration (e.g., to implement a massage stroke). That is, the various torque applied by the motors of the arm may result in forces that can put strain on various portions of the arm (e.g., due to the creation of levers based on how the various links and joints of the arm are positioned).

For different strokes, the linkages are arranged in various configurations, and varying amounts of force are applied by the motors in order to implement stroke trajectories (e.g., to be able to move the end effector along a path on the user's body). The amount or portion of force that is translated or transferred or delivered from a motor (compared to what is being applied by the motor) to the end effector will depend on the configuration of the linkages and angles between the linkages (e.g., joint configuration). That is, based on the configuration of the linkages, varying amounts of force will be applied on joints as torque (versus being linear) if, for example, two linkages are at angles to each other. The amount of strain on a joint depends on the linkages around the joint, where the motor(s) are, and how forces applied by the motors are being transmitted along the arm.

That is, using a tool of the end effector involves placing or positioning the tool at a location on the user's body, and providing a force at that location. Implementing a stroke involves using the motors to change the position of the end effector (to follow a stroke trajectory) and applying force (to provide a therapeutic effect). Positioning of the tool at a location on the user's body involves manipulating the robot arm into certain arm/joint configurations. The motors in the arm are used to apply forces that are transmitted through the tool (which is attached to the end of the arm) to the user to provide the desired therapeutic effect. As described above, when applying a force, there will be various amounts of torque on the various joints of the arm. Depending on the configuration of the arm, the relative torque on a joint will vary. High amounts of torque will strain the arm. If the relative torque on a joint is small, then a large amount of force can be applied at that point without straining the robot arm. From a joint configuration and motor sizing perspective, given the same motor size, more force could be applied on an area if the relative torque is small, as compared to if the arm is in a configuration in which the relative torque on the joint would be large. That is, the configuration of the joints of the arm will determine whether the joints are being strained or reaching a mechanical limit.

In some embodiments, where on the end effector a given tool or interaction region is located or oriented is determined based on the forces to be applied when using the given tool, as well as the joint configurations that the arm will go through to implement strokes utilizing that tool. For example, the “palm” tool is used to perform effleurage techniques, which require less force as compared to tools used for compression strokes or stripping, which need more force. In some embodiments, the location or placement of a tool for use in applying high force strokes is such that the corresponding joint configurations (in order to place the tool properly or cause it to move along the stroke trajectory) minimize strain on joints (as the forces involved and being applied are larger). For example, the “knuckle” region is an example of a high force interaction region that is oriented with respect to the mounting interface to transmit force from the robot arm in a mechanically advantaged direction, such as when performing stripping, as shown in the example of FIG. 11B. While the use of other surfaces (e.g., effleurage surface) may require the arm to be in less desirable joint configurations, the relatively less amount of force being applied reduces joint strain as an issue, as will be described in further detail in conjunction with the example of FIG. 11B.

In some embodiments, the shape of the end effector (e.g., placement of different tools) is designed to take into account the amount of strain on joints given the tool/surface of the end effector that is to be used. For example, with respect to a given tool or surface, the given tool is designed for certain types of strokes to provide desired effects in terms of strokes, as well as provide a certain amount of force performance. As one example, based on the placement of the various tools on the end effector, and the manner in which the end effector is mounted on the arm, the “knuckle” or “top” portion 814 of the end effector surface is the highest force area that can be used in some embodiments (up to 200+ Newtons of pressure directly under the arm, in some embodiments). The force performance of a tool (e.g., the amount of force that can be applied to the user via that surface) is also a function of the joint configurations that the arm would have when the given surface or tool of the end effector is being used. Other high force areas (given joint configurations) include the elbow or forearm regions.

As described above, the overall shape of the tool is made up of different tools or surfaces. The placement of location of a given tool on the end effector is determined based on a variety of factors. In some embodiments, the location of a given tool on the end effector is determined based on:
The amount of force to be applied by the end effector to the user. This may vary for different types of tools and the types of strokes to be performed using the tools. For example, for an effleurage, the amount of force applied by the robotic arm may be in the range of 60 to 80 Newtons of force, versus for compressions, where the amount of force applied by the robotic arm may be upwards of 200 Newtons of force.
The regions of the body that the given tool will contact. This is based on the types of trajectories that the given tool will traverse, which will in turn involve the arm being manipulated (by using its actuators/motors) into various configurations.

The use of a tool surface of the end effector involves being able to, throughout a stroke, have the given tool of the end effector be able to maintain contact with the user throughout a trajectory of the stroke, while at the same time providing a desired amount of force throughout the stroke (along its trajectory) to provide a therapeutic effect.

The location of a given tool on the end effector will impact how the linkages of the arm will need to be arranged in order for the given tool to reach all of the parts of the user's body along the stroke trajectory.

The amount of force that can be transmitted from the various arm motors to the end effector and applied to the user is a function of the amount of force provided by the motors, and the relative arrangement of the linkages through which the motor forces are transmitted. Over the course of the stroke, the configuration (relative arrangement of linkages) of the arm will change in order to move the end effector along the stroke trajectory. For example, the robotic massage system is configured such that the majority of the time the end effector is applying force, it is pushing, rather than pulling. For example, to “push” the end effector (e.g., down the back), force is applied from behind the touchpoint. In some embodiments, the force is applied depending on the direction that the end effector is moving in. For example, higher force is applied when the end effector is pushing (e.g., down the length of the back), and lighter when the end effector is being pulled (e.g., dragged pulled back up the length of the back). This similarly applies for other tools or strokes, such as stripping using the elbow portion of the end effector.

As described above, depending on the configuration of the arm, the amount of force being transmitted will cause varying amounts of strain on different portions of the arm. In some embodiments, tools which typically require large amounts of force are placed on the end effector such that, given the required range of motion of the arm for the stroke trajectories involving the tools, the relative arrangement of the links is such that the amount of strain is minimized, given the motor forces being applied.

Considering the location of tools on the end effector in conjunction with the types of strokes to be performed, the joint configurations of the arm when using that tool, as well as the forces that will be applied not only at the end effector tool, but also at various points along the arm has various benefits, such as being able to control motor sizes. For example, given the same motor size, more force can be applied without reaching joint strain limits.

As described above, based on the purpose of the tools, the amount of force being applied by the robotic arm will vary. For example, some tools, such as the palm, are typically used in situations that require less force than tools used for other purposes such as compression strokes or stripping, which need more force being applied. In some embodiments, the position of a certain tool on the end effector is determined based on the amount of force to be applied when using a tool, as well as the amount of strain that would be put on joints of the arm if that tool were being used, which is dependent on the joint configuration of the arm when the tool is used.

For example, the use of a certain tool will involve the last link of the arm being tilted in certain ways. The amount of strain on the joint connected to that link will vary depending on the amount of tilting. This is due to the direction of the force being applied to the last link. If the last link is in line with the direction of the force being applied, then there will be less strain on the joint (as the force being applied would be a direct force instead of a torque). However, if the joint is angled, then a portion of the force being applied is not in line with the last link, but will be a torque that places strain on the joint.

In some embodiments, when higher forces are to be applied, then the joint configurations are designed to be in a more favorable location in order to apply that higher force while minimizing the amount of strain on the joint.

FIG. 11A illustrates an embodiment of a robotic arm. In this example, a robotic arm with seven degrees of freedom is shown. In this example, the robotic arm has seven joints 1102, where there is a motor at each joint to allow rotation about an axis (resulting in seven degrees of freedom). In this example, the joints are interconnected by links, where there is also a link (link 7) between the last joint on the arm and the end effector 1104.

FIG. 11B illustrates an embodiment of implementing robotic strokes using an end effector. In this example, the robotic arm is controlled to “push” the end effector 1152 down the subject's back in order to perform stripping. In this example, subsequent to performing the stripping, the robotic arm is controlled in reverse to cause the end effector to be dragged or “pulled” back up the user's body to implement an effleurage stroke.

Different strokes require different amounts of force. For example, stripping and compression strokes typically require more force than strokes such as effleurage. The stripping stroke, which in some embodiments involves the use of the blade portion of the end effector is a stroke that requires relatively more force as compared to the effleurage stroke (which in some embodiments involves the use of the palm portion of the end effector). In some embodiments, to account for the higher amount of force needed by the stroke, and the use of the blade portion of the end effector, the stroke is implemented by configuring the arm to implement the stripping stroke by applying force and pushing, where the force exerted by the end effector comes from “behind,” by the arm pushing the end effector. By implementing such higher force strokes by controlling the arm to push the end effector along the subject, the strain on the arm is reduced.

Dragging of the end effector along the subject's body can cause strain on the last links of the arm (e.g., links 5, 6, and 7, as shown at 1154 in the example of FIG. 11B). In some embodiments, in order to reduce strain on the arm, dragging of the end effector is limited to those strokes such as effleurage that are lighter in force, while higher force strokes are implemented by controlling the arm to push the end effector.

As described above, in some embodiments, use of the end effectors is configured such that the end effector is typically being pushed by the arm, such that the end effector is applying force. Performing stripping is one example of a stroke in which pushing of the end effector down the user's body is performed. In some embodiments, a stroke also involves pulling the end effector up the person's body. An example of such a stroke is an effleurage stroke as described above, which may be performed by pulling an end effector back up a user's back, after having performed stripping by pushing the end effector down the person's back. In some embodiments, pushing of the end effector is performed with higher force, while motions up the body (or where the end effector is dragged by the arm), such as the effleurage are lighter in force. This also reduces the amount of strain on joints. That is, motions that would result in the arm being in joint configurations that would have higher torque and joint strain are limited to those that require less force to reduce the overall amount of strain.

### Collision Avoidance

As described above, in various embodiments, the end effector has multiple surfaces, which are also referred to herein as segments or tools. In some embodiments, the various faces and features of the end effector are angled in certain ways to avoid a number of types of collisions, such as:
Between two end effectors on the two arms when performing coordinated strokes involving multiple arms, such as those described above
Unintended contact between a tool of the end effector that is not in use, and a part of the user's body.
Between the end effector and a part of the robotic arm that the end effector is attached to.

Collisions relate in part to the variability between people. Such collisions are avoided based on the design of the end effector. For example, the various tools of the end effector have various curvatures, convexities, and concavities (where the curvatures are in three dimensions) so that end effectors avoid colliding with each other during certain strokes, or prevent a part of the end effector that should not be touching the user from making unintended contact with the subject.

In some embodiments, to avoid collisions, the touchpoint is designed or configured with steeper or smaller bend radii between segments (e.g., when transitioning from one segment/tool/face of the end point to an adjacent segment/tool/face).

The location of the segments or tools on the end effector are also structured to prevent the aforementioned collisions. Some of the segments on the touchpoint are locally concave surfaces. For example, the cupping segment is concave for support, such as for asymmetric massages.

In some embodiments, the angles of the individual tools are determined such that when tilted downwards, or on an edge, such as in the configuration of FIG. 11B (where there is a large mass to the side that the endpoint is directly mounted onto), links of the arm do not drag on the user's back. For example, the angle of the tool is limited to prevent a portion of the arm from causing drag. This is an example of another type of collision that is prevented, where the end effector is shaped such that use of any specific tool does not result in the arm coming in contact with the person's body (that is, only the desired tool of the end effector is what comes in contact with the person).

In some embodiments, the shape and size of the end effector and its tools take into account deformation of the body. For example, the end effector is designed so that there is a limited amount or no overhang of the robot arm beyond the boundaries of the touchpoint, even if the touchpoint has sunken into the user's body (due to their tissue being deformable).

For example, when the touchpoint is pushing on the subject's body, the body deforms, creating space. An adjacent part of the body (e.g., surrounding the main point of contact of the touchpoint with the body) may also “spring” back up, grabbing onto a part of the end effector and causing drag on the touchpoint.

In some embodiments, the touchpoint is designed in consideration of where the various linkages of the arm are so as to ensure that a linkage of the arm does not cause an unwanted collision with the user's body and, for example, cause drag. That is, in some embodiments, link limits are determined to prevent collision with the body.

For example, in order for a portion of the tool to be utilized across an entire stroke, the linkages of the arm will be adjusted in configurations that may vary over the course of the stroke, in order to maintain contact of a particular portion of the end effector with the user's body according to the stroke. The surface of the tool (e.g., angles and area) is determined also to prevent the arm linkages from having to be positioned in ways (e.g., bent at various angles) that would cause unintended collisions between some portion of the arm and the user.

In some embodiments, the tools are placed in positions that are optimal to avoid both collisions and hardware limitations, while still being able to have sufficient torque to provide the desired amount of force.

The following is an example of avoiding collisions between end effectors during coordinated strokes. As described above, in some embodiments, the robotic massage system includes multiple robotic arms, where performing a coordinated stroke involves the use of both robotic arms.

One example of a coordinated stroke involves performing a symmetric technique, further examples of which are described above. An example of such a symmetric technique is an effleurage stroke.

FIG. 12 illustrates an embodiment of performing a symmetric massage stroke. In this example of an effleurage stroke, the two end effectors have a mirrored trajectory, where the trajectory causes the end effectors to move inwards towards the center of the back, before flaring outwards. Care should be taken to avoid collisions, such as where the end effectors of the two robotic arms collide when they move towards each other.

As described above, in some embodiments, the tools or surfaces of the touchpoint are designed to avoid such collisions. As one example, the surfaces of the touchpoint are angled or curved in specific ways.

For example, as shown in FIG. 12, the front portions 1202 of the end effectors are not straight, but are bent back. In this way, when the end effectors come inward towards each other, they avoid crossing the center plane and colliding with each other. That is, based on the angles and curvatures of the surfaces of the end effector, crossing of the center plane and colliding of the two end effectors is avoided when using, for example, a palm region of the end effector for such symmetric work.

Further, as shown in this example, the blade segments 804 of the end effectors are angled back so that when the end effector is oriented such that the palm portion of the end effector (810, on the surface of the end effector touching the subject) is pushing down on the person, the blade segment lifts away, and also does not protrude as far forward.

This is beneficial in regions of the body with more significant curvatures, such as the glutes, so that the thumb portion of the touchpoint does not run into the person's body. Rather, the blade portion will rise up and twist away, gradually moving over rises in the body. For example, the curvatures will cause various segments of the touchpoint to turn away depending on how the end effector is oriented.

The curving away of the various segments of the end effector also prevents unintended use of tools (that should not be in contact with, or applying force to, the subject's body). For example, if the forearm tool is being utilized, then the palm portion is not unintentionally used, as, due to its curvature, it will not come in contact with the person's body. As another example, due to the curvature of the cupped hand area, when the palm segment is being utilized, the cupped hand area is not unintentionally used. Based on the shape and curvatures of the different segments, when the touchpoint is oriented for use of one of the segments, this will cause the other segments to be turned away from where contact is being made with the body. This prevents unintended collisions with the body. In some embodiments, the shape of the end effector, and the curvatures of the various segments of the touchpoint are determined based on stroke trajectories, determining where the end effector crosses the spine, the behavior of the end effector when in concave portions of the body, etc. Variations between people are also taken into consideration.

As described above, the end effector includes various shapes and tools that engage with the subject in various ways. As shown in the above examples, the shape of the end effectors is determined to minimize the likelihood of collisions. This is an example of mechanical or hardware collision prevention. In other embodiments, recorded stroke types are also used to minimize collisions. For example, strokes are designed to prevent collision between two end effectors. As another example, software is programmed to prevent collisions. For example, the system is configured to track or monitor the position of the end effectors, as well as the shape/configuration of the arms, and use such information to prevent the end effectors or arms from colliding.

As shown in the examples described herein, the endpoint is asymmetric in both its shape, as well as its mounting position. That is, there is not a singular axis that a plane could be drawn through that would result in symmetric portions of the touchpoint. In some embodiments, the end effector is designed with such asymmetry to avoid the collisions described above, such as when working close to the spine.

In various embodiments, an end effector includes various componentry for facilitating robotic massage. FIG. 13 illustrates an embodiment of a system architecture of an end effector. In this example, the end effector architecture 1302 includes a power supply 1304, communications 1306, microcontroller 1308, heating element(s) 1310, and sensor(s) 1312. Further details and embodiments of such components of the end effector are described below.

### Heating

In some embodiments, the touchpoint includes heating elements (e.g., heating elements 1310) within the end effector.

FIG. 14 illustrates an embodiment of heating elements of an end effector. One example of heating elements is heating strips, such as ceramic heating strips. In some embodiments, the heating elements include ohmic heating elements. In some embodiments, the heating elements include individual heaters that are attached to or adjacent to the interior skeleton, where the heat from the heating elements is distributed. Based on the material of the skeleton, the skeleton also helps to distribute the heat.

In some embodiments, the heating elements are on the exterior of the skeleton, where, for example, the heating elements are in or adjacent to the silicone surface. In the example of FIG. 14, a heating element strip 1402 on a plastic inner skeleton 1404 is shown. In other embodiments, the heating elements are in the interior of the skeleton.

With respect to placement of the heating elements, there may be various trade-offs. For example, placing the heating elements between the exterior material and the skeleton, rather than inside the skeleton, would prevent the heating elements from heating up components such as a microcontroller that is inside the skeleton. On the other hand, placing the heating elements between the exterior material and the skeleton may cause the heating elements to be more vulnerable to shear forces and wear.

In some embodiments, to promote more uniform or even spreading of heating of the end effector, the interior skeletal structure is made from a thermally conductive material such as aluminum. This is in contrast to using a less thermally conductive material such as plastic. For example, with a less thermally conductive material, hotspots will form where the surface of the end effector is warmed directly above the heating elements, and cool when moving away from the heating elements. In some embodiments, with a metallic skeleton for heat distribution, the heating elements are mounted next to the skeleton. Examples of materials that may be used for the skeleton include aluminum and Ultem.

In some embodiments, the internal structure includes passthrough holes or recesses for the placing of heating elements, temperature sensors, etc. In some embodiments, the exterior material is thermally conductive. For example, thermally conductive silicone is used for the exterior material to promote spreading of heat throughout surface of the end effector.

As described above, mounting of the end effector results in an electrical connection between the robotic massage system and the end effector (via a robotic arm). In some embodiments, the heating elements of the end effector are manually turned on/off (and are not, for example, automatically turned on when the end effector is mounted).

### Sensors

In some embodiments, the end effector includes sensors (e.g., sensors 1312) for collecting various measurements.

As one example, the end effector includes sensors for measuring force/pressure. One example of such a sensor is a force torque sensor. Another example sensor is a camera, where the images captured by the camera sensor are evaluated to detect contact. Other examples of sensors include capacitive sensors for contact areas, piezoelectric force sensors, etc. In some embodiments, a force-sensitive skin is applied around the skeleton, where the force-sensitive skin is used to measure pressure. The application of the end effector to the user may then be dynamically updated based on the measured pressure or force feedback. For example, if a certain amount of force were expected, the measured amount of force applied to a person may be used as feedback to determine an adjustment to the motors of the arm so that the applied force matches the expected force. The following is another example of determining pressure or force of the end effector. A set of cameras or other optical sensors is placed inside of the touchpoint. The cameras monitor the surface of the touchpoint. Through a specialized material or coating, models are built around deformation to determine an area that is in contact with the surface. The arms of the system provide the force that is being applied. The pressure being applied or engaged may then be determined from the force provided by the arms and the area in contact with the surface. For example, how the material is engaging, bunching, grabbing, gripping, etc. is determined. As another example, a pressure mat or capacitive sensing may be used.

By determining the area of the surface in contact with the user, the amount of pressure can be determined (not only force, where in some embodiments the force desired is assumed to be the force being applied). This allows for pressure-based control and engagement.

As another example, the interior of the touchpoint includes ultrasonic sensors for determining ultrasound measurements. This allows ultrasound for diagnostics, such as determining information about the person's muscles during the course of the massage.

In some embodiments, the end effector includes temperature sensors such as thermocouples to determine the temperature of the end effector. In some embodiments, such measurements are used to determine heating (or more generally, temperature control) of the end effector (e.g., using the heating elements described above).

In some embodiments, the end effector includes sensors to perform muscle sensing, including sensing muscle tension in order to quantify the impacts of a massage. Described herein are various embodiments of muscle sensing, including muscle sensing using ultrasound, pressure, bioimpedance, and electromyography.

### Ultrasound-Based Muscle Sensing

As one example, the end effector is configured to include ultrasound sensors. Measurements captured and provided by the ultrasound sensors are analyzed to evaluate tissue stiffness throughout the user's body. In some embodiments, the ultrasound sensors are combined with a load cell, allowing for force measurements to be taken with each ultrasound measurement (e.g., ultrasound video frame). Tissue features may then be measured and calculated from the analysis of the ultrasound measurements.

In some embodiments, the ultrasound sensors are used to perform ultrasound elastography to evaluate the stiffness of human tissue. In various embodiments, this includes performing strain elastography, supersonic shear wave elastography, etc. The use of ultrasound sensors in an end effector that is coupled to a robotic arm provides various benefits. For example, the repeatability offered by the use of robotic arms to control the position of the end effector (and the ultrasound sensors embedded within) allow for consistent probe angle, probe positioning, pressure, and patient posture.

### Pressure-Based Muscle Sensing

The following are embodiments of pressure sensing. In some embodiments, the end effector includes sensors configured to perform resistive sensing. As one example, forces applied to the silicone or exterior material of the end effector are detected by mounting force-sensitive resistors below the silicone. Multiple force-sensitive resistors may be utilized. For example, force sensitive resistors are embedded under the silicone material. Data collected from the resistive sensors is then used to perform pressure sensing.

The following is an example of evaluating pressure readings to determine pressure-based muscle sensing. Sensor output is averaged for unloaded muscles. Sensor output for loaded muscles is determined. Percentage change between those changes is plotted. The changes in observed loading patterns across sensors are used to determine when muscle stiffness changes.

One example implementation of a pressure sensor includes a piezoresistive strain gauge that includes an adjustable sensor tip. In some embodiments, the pressure sensor includes a geometry that pushes into the muscle, similarly to palpation. As another example implementation, pressure sensing includes a strain gauge, amplifier, and a rigid probe geometry.

As another example, pressure sensing is implemented using inductive sensing. For example, forces applied to the silicone of the end effector are detected by embedding a metal target within the end effector. The displacement of the metal target is measured with inductive sensors mounted below the silicone.

As another example implementation, pressure is sensed using a load cell. For example, reaction forces during massage are detected by mounting a load cell at the base of the end effector. With the use of a load cell, muscle stiffness is repeatably detectable.

### Bioimpedance Analysis

As another example, muscle sensing is performed using bioimpedance analysis (also referred to as electrical impedance myography). In some embodiments, electrodes are mounted on the end effector. Data gathered from the electrodes is used to identify frequencies of interest and perform bioimpedance analysis. As one example, strips of adhesive-backed copper taped are placed on the touchpoint as electrodes. In some embodiments, both outer electrodes and inner electrodes are included in the end effector. For example, a bioimpedance platform is used to drive the outer electrodes (e.g., for electrical stimulation) and gather data at the inner electrodes. In another embodiment, conductive silicone is used (to replace the metal electrodes). In some embodiments, a conductive lubricant is applied (to the end effector and/or the subject) to improve the efficacy and quality of the bioimpedance analysis.

Multi-frequency bioimpedance analysis may be used to indicate a variety of tissue states. For example, collected data is used to assist in controlling for spurious changes caused by massage. Contracted muscle density causes changes in center frequency (where, for example, center frequency is the frequency at which the reactance is highest). In some embodiments, changes in center frequency are used to create signals that are measurable at a single frequency. In some embodiments, if multiple frequencies are to be identified, parallel signal generation is performed.

### Electromyography

As another example, muscle sensing is performed using electromyography. For example, electromyography is used to detect contracted muscles by detecting the electrical impulses of nerves associated with muscle activity. The electrical impulses may be detected using metal electrodes included in/on the end effector. For example, adhesive-backed copper tape placed or mounted on the end effector may be used as electrodes. In some embodiments, a conductive silicone on the exterior of the end effector is used to detect the electrical impulses of nerves. As one example implementation, the end effector includes a differential amplifier with inputs directly connected to the skin. The end effector includes detection electrodes in contact with the muscle of interest. In some embodiments, the end effector includes a reference electrode in contact with electrically unrelated tissue. For example, a reference electrode is included that includes a stable connection to electrically neutral tissue (e.g., a bony location on the subject). This may include placement of a reference electrode separate from the end effector. In some embodiments, a conductive lubricant is also used to improve the quality of data collection.

### Microcontroller

In some embodiments, the end effector includes an (embedded) microcontroller (e.g., microcontroller 1308). In some embodiments, the microcontroller is configured to communicate with the rest of the robotic massage system.

As one example, the microcontroller facilitates communications with the robotic massage system so that the robotic massage system is able to confirm or verify that there is an end effector attached to the system. For example, the end effector is able to be identified (e.g., with a unique hardware identifier). The microcontroller is also used to identify whether the end effector is on the left arm or the right arm. The microcontroller is also configured to provide the system with other information about the end effector, such as its version number.

In some embodiments, encryption is also included in the microcontroller to ensure that a permitted end effector is attached. In some embodiments, encryption and verification are performed to ensure that a massage is not performed without the appropriate touchpoint.

In some embodiments, the microcontroller communicates with an odometer that keeps track of the number of hours that a given end effector has been in use. This allows for the system to be notified of when the end effector should be replaced (e.g., due to its lifetime approaching).

In some embodiments, the microcontroller is programmed with firmware to execute the various functions of the end effector. This includes facilitating communications with the robotic massage system, as well as controlling or taking inputs from various components such as the heating elements, sensors, etc. described above.

### Communications

In some embodiments, the end effector includes various electrical and mechanical interfaces (e.g., included in communications 1306) to connect the end effector to the rest of the robotic massage system. In some embodiments, the electrical interfaces are within the robotic flange (to which the end effector is mounted) so that any wiring is hidden internally of the arm. In other embodiments, wiring is run on the exterior of the end effector to the arm.

As described above, the microcontroller is configured to communicate with the rest of the robotic massage system. Communication is wired and/or wireless. Examples of communications interfaces include a CAN (Controller Area Network) interface, RS485, USB (Universal Serial Bus), etc. As another example, the communications interface is implemented using ethernet that is passed through an arm to the end effector. The use of an interface such as ethernet would allow a large amount of information to be transferred, as well as the connection of various sensors, such as ultrasound, etc.

In some embodiments, the various electrical components described above are included in a PCB (printed circuit board). In some embodiments, the PCB is located near the flange, with terminals as interfaces into/out of the end effector. FIG. 15A illustrates various perspective views of portions of an end effector. In some embodiments, the end effector further includes a power supply to power the various components of the end effector. Examples of a printed circuit board carrying such componentry are shown in this example at 1502.

In some embodiments, the end effector includes various electrical and mechanical interfaces to connect the end effector to the rest of the robotic massage system. FIG. 15B illustrates embodiments of end effector exits. For example, programming header and power exits are shown at 1522. An example of a central power exit for flex cable is shown at 1524. In various embodiments, the exits also include exits for ribbon cables, which in some embodiments connect to the PCB described above. An example of two mold halves of the end effector is shown at 1526. A side profile view of the end effector is shown at 1528.

FIG. 16 illustrates an exploded-view diagram of an embodiment of an end effector. In this example, components of an end effector are shown. In the example of FIG. 16, the end effector shown includes heater 1602, thermistor 1604, stand-off 1606 (two of which are shown in this example), skeleton 1608, silicone exterior material 1610, and skin 1612.

Examples of skin 1612 include various materials such as those described above, including LDPE, vinyl, etc. Other examples of skins applied to the end effector include wraps. One example technique for applying the skin or wrap includes heat shrinking or thermoforming the wrap material around the end effector. In other embodiments, the skin 1612 is a cover that is put over the end effector. For example, the cover is washable, disposable, etc.

End Effector with Embedded Contact Sensitivity

Force sensing is important in applications such as robotic massage, in which a robot interacts with a human body. Existing force-sensing solutions may have only a single vector of force that is able to be estimated, which is relatively low resolution, and does not provide the full ability to respond to or understand the state of the body.

The following are embodiments of force sensitive end effectors. In embodiments of the force sensitive end effector described herein, the end effector is embedded with tactile or contact sensors. In some embodiments, the contact sensors are arrayed across the end effector, which in some embodiments has a varying shape. In some embodiments, the contact sensors are force sensors, which measure and output values indicative of force that is exerted at various points or regions or locations on the end effector when the end effector is interacting with a deformable body.

In an interaction between the end effector and a deformable body, the end effector is controlled, via torque commands to the robot, to come in contact with (and apply a force to) the deformable body. As part of this interaction, the end effector exerts a force on the deformable body, and in response, the deformable body exerts an opposite reaction force on the end effector. In some embodiments, the force sensors embedded in the force sensitive end effector provide a direct measurement of the force exerted on the end effector due to the interaction, where the force exerted on the end effector is a lump sum of force due at least in part to the reaction force of the deformable body in the interaction (exerted by the deformable body on the end effector in reaction to the force exerted by the end effector on the deformable body), as well as other forces (e.g., friction forces, which may also be based on reaction force, effects of compliance, etc.). For purposes of simplicity, the forces exerted on the end effector that are directly measured by the embedded force sensors are referred to herein as reaction forces of the interaction between the end effector and the deformable body, where the robot is controlled to cause the end effector to apply or exert force on the deformable body.

In some embodiments, the direct measurement of force exerted on the end effector as a result of the interaction (which includes application of force to the deformable body by the end effector) is fed back to the robotic system, where the direct force feedback from the end effector is usable in a variety of applications.

As one example, as the force directly measured by the force sensitive end effector includes the reaction force that is a counterpart to the force applied by the end effector to the deformable body in the interaction between the two objects, the measured reaction force can be used by the robotic system to more accurately determine or estimate how much force is being applied by the robot to the deformable body, as well as in what direction (in addition to the reaction force from the deformable body, there may be other forces such as friction that are also exerted on the embedded force sensors and included in the forces measured by the embedded force sensors). More accurate determinations of actual applied force can then be used to close a feedback loop on the application of force, such that torque commands can be adjusted so that an intended amount of applied force is actually exerted on the deformable body. As another example, the reaction forces that are directly measured by the end effector can be used to determine a contact patch or area of the end effector, which can be used to make various other determinations, such as pressure. For example, the real-time embedded force sensing described herein is usable to determine real-time pressure mappings. Further examples of applications of utilizing direct force feedback provided by contact sensors embedded in the end effector are described below.

While examples in the context of robotic massage are described herein for illustrative purposes, embodiments of the force sensitive end effector and embodiments of the techniques for utilizing direct force feedback measurements from contact sensors embedded in the force sensitive end effector described herein may be variously adapted to accommodate other types of contexts as well, such as physical therapy, clinical applications, diagnostics, etc.

In embodiments of the force sensitive end effector described herein, tactile or contact sensors are integrated directly into the end effector, which is the component of the robotic system that directly comes in contact with the body of the subject. In some embodiments, a robotic system that interacts with a subject (e.g., the robotic massage system described above) includes multiple robotic arms. Each robotic arm may include a corresponding end effector. Each end effector can include integrated force/touch sensitivity. In embodiments of the force-sensitive end effector described herein, the tactile or contact sensors that are embedded in the end effector are force sensors that detect and output measured values of force. The techniques described herein may be variously adapted to accommodate other types of sensors as well. Embodiments of integrating two types of force sensors, force sensing resistors (FSR), and optical force sensors, are described in further detail below for illustrative purposes. Other types of force sensors may be utilized as well.

In various embodiments, touch or force sensing includes real-time measuring or sensing mappings of force (e.g., spatial distribution or profile of observed force) across various portions of the end effector as the end effector comes in contact with the subject's body. By integrating touch sensing directly into the end effector, the end effector can directly “feel” the part of the subject that the end effector is interacting with. As will be described in further detail below, in various embodiments, the force mappings (and pressure mappings derived from the force mappings, described in further detail below) that are collected or otherwise derived can be used to determine characteristics of the subject's body, including recording density and deformability of what is being interacted with, etc. In some embodiments, the integrated touch sensing facilitates internal sensing within a subject's body.

Embodiments of hardware integration of tactile or contact sensors into an end effector are described herein. Embodiments of software integration and utilization of direct force feedback output at the end effector, or information derived from output of the touch/contact sensors (e.g., force and/or pressure mappings) into robotic systems, such as control loops, as well as long term planning, are also facilitated and described in further detail below.

As will be described in further detail below, embodiments of the end effector-integrated force sensing described herein provide a full, force-sensitive understanding of the subject, such as with respect to understanding of the surface of muscle tissue, facilitating such analysis including estimating of deformation of tissue that is underneath, as well as estimating actual contact areas and control relative to an actual point of contact. This is in contrast to existing systems in which a point of contact between the robot and subject is estimated or projected in advance. In such existing systems, it is challenging to fully close the loop on the point of contact itself, as it is difficult to measure the point of contact and obtain a contact patch. This further places limits on the control that can be provided.

Integrating Contact Sensing into an End Effector

The following are embodiments regarding embedding of contact sensors in an end effector, resulting in a force sensitive end effector that can provide direct force feedback from the end effector pertaining to interaction between the end effector and a deformable body.

FIG. 17 is a block diagram illustrating an embodiment of an end effector with integrated contact sensing. In some embodiments, end effector system 1702 is an alternative view of end effector architecture 1302 of FIG. 13. In this example, end effector system architecture 1702 includes a power supply 1304 and microcontroller 1308, embodiments of which are described in further detail above.

In the example of FIG. 17, end effector system architecture 1702 further includes contact sensor array 1712 and communications 1706. In some embodiments, contact sensory array 1712 is an alternative view of sensor(s) 1312, which in various embodiments includes force sensors as well as other imaging and sensing or therapeutic emitters. In some embodiments, communications interface 1706 is an alternative view of communications 1306 that facilitates communication of contact sensor measurements from the contact sensor array (and to, for example, a robotic massage system that processes contact or interaction readings output by the contact sensor array).

In some embodiments, contact sensor array 1712 includes a grid, array, or matrix of individual, discrete contact sensor cells. In some embodiments, the contact sensors are arrayed across the end effector. For example, embedding contact sensors in the end effector includes embedding an array of individual, discrete force sensor cells across the end effector. In some embodiments, the discrete force sensor cells are located at or near the surface of the end effector to facilitate direct measurements of force or other contact exerted on the end effector during an interaction in which a robotic arm is controlled to engage a deformable body with the end effector.

Design Considerations for Integrating Contact Sensors into End Effectors

In some embodiments, embedding force sensitivity into the end effector includes covering the end effector with a grid or matrix or array of contact sensors. In various embodiments, contact sensors include force sensors, pressure sensors, etc. Embodiments of integrating force sensors are described herein.

In some embodiments, embedding contact, touch, or force sensitivity includes determining array sizing, packaging of multiple force sensors, and coverage of the end effector (e.g., amount of area or space occupied by force sensors) given the characteristics of the end effector, such as its shape and material properties. For example, embedding force sensing includes taking into account material properties such as thicknesses and temperatures.

In some embodiments, how contact sensors are embedded or arranged in the end effector is also based on the characteristics or hardware properties of the discrete sensor cells that are used. For example, there may be a desired spatial resolution (e.g., density of discrete sensors cells per unit area). The spatial resolution is dependent on the size of the discrete sensor cells, where one factor taken into consideration in integrating sensors includes how many sensors can be packaged within a certain area.

In some embodiments, contact sensors are provided in the form of modules, which are in turn used to create clusters. The shape of the cluster can be defined. For example, the shape of the cluster can be defined based on a desired spatial grid resolution. A grid pattern can then be determined based on the desired shape (and its regularity).

Another property of sensor cells that is taken into consideration is dynamic range. In some embodiments, the tactile sensors have a dynamic range specifying a minimum and maximum force that can be detected. For example, there is a minimum detectable force (e.g., non-zero amount of force, below which a force reading is not registered). There is also a maximum detectable force, beyond which the sensor becomes saturated. Tactile sensors may also have different resolutions or granularities of force or load sensing, such as in terms of the levels of force that they are able to measure and output.

In some embodiments, the hardware properties of the tactile sensors (e.g., cell size and dynamic range) are selected to facilitate grid/spatial resolution and dynamic range that is sufficiently general purpose for the various applications and use cases for which force feedback data from the end effector will be used. The aforementioned spatial resolution and dynamic range may be independent of, or dependent on, each other.

In some embodiments, multiple types of tactile sensors with different hardware specifications or hardware properties, such as cell/module size, dynamic range, force resolution, etc. are utilized across different portions of the end effector. For example, as described above, in some embodiments, different portions of the end effector are shaped to facilitate different types of contact. In some embodiments, different tools of the end effector are embedded with different specifications of tactile sensors based on the characteristics of the contact that will be implemented using a given tool.

In some embodiments, contact sensor array 1712 of the end effector includes multiple sub-arrays of contact sensors, with each sub-array covering different portions of the end effector. For example, in some embodiments, force sensing is embedded in an end effector such that there are different-sized arrays of force sensors (with different densities and spatial resolutions of force sensors) depending on location on the end effector, where the force sensors may also be associated with different dynamic ranges of force sensing based on where they are located on the end effector.

For example, a tool with a small surface area may be embedded with force sensor cells that are physically smaller. As another example, a tool via which high forces are applied can be embedded with tactile sensors with higher dynamic range (to avoid saturation). On the other hand, a tool of the end effector that is broad in its contact area and relatively low force can have embedded force sensor cells that are relatively larger and that do not have a high dynamic range. In some embodiments, different tools or parts of the end effector can have different densities of cells (different spatial resolution), as well as tactile sensors of different dynamic range.

As described above, different portions of the end effector may be used to provide different types of contact to the massage recipient. For example, some tools/surfaces may be pressed down harder than other tools/surfaces of the end effector. The differences in pressure that are experienced when using different surfaces of the end effector can result in potential issues with thresholds, as well as saturation of sensors themselves. As described above, in some embodiments, depending on where they are located on the end effector, force sensors with different properties may be utilized (e.g., based on range of force to be measured in a region of the end effector, where the range of force may be different for other regions of the end effector). In some embodiments, configuration of contact sensor arrays in the end effector may also take into consideration other tradeoffs, such as robustness, as higher-pressure areas such as the thumb region may result in more wear on the contact sensors.

As shown in the above examples, configuration of contact/force sensing on surfaces of the end effector includes configuring spatial resolution (e.g., density of discrete force sensors), as well as taking into account force resolution and dynamic range of detectable force. In some embodiments, the configuration of the spatial resolution and/or detectable force measurement range for a given tool of the end effector is dependent on the size/area of expected contact, as well as the range of forces/pressures that will be experienced, when utilizing that tool.

The following are further embodiments regarding configuration of contact sensor arrays embedded in an end effector. In some embodiments, optimization of spatial resolution and force sensing range is further based on the size of individual or discrete sensors. For example, optimization is performed to determine the maximum number of sensors that can fit into an area of the end effector given a corresponding contact patch area (with more sensors providing more precision). The size of the sensor can also affect how well the sensor detects or senses force.

Another example consideration for spatial resolution is packaging constraints. In some embodiments, electrodes are connected to the grid of contact sensors in order to obtain data from the discrete force sensors (that is communicated to the robotic system via communications interface 1706). There may be space constraints based on the number, placement, and arrangement of electrodes. In some embodiments, increasing contact sensing (spatial) resolution involves including more contact sensors. However, there may be tradeoffs, as increasing spatial resolution further increases complexity, such as with respect to cable management. Further, more noise may be introduced, limiting the amount of improvement in signal performance that can be achieved with more force sensors.

As another example, as the integration of more sensors may involve more electrodes, there may also be more querying performed as well. There may also be packaging constraints to the number of contact sensors that can be packaged on an end effector. The smaller the contact sensors, the more of an irregular shape (e.g., of the end effector) that can be covered. However, the more contact sensors there are, and thus an increasing number of electrodes, the longer it will take to query the contact sensors. Also, the more electrodes there are, the more computational power is needed to collect the data. Further, there will be more connections, more noise, etc.

### Embodiments of Contact Sensor Types

The following are embodiments of embedding of two types of force sensing technology in an end effector. The techniques described herein may be variously adapted to accommodate other types of force sensing modalities, as appropriate. What modality of contact sensing to embed in an end effector can be based on various factors or tradeoffs. As one example, due to the end effector being in contact with a deformable body and subject to wear, what force sensing modality to utilize can be based on that modality's robustness to wear on deformable bodies.

### Force-Sensing Resistors

One example type of contact sensor that is embedded in the end effector is force-sensing resistors (FSRs). In some embodiments, the force sensitive resistors are implemented using sensing pads that are located around the end effector. In some embodiments, each sensing pad includes a grid or array of individual force-sensing resistor cells.

In some embodiments, the force sensitive resistors are implemented as a film. In some embodiments, the end effector includes multiple layers, one of which is a layer of force-sensitive resistors. For example, the end effector includes a hard shell (e.g., inner skeleton described above). In some embodiments, the flexible film of contact sensors is embedded as a layer over the hard shell. In some embodiments, a layer of silicone is placed over the flexible, force-sensitive resistive film. In some embodiments, a layer or wrap (e.g., LDPE) is placed over the silicone.

FIG. 18 illustrates an embodiment of integration of force-sensitive resistor materials in an end effector. Shown in the example of FIG. 18 is an embodiment of integrating force sensors into an end effector or touchpoint. As one example, a flexible film of force sensing resistors is integrated into the touchpoint surface, such as shown at 1802.

In some embodiments, the force sensitive film that is used is a two-dimensional (2D) flexible film that includes a matrix of force sensitive resistor cells that can be applied to non-flat surfaces such as the surface of the end effector, which has various shapes and curvatures. In some embodiments, the flexible force sensor sheet/film is integrated into the touchpoint by placing it under the surface of the touch point. In some embodiments, the flexible force sensitive film is placed between an inner skeleton of the end effector and an outer silicone layer of the end effector. The flexibility of the force sensing film allows the force sensor to conform to the shape of the end effector's surface. Further, by being flexible, the force sensor is not a rigid component that could affect the feel of the end effector on a subject's body.

As one example, the force sensitive film includes two layers or sheets of separated material. As the two layers are pushed together through being deformed (caused by the interaction between the end effector and the deformable body), the position of where the pressing occurs is detected based on changes in resistance, where the measured resistance is dependent on the amount of force that was applied. In some embodiments, the deformation results in a change in resistance that in turn results in an electrical signal that can be read and translated into force. In some embodiments, the force measurements take into account the layers that are over the force sensitive film, such as the silicone outer layer of the end effector (which can affect the resolution of the sensed forces).

As will be described in further detail below, the detected forces and their positions/locations in the film can be used to generate a force map that indicates the spatial distribution of force experienced across the end effector. For example, the force sensing is a form of tactile sensing based on interaction of the end effector with the subject. For example, a robotic arm is controlled to apply a certain amount of force via the end effector. The end effector interacts with the subject. The subject's body reacts to the end effector, such as deforming. The deforming of the body given the applied force of the robotic arm is translated into a distribution or pattern or changes in force across portions of the end effector that is detected by the flexible force sensing film embedded in the end effector.

### Optical Contact Sensing

Another example type of contact sensor that can be embedded in the end effector is optical contact sensors. For example, in optical force sensing for robotics, force sensing and pressure detection are performed by utilizing optics to observe the deformation of a material (and in some embodiments, the silicone layer of the end effector as well).

In some embodiments, optical contact sensing includes a form of touch sensing that is a fiber optics-based tactile sensing of a deformable material. For example, optical sensors are used to observe how that material deforms, given emitted light. The observed deformation of the material is used as a signal to indicate an amount of sensed force. For example, each fiber optic sensor acts as a pixel. The fiber optics track deformation across a deformable material, providing a fine grid of deformation. The amount of deformation is dependent on the amount of force that was applied, and thus force values can be extrapolated or determined from the deformation information.

In some embodiments, an array (or arrays) of such fiber optic sensors are placed across the end-effector. A similar mapping as described above with respect to the resistive-based contact sensing can be performed to determine the location of detected or measured force values.

Utilizing Contact Sensing Data obtained from Contact Sensors Embedded in an End Effector

The following are embodiments of utilizing contact sensing data obtained from contact sensors embedded in an end effector. Embodiments of utilizing force measurements collected from an array of force sensors embedded in an end effector that is in contact or interacting with a deformable body are described below. As will be described in further detail below, using the interaction forces directly measured at the embedded contact sensors, various processing may be performed, such as contact patch determination, pressure mapping determination, feature identification, closing of control loops, etc. The touch/force sensors described herein can be used to facilitate various other types of determinations, as well, such as measuring elasticity, tissue stiffness, etc.

FIG. 19 Here is a block diagram illustrating an embodiment of a system for utilizing force feedback provided by contact sensors embedded in an end effector. In some embodiments, system 1902 is a robotic massage system that controls the operation of the robotic arms/manipulators to perform a robotic massage on a subject.

In this example, robotic massage system 1902 includes contact sensor feedback data collection interface 1904, force mapping engine 1906, contact patch determination engine 1908, and pressure mapping engine 1910. Robotic massage system 1902 further includes stiffness measurement engine 1912, feature identification engine 1914, and massage planner 1916. Robotic massage system 1902 further includes control loop engine 1918 and torque controller 1924. Control loop engine 1918 further includes position control engine 1920 and force application control engine 1922.

### Collecting Contact Measurement Data

The following are embodiments of collecting and utilizing contact sensor measurements from an end effector with integrated tactile sensing (e.g., utilizing the contact sensing modalities described above, such as FSR and optical sensing). In some embodiments, contact measurement data generated by the contact sensors is collected via contact sensor feedback data collection interface 1904.

As described above, in some embodiments, the embedded tactile or contact sensors are force sensors that measure force values. In some embodiments, the output of the force sensor(s) embedded in the end effector are read and communicated to a robotic system such as robotic massage system 1902.

For example, the force sensors output values or signals that are translated into, or otherwise indicative of force exerted on or experienced by the force sensors. For example, the contact sensors output electrical signals that map to force values. From the measured force output values, various other types of information are derived, such as contact patches/areas, pressure mappings, etc. Such derived information is then further utilized by embodiments of the robotic massage system described herein.

In some embodiments, measurements from the discrete pressure points are collected. For example, the individual contact sensors are arranged in an addressable grid. The contact sensors are queried (e.g., via electrodes). For example, the discrete or individual contact sensors are each queried. The order and sequencing and speed of querying/data collection may depend on a number of factors, such as the characteristics of the contact sensors, as well as the communications interface. For example, the sensors may be able to provide sensor data faster than the communications interface can collect and provide such data. In some embodiments, frames of contact measurement data are received at a certain frequency. In some embodiments, the frames of captured contact measurement data are stored.

In some embodiments, the output of the force sensing (either via resistive contact sensing, optical contact sensing, or other force-sensing modalities) is a grid of electrical signals that are indicative of the force applied to the contact sensing cells. For example, the output of a contact sensing array is a grid of voltage or current measurements that are indicative of the force applied to, exerted on, or otherwise experienced by contact sensor cells. This grid is of a certain resolution, where contact sensor measurements are detected along the shape of the end effector.

For example, in FSR, resistance measured by a sensor is a function of the amount of force or pressure applied on the sensor. The change in resistance results in a change in the output electrical signal (e.g., voltage or current measurement). The output electrical signal is then converted to a force reading or measure. In some embodiments, such as in the optical sensing modality described above, the raw contact data is measured deformation (of materials of the end effector). Force measurement data is then estimated, as given known properties of the material, there is a relationship between force/pressure and deformation of the material. The force is then estimated from the amount of material deformation that is observed.

### Force Mapping and Interpolation

The following are embodiments of generating a real-time spatial map of force detected across the end effector. In some embodiments, force mappings are generated using force mapping engine 1906.

In some embodiments, from the collected discrete contact measurement points, the following are obtained: a distribution of cells (individual or discrete contact sensors) that are being activated; and the activation value of each cell. For example, the electrical signals received via the electrodes connected to the array(s) of discrete contact sensors are converted into force readings. In some embodiments, the contact measurement data from the queried contact sensors is used to build a force map (e.g., map of forces experienced by the individual discrete cells that are arrayed across the end effector). In some embodiments, the force map is a spatial distribution of forces across various locations on the end effector.

As described above, as one example, the force sensing is implemented using a two-dimensional, force sensitive resistive film. In some embodiments, the force sensitive film includes two sheets of separated material. When the film is pushed on at a location, this causes the two sheets to connect together at the location of the pressing. This results in a measured resistance at the location, which can be represented using an X-Y coordinate. In this way, force is measured at points on the 2D surface of the force sensing resistor film. The force applied at that location can then be extrapolated as a function of resistance. Capacitive force sensitive films may also be used in other embodiments.

In some embodiments, the flexible force sensitive film wraps around the end effector. In some embodiments, the 2D force map that is outputted indicates intensity of force along the 2D surface (e.g., akin to a heat map, where different intensities measured at different locations indicate different levels of force applied at different areas). As one example, suppose the force sensing is implemented as a two-dimensional (2D) array or matrix. In some embodiments, the rows and columns of the force sensors are used to determine the location and intensity of applied force along the 2D surface (e.g., to generate a force map from the real-time (or near real-time) force measurements measurements). In some embodiments, interpolation and filtering are also performed.

With respect to force sensing using FSR film, in some embodiments, a single continuous sheet of flexible force sensitive film is wrapped around the end effector. In other embodiments, multiple sections of flexible force sensitive film are utilized to cover the end effector. In some embodiments, when multiple sections are utilized, addressing is used to determine what force is being measured where on the end effector. In some embodiments, whether one or multiple force sensitive films are used to cover the end effector, the output is a 2D force map.

As described above, in some embodiments, a force map is determined from the collected grid of contact (e.g., force) data. In some embodiments, a contact or force map is a map of points where contact is detected on the surface of the end effector versus how much force is estimated at that point. In general, the point will not lie on a cell, but will instead lie between cells or on a group of cells—in some embodiments, from such discrete contact sensor cell data, force at points on the surface of the end effector (that are between cells) is inferred and included in the map.

For example, discrete force readings are received from the contact sensor cells. In some embodiments, interpolation of forces in spatial areas between those force readings is performed to determine or estimate force values for areas between locations of discrete sensor cells. In various embodiments, spatial interpolation of force is performed using surface interpolation, scattered data interpolation, etc.

In some embodiments, surface or curve fitting is performed on the pressure data. For example, splines are utilized with respect to the discrete representation of forces. In some embodiments, to support or facilitate applications such as those that will be described in further detail below, derivatives (e.g., first or second derivatives of the force data) are determined (e.g., based on sampling of force data over time). In some embodiments, continuous approximations of the discrete force data are determined that are at least once (and sometimes twice or more) differentiable. In some embodiments, the continuous approximations of the discrete force data are determined using techniques involving splines (e.g., B-splines, polyharmonic splines, etc.). Other interpolation techniques may be utilized, as appropriate.

In some embodiments, in addition to the spatial map of force measurements (including interpolated force measurement values), characteristics of the force measurements are determined. For example, the localization of force readings and how they are spread out or distributed across the contact sensor cells (where a cell refers to a discrete physical sensor) is determined. In some embodiments, the size of the contact is also determined. In some embodiments, the rate of change of such information is also determined. In some embodiments, force gradients are determined.

The following are further embodiments of determining a spatial map of force detected across the end effector. In some embodiments, each individual tactile sensor cell is associated with a corresponding coordinate identifying its location on the end effector. For example, each individual contact sensor cell is associated with a 3D coordinate (e.g., X, Y, and Z coordinates) indicating its location on the end effector. When a force value is measured and outputted by a contact sensor, the force value is associated with the contact sensor's coordinate on the end effector. In some embodiments, interpolation, such as that described above, includes interpolating forces for coordinates between the coordinates of force sensors.

In embodiments of the end effector described above, different surfaces or tools of the end effector are utilized to facilitate different types of contact. In some embodiments, it is beneficial to determine which particular tool a force reading belongs to. In some embodiments, the robotic system maintains a table that maps coordinates (e.g., X, Y, Z positions or coordinates) to certain tools. For example, a given tool is associated with an area or portion of the end effector that is defined by, and encompasses, a certain set of coordinates. By using such a mapping of coordinates to tool surfaces, where force has been applied by the end effector can be determined.

In some embodiments, a model of the end effector is maintained, such as a mesh surface model. Such a mesh model can be flattened into a 2D plane via projection.

FIG. 20 illustrates an embodiment of a force map. Shown in the example of FIG. 20 is an example of a heat map view of the force sensor readings from an array of force sensors integrated into an end effector. In this example, a heat map is shown of the end effector (with embedded force sensing) being pushed against a subject's back. In this example, the heat map provides an interpolated view of the force measured by the embedded force sensors. In some embodiments, different intensities (e.g., as shown at 2002) indicate different amounts of measured force. The force map is a map of force that indicates the distribution of what force has been detected, and where, by particular sensors in the array of force sensors located across the end effector.

The map of force measurements across the end effector determined from the contact sensors is then used as a basis for supporting or facilitating various types of applications, further embodiments of which are described below.

### Contact Patch Determination

Using embodiments of the integrated contact sensing described herein, force sensing across the surface of a varying shape such as the end effector described herein is facilitated. Using the force sensing described herein, the location and amount of force applied on the end effector, when it is interacting with or otherwise in contact with a deformable body, is determined.

In some embodiments, the real-time force maps are used to determine a contact patch, where the contact patch is the patch or portion or area of the end effector that is actually in contact with the deformable body (where the end effector may be oriented such that a particular tool or portion of the end effector is caused to come into contact with a deformable body). Further the contact area is determined for an end effector such as that described above, which has a smoothly varying shape with multiple different regions or tools that are used for facilitating different types of contact. In some embodiments, end effector contact patch determination is performed using contact patch determination engine 1908.

As one example of performing contact patch determination, an estimation or determination is made of all the places or locations on the end effector where measured force is above a threshold or certain value. This mapping of where on the end effector force has been detected to be above a certain threshold is used to generate an area estimation for use as a contact patch. The identified contact patch can then be used for further downstream processing.

The following are further embodiments of determining the area (e.g., size) of the contact patch. As shown above, the end effector is of a three-dimensional, smoothly varying shape. In some embodiments, each individual tactile sensor cell is at a location on the end effector. In some embodiments, as described above, each individual tactile sensor cell is associated with a corresponding coordinate identifying its location on the end effector. For example, each individual contact sensor cell is associated with a 3D coordinate (e.g., X, Y, and Z coordinates) indicating its location on the end effector. In some embodiments, the area of the contact patch is determined by utilizing the coordinates of the subset of contact sensors whose measured force values exceed a threshold force.

In some embodiments, an origin of the contact patch is determined. In some embodiments, the origin of the contact patch is determined as the coordinates of the tactile sensor that had the largest magnitude force value reading. As will be described in further detail below, the origin of the contact patch can be used to facilitate positioning control loops.

FIG. 21 illustrates an embodiment of force readings output from embedded contact sensors in response to interaction between an end effector and a deformable body. In the example of FIG. 21, force values measured at various locations across the shape of the end effector are shown.

As shown in the above examples, the shape of the end effector is non-convex and varying, and thus, depending on how the end effector is applied to the subject, multiple parts of the end-effector can be in contact with the body (and thus corresponding force may be detected). As described above, in some embodiments, the force map determined from the direct force feedback measured at the end effector, using the integrated array of force sensors, is used to determine what specific parts of the end effector are in contact with the body, and to what degree. The contact patch is then determined as the subset of force readings whose values are above a threshold. In the example of FIG. 21, the contact patch is determined as the cluster 2102 of contact sensor cells whose measured force values are above a threshold.

The following are further embodiments of contact sensing and contact patch determination. As described above, using the integrated contact sensors described herein, the size and shape of the contact area of the end effector (when interacting with a deformable body), as well as where on the end effector contact is occurring, is determined. Further, continuous force readings across the contact area are collected and used to perform further deductions and calculations. In some embodiments, samples of contact are obtained periodically. For example, frames of contact are received at time intervals.

In some embodiments, an instance shape or area of the contact patch is determined from the frames or instances of force maps (e.g., the instant shape of the contact patch for the frame of force measures is the subset of readings that are above a threshold force value). In some embodiments, the rate of change of the contact patch is determined. For example, spatial rate of change is determined. In some embodiments, the instant shapes of contact patches collected at various points in time are used to detect changes in the contact patch, such as changes in size or area of the contact patch. The change in size of the contact patch over time can be used to facilitate various other processing. For example, growth of the contact patch in terms of area is indicative of applying of more force or pressure. The change in contact patch can also be used to facilitate minimization and maximization when solving various functions, such as when determining whether to stay away from delicate or sensitive areas of the body. As another example, when the end effector is pushing into tissue, the rate of change of the robotic arm and the rate of change of the contact (interaction of the end effector and the body) can be indicative of whether the end effector is sliding, is digging in, or if muscle or tissue is being moved.

Embodiments of the techniques described herein facilitate improved determination of contact patches, including by providing a full grid of sensing, which facilitates force sensing on a surface of the skin, beyond a single force value that is created. For example, as described above, an array of individual force or contact sensors is used to provide a map of forces experienced during interaction between an end effector and a subject.

The use of an embedded array of individual contact sensors as described herein provides higher resolution force sensing. For example, the end effector does not contact a body at only a single point. Rather contact occurs over an area or patch. Using the techniques described herein, the manner in which the end effector interacts with the deformable body is more accurately sensed with higher resolution, facilitating improvements to the robotic massage experience for the subject.

As described above, using embodiments of the end effector described herein, which is integrated with embedded force or touch or contact sensitivity, what patch or portion of the end effector is contacting what part of the body can be determined. Such contact patch determination further facilitates improved accuracy in estimating various properties of the massage recipient, such as estimating tissue stiffness, estimating structures beneath skin, etc. Such improved estimation of massage recipient properties using embodiments of the embedded force sensing described herein further enhances other massage-related processing, such as providing increased accuracy in robotic control (further details of which will be described below), further improving the experience for the massage recipient.

### Pressure Mappings

As described above, with a grid of integrated contact sensors across the surface of the end effector, which has a varying shape, a contact patch or area of the end effector that is in contact with a deformable body can be determined. In some embodiments, the force readings and the contact patch (whose size or area can be determined) are combined to facilitate accurate measurement of pressure. In some embodiments, pressure maps are generated by pressure mapping engine 1910 using force maps and contact patches determined as described above.

As described above, the integrated contact force sensors provide measurements of force. Because the grid of force measurements is from an array of sensors that is across the shape of the end effector, the contact sensor array measurements can also be used to determine the contact area (area of the end effector that is contact with the deformable body), as described above.

In some embodiments, the measured force map and the contact area are then used to provide a measurement of pressure (which is force per unit area). For example, the size and shape of the contact patch, along with the forces measured for the contact patch are used to determine what pressure is being applied.

Even with accurate force estimation, without the size and shape of the contact patch, it can be challenging to accurately determine or approximate the pressure that is being applied. Using the embedded contact sensing described herein integrated into an end effector, accurate contact patch determination can be performed, facilitating accurate pressure determination.

Various processing can then be supported based on the pressure mapping. As one example, peak detection is performed on the determined pressure map. For example, peak detection includes detecting if there is a peak amount of pressure that is detected that is over a certain pressure threshold. If a peak in pressure is detected, various actions can be taken in response.

### Feature Identification

In some embodiments, the direct force feedback provided by contact sensors embedded in the end effector facilitates identification of features or elements of the deformable body that the end effector is interacting with. In some embodiments, feature identification is performed using feature identification engine 1914. Examples of features that can be identified using the end effector-embedded contact sensing techniques described herein include, without limitation: bone cartilage, ligaments, large muscle structures, skeletal structures, etc.

In some embodiments, with the high-fidelity force/pressure mapping determined from the direct force feedback provided via the end effector-embedded force sensors described herein, accurate feature identification is performed. For example, the shape of features embedded underneath the skin can be identified.

As one example, a force or pressure map that appears as a rectangle can be identified as a bone. For example, features such as bones can be identified for certain strokes based on analyzing the variation (and change in, rate of change in, etc.) in recorded force/pressure readings. For example, as the end effector moves over a boundary, there may be a corresponding sharp increase in pressure. Such changes in pressure are usable as information to indicate characteristics of the features, as well as the location of skeletal features, knots, various adhesions, etc.

In some embodiments, feature detection includes recognizing landmarks that the end effector has encountered. In some embodiments, feature detection includes combining the contact data with knowledge of where the end effector is on the body (e.g., as determined using a body model, camera/perception systems, etc.). Knowledge of detected features can then be utilized for further downstream processing.

For example, such force-based feature identification information is usable to change planning and robotic arm control, such as adjusting force when moving over a certain feature, such as lowering the applied force when it is determined that the end effector is moving over a bone boundary.

As another example, features can be identified as ones that are more sensitive, and for which less force or pressure should be placed. For example, if a higher spike in pressure is detected, then this is indicative of the end effector moving over a more sensitive area, or an area with a lower amount of depth of tissue to bone or an adhesion. In that situation, the control of the robot can be changed or modified as well. In this way, the loop on interaction dynamics between the end effector and the body can be closed via the embedded force sensing described herein.

The following are further embodiments regarding feature identification. In some embodiments, feature detection is performed by generating a stiffness map. For example, a stiffness map is generated from the relative force measured between electrodes or contact sensor cells. In some embodiments, stiffness maps are generated using stiffness measurement engine 1912.

The following are embodiments of generating a stiffness map, which can in turn be used to facilitate landmark detection. Stiffness refers to an object's resistance to deformation, responsive to force that is applied. For example, for different materials with different stiffness, different amounts of force would need to be applied to produce the same amount of deformation. In some embodiments, the embedded force sensors are used to sense the stiffness of encountered features in a deformable body. For example, different features under the surface of the skin, such as tissue, bone, etc., have different stiffness. As an end effector pushes deeper into a recipient's body, different tissue layers or skeletal structures will be encountered. Detected changes in stiffness can be used to infer or otherwise identify what features are being encountered by the end effector.

In some embodiments, as force is applied by the robotic arm at a location, the displacement that results is also monitored and tracked (e.g., using position encoders of the robot). Changes in force measured over time over a location, as well as determined changes in depth can be used to determine a stiffness map. For example, stiffness (e.g., of musculoskeletal layers or structures that are being pushed on) is a function of the difference in force over the same location, as it is tied to displacement.

In some embodiments, stiffness is determined by moving the robotic arm and modulating pressure and relating it to movement in or out. In some embodiments, relative stiffness within a small area is determined.

For example, the end effector is used to probe or hone in on a feature by pressing repeatedly in the same place. Displacement and force are usable to determine stiffness. If such exploration or examination is done over a certain area, a stiffness map can be constructed. For example, modulation of the end effector in place is used to determine a relationship between displacement and force, which in turn are used to determine stiffness. Such modulation is performed over an area, generating a stiffness map of the examined area. For example, the map will represent a structure such as a bone (e.g., a 2D section of a bone). In some embodiments, structure recognition is performed using the stiffness map or transformation.

As one example, the surface of the skin is determined from the contact sensing readings. The end effector is moved in a certain distance (e.g., the robot is controlled to move the end effector into the body by a certain distance). Suppose that the end effector is moved into the body by 5 millimeters in this example. The stiffness map will then look different. The robot indicates the distance it has moved relative to the surface (5 millimeters deeper in this example). In this example, the force measured when the end effector is on the surface, and the force measured when the end effector is 5 millimeters deep are known from the contact sensor measurements. The amount of displacement is known. The differences in force over the distance (deformation) is used to determine stiffness. For example, the force needed to produce a certain amount of deformation is determined, which is used to determine the stiffness of the feature that the end effector is interacting with.

Such testing or probing is repeated, where high and low forces/pressures are observed, and the difference in between small areas that are next to each other will indicate stiffness. The collected stiffness measurements obtained via modulation (with corresponding pressure measurements and displacement) are used to construct a stiffness map.

As described above, once features have been identified, various responsive actions can be taken. For example, massage planning can be adapted. For example, massage planner 1916 is configured to take as input identified features, and determine whether to make adjustments to a massage plan. For example, as described above, the contact sensing can be used to determine sensitive areas of the deformable body to stay away from or avoid or to apply less force/pressure to. For example, if the end effector is approaching a neck of the massage recipient, and it is desired to stay away from certain sensitive parts, the integrated contact sensing can be used to detect certain shapes that would indicate that a delicate area is being approached that the robot should stay away from.

As another example, a nodule can be detected via the contact sensing, where in response to the detection of the nodule, changes to a massage plan or stroke are implemented. For example, the type of stroke being performed can be changed (e.g., to work the nodule out).

The following are further embodiments of feature identification using a force-sensitive end effector. As one example of feature identification, a spike in pressure would indicate that something hard underneath the surface of the skin, such as bone (or some other structure which should not be pushed on further), has been encountered. With this contact data and an understanding of how the end effector is actually contacting the body, the robotic system described herein can determine one or more actions with respect to the detected structure, such as whether to stay away from the sensed structure, to skip the sensed structure, push on the sensed structure (e.g., if the sensed structure is a nodule), etc.

As described above, in some embodiments, feature detection includes distinguishing between features (or identifying/classifying what type of feature has been encountered) based on the observed profile of contact sensor readings (e.g., observed profile or distribution of pressure, force, or stiffness readings). The following are further embodiments of classifying features from direct force feedback at the end effector.

As one example, a heuristic is utilized to map pressure or force or stiffness profiles/maps to features. As another example, feature identification is learned via an artificial intelligence (AI) and/or machine learning (ML) model that is trained through labeling. For example, motions can be performed over areas of the body. Labeling is performed as features are encountered, providing an understanding of what those features are. A model is then trained to identify or classify features.

As one example, in a manner analogous to image classification, the contact sensing data is used to determine a grid or frame of pixels of pressure/force values. This grid or frame of force or pressure pixels is provided as input to the feature classification model. Further data can also be provided as input, such as information about where the end effector is on the body (e.g., according to a body model, perception systems, etc.). The feature identification model then provides an output classification of the feature that the end effector is in contact with, along with a confidence measure.

The following are examples of further processing that is performed based on feature identification and classification using contact sensor data. As described above, in some embodiments, an identified feature is provided as input to a massage planner (e.g., massage planner 1916). The massage planner can then take action to adjust a massage plan to adapt to the encountered and identified feature at a certain location of the deformable body.

The use of feedback from contact sensors embedded in the end effector in planning actions and/or robotic control is adaptable for various approaches, such as VLA approaches (e.g., vision, language, action end-to-end approaches that remove barriers between perception and action and instruction), or lower-level control.

In various embodiments, there are different levels for massage plan adaptation to identified features. For example, at a lower level, there is control and motion planning and adapting stroke trajectories themselves. At a higher level of planning, the adapting may include changing out strokes or pieces of content because of what has been detected.

For example, as described above, a feature identification model is trained to take as input contact sensor readings, such as force or pressure readings. The model then determines, based on an observed type of pattern or anomaly or abnormality in force or pressure (e.g., unevenness in the distribution of the profile of force or pressure that is being unobserved, which is indicative of an unevenness in the feature(s) that the end effector is encountering or moving over), a predicted classification of what the encountered feature is.

Various different actions can then be taken based on the identified features that are detected based on the integrated contact sensor readings. For example, if the planner receives as input from the feature identification model that a knot located in a certain region has been identified with a fairly high confidence, then more time can be spent working on that area. Or, as another example, a prompt can be generated (e.g., to the massage recipient), indicating that, for example, extra tension has been identified at a location (that the end effector is currently on). The prompt can also include options for actions to take.

As shown in this example, the massage planner, in response to detection of a feature, can autonomously perform an action, or raise an alert or notification to the member, allowing them to manually determine whether they would like to perform a certain action (e.g., that is selectable from a list of options provided to the member by the massage system).

The following are further embodiments regarding feature identification.

In some embodiments, pressure maps generated using the integrated touch sensing capabilities described herein facilitate identification and classification of body elements that are interacted with by the end effector. In some embodiments, the end effector is controlled or manipulated to push down on a region of a subject, compressing a portion of the subject. In some embodiments, resulting pressure maps can also be used to identify when various layers of muscle tissue are encountered as the end effector is pushed down into a subject. In some embodiments, the force is adjusted as the pressure maps change. For example, suppose that massage work on the rhomboids on the back is to be performed. In order to reach the rhomboids, the end effector must push down through the lats to reach the rhomboids. In some embodiments, the profiles of the observed pressure mappings are used to determine when the end effector is encountering the lats, where a difference or change in the distribution or profile of pressure mappings can then be used to determine that the edges of the muscle fibers of the rhomboids are being encountered as the end effector pushes down further. In this way, specificity of interaction with particular muscles is facilitated.

As described above, the touch sensing integrated into the end effector facilitates the determination of the location and bounds of specific elements of a subject's body. This can be used to update the body model of the subject. In some embodiments, elements of interest can be tracked over time, as the state or condition or properties of a tracked body element can evolve, (e.g., as a function of treatment). For example, the touch sensing can be used to detect a knot (where a profile of distribution of pressure is mapped to, or otherwise indicative of, the knot). The location of the knot can be determined, as the position of the end effector relative to the body is also tracked by the robotic system. The properties of the knot at the marked location can be tracked over time and correlated with different treatments to determine the impact of different treatments on the knot. Such treatment impact information, along with subjective feedback, can be used to learn more about the subject, and provide more personalized care.

During interaction with the user (e.g., a massage being performed), the integrated touch sensing in the end effector can also be used to fine tune an understanding of the subject's position in three-dimensional (3D) space. For example, during a massage, the touch sensing data is used to fine tune or increase the precision of the determination of the exact location or position of the subject on the table that is being engaged with (which can change over the course of the massage, such as if the user reaches back to scratch).

In some embodiments, the integrated touchpoint tactile sensing described herein facilitates identifying of anomalies, as well as determining the location of such anomalies. For example, anomalies are detected and classified in part using the integrated touch sensing data (e.g., based on the pressure mapping readings that are collected). Such identified anomalies and their locations can be recorded and used as further output in various contexts.

### Interacting System Dynamics and Control Loops

In the robotic system described herein, there is a robot (e.g., robotic manipulator or arm), and that robot has an end effector. When that end effector is moving in free space, and not interacting with or coming into contact with another object, then the dynamics of the system are effectively the dynamics of the robot.

When performing a massage, the system that is being controlled is not only the robot (e.g., robotic arms). Rather, the system that is being controlled is what is referred to herein as the interacting system.

For example, when that robot is in contact with a deformable body or object, then the dynamics of the total system are the dynamics of the interaction between the robot (via end effector) and the deformable body.

In an interacting system, the robot is not in isolation. There is interaction between the robot and the deformable body. It would be challenging to calculate the dynamics of the robot without taking into account the dynamics of the forces that the deformable body is applying to the robot.

The integrated force sensing described herein facilitates closing of the loop on the entire interaction, which is applicable independently of the task or application being performed, whether positioning, tissue detection, etc. The high resolution, integrated force sensing described herein facilitates determination of the dynamics of the interacting system. By being able to determine the dynamics of the interacting system using embodiments of the integrated force sensing described herein, more effective control and planning with respect to such dynamics are achieved.

In free space (e.g., a non-interacting system, where the end effector is not in contact with an object), an accurate model can be determined (e.g., model of dynamics of robot, such as acceleration, velocity, position, etc., given input torque commands). However, if the same non-interacting model were applied to calculate the behavior of the dynamics of the robot, such as how the robot would accelerate or move to a certain position while in contact with the deformable body, the non-interacting model would be very inaccurate.

For example, when moving about in free space, the reaction force applied to the robot is zero (or close to zero). In the absence of reaction forces, the dynamics of the robot, such as its acceleration in free space from a position at one velocity to another position with another velocity can be accurately modeled. However, the dynamics of the robot and how it will behave given input torque commands can be difficult to predict when the robot is in contact with a deformable body. Bodies will have friction, and will deform. Due to this, there will be reaction forces that are also applied to the robot, where the end effector will not end up in an expected or modeled position, or move with the expected velocity, if a non-interacting dynamics model were utilized.

In some embodiments, the direct force feedback provided by the force sensitive end effector facilitates an accurate dynamics model of the robot when interacting with a deformable body. For example, by embedding contact sensors in the end effector, the reaction forces exerted by the deformable body on the end effector as a result of the interaction can be more accurately measured. With the direct force feedback provided by the contact sensors embedded within the end effector itself, a more accurate interacting model can be constructed that predicts, given input torque commands and taking into account that the end effector is in contact with a deformable body, expected dynamics of the robot, such as position, acceleration, and velocity. This provides improved control of the end effector to implement robotic massage or other types of robot-deformable object interaction.

The following are further embodiments of how direct force feedback from the force sensitive end effector facilitates improved control in an interacting system.

When the end effector is caused to be placed in contact with, or otherwise interact with a deformable body, there will be both friction and reaction forces experienced by the end effector. For example, there will be friction along the direction of motion, and a reaction force that is somewhat normal. If the end effector is pushing exactly normal to a surface on the deformable body, then the forces registered by the embedded force sensors in the end effector will primarily be due to the reaction force applied by the deformable body back to the end effector.

In some embodiments, the embedded force sensors, which provide a form of tactile sensing for the end effector, measure forces applied to the end effector, including such friction and reaction forces. That is, by embedding force sensors in the end effector, friction and reaction forces can be determined. In some embodiments, friction forces can be projected along a direction of motion.

The following are further embodiments of what information the embedded tactile sensors described herein provide. The interaction between the end effector and the deformable body will not be a single point on the end effector touching a single point on the body. Rather, there will be several points on the end effector contacting several points of the body. This contact will result in a force with a magnitude and direction that is applied to the end effector (in reaction to the force applied by the end effector to the deformable body). The magnitude of the resulting force applied to the end effector as part of the interaction can be determined from the force sensor cells. For example, a force sensor cell will indicate that a force with a certain magnitude is being applied.

In some embodiments, the direction of the force applied to the end effector is determined based on aggregation of the individual point forces measured by the group of sensor cells that come in contact with the deformable body, and determining a direction vector. For example, the direction along the end effector in which magnitude is decreasing across the contact sensor cells can be determined. In some embodiments an overall gradient of force magnitude measured along the surface can be calculated. A force vector can then be projected along the direction of motion.

The ability to directly determine, at the end effector, where reaction forces are being exerted on the end effector improves the ability to determine interaction forces, as compared to, for example, relying on inference from sensors of the robot (and that are away from where the contact is occurring). For example, robotic sensors (e.g., of the robotic manipulator), obtain the resulting force and moment. That is, forces or moments measured by intrinsic robotic arm sensors are resultants of various factors, and it is difficult to ascertain exact locations. By being able to ascertain the contact area of the end effector (where contact is not a single point contact), more information is obtained to determine more accurate interaction forces and moments. For example, detecting the shape and area of the contact, and where that contact is occurring on the end-effector provides information that is usable as constraints when utilizing various other data (e.g., robot forces and moments or other variables) in determining certain solutions.

In some embodiments, the embedded tactile sensors provide a direct measure of a composite of friction and reaction forces experienced at the end effector that are caused by the interaction between the end effector and the deformable body (where the friction is also due to the reaction forces, such as the reaction forces that result from applying a force normal to a surface). In some embodiments, having accurate force sensing at the end effector facilitates distinguishing of forces exerted on the end effector/robot.

Suppose that a certain amount of torque is applied in order to move the robotic arm so that the end effector engages in contact with the deformable body. The end effector is subject to a certain amount of force in reaction by the body. Suppose that the end effector is not moving at the rate expected (e.g., according to a model that models the dynamics of the end effector given input torque).

The tactile sensors embedded in the end effector measure interaction friction and reaction force exerted on the end effector (and thus the robot) by the deformable body. The robot is also subject to other types of friction. For example, even in free space, the joints and motors of the robot have friction. The tactile sensors embedded in the end effector measure how much friction/reaction force experienced by the robot (which affects its dynamics) is due to the interaction with the body. This facilitates distinguishing friction from the joints/motor of the robot (also referred to herein as robot friction), versus due to interaction with the body.

For example, the actual motion of the robot can be accurately measured using position encoders. The torque of the robot applied can be accurately measured using torque sensors. A model can be used to predict the motion or dynamics of the robot given input torque, such as if it were moving in free space, in a non-interacting system. However, if the actual motion (as measured using position encoder readings) is different from what was expected (e.g., more resistance than expected), then this difference can be attributed to the combination of interaction forces (e.g., interaction friction and reaction forces due to contact with the body), as well as friction forces in the robot itself. In existing lower resolution force readings, the reaction forces and robot friction forces are lumped together, and it can be difficult to distinguish how much of the robot's motion dynamics are affected by the reaction forces versus from robot joint and motor friction. The embedded force sensors can be used to directly measure and isolate the reaction forces from interaction with the deformable body, allowing more accurate separation between forces acting on the robot (e.g., by allowing distinguishing between reaction forces exerted by the deformable body, and robot joint/motor friction forces).

The following are further embodiments of how the end effector integrated force sensing described herein facilitates improved, and more accurate determination of interaction forces and other forces affecting the dynamics of the robot when interacting with a body.

For example, the net or resultant amount of force that is exerted or experienced by a contact sensor cell in the grid of contact sensors arrayed across the surface of the end effector is a function of multiple force components that are exerted on the end effector. For example, there is the reaction force exerted by the deformable body in response to the force being applied by the end effector. There are also friction forces that counter the movement of the end effector when it is moving against the surface of the deformable body as part of the interaction between the end effector and the body. Further, the deformable body is not rigid, and compliance is also a factor.

In existing systems, it is challenging to determine such reaction forces and interaction friction. For example, in existing systems, reaction force and friction are inferred from joint data of the robotic arm. However, achieving accurate reaction force and interaction friction from joint data can be challenging, as the reaction force and friction due to the interaction between the end effector and the body are mixed up or tangled or muddled up with other forces (e.g., from the robot joints/motor). For example, there is a total force that is affecting the behavior of the robot/end effector, a portion of which is from the motor, and a portion of which is from friction and reaction forces.

The following are embodiments of estimating interaction forces (e.g., interaction friction and reaction forces) using integrated contact sensors embedded in the end effector that comes in contact with the deformable body.

In some embodiments, the robotic system collects high-quality measurements of joint position and joint torque (of the robotic arm). An accurate dynamics model is maintained that models the behavior of the robotic arm when it is not interacting with a body (also referred to in this example as a non-interaction dynamics model).

When the robotic arm (via the end effector) does interact with the body, there is unmodeled friction and reaction forces resulting from the interaction. In existing solutions, friction and reaction forces are inferred by looking at the expected force value that is output from the non-interaction dynamics model, the actual force value (where applied force can be determined from the measured force exerted on the end effector), and determining a difference between the actual value and the model-outputted value. Within this lump sum difference, there is a friction force, a reaction force, effects of compliance, and model error.

Using the integrated contact sensors described herein, there is now direct information regarding the interaction force and/or about the time rate of change of the interaction force, which in some embodiments is evaluated with respect to the model output. In this way, the difference between the model output and the actual force can be closer to model error, where the interaction friction force and reaction force can be determined or isolated and removed from the external lump sum forces that were previously difficult to discern.

Using the integrated contact sensing described herein, improved measurement data is collected, which can be used to build improved and more accurate models. Further, models of the interacting system (versus non-interacting system models of the arm, in the absence of contact with an object) can be built, rather than relying on model error.

With the direct force measurements at the end effector being provided as feedback, reaction forces can be separated or distinguished or isolated from other sources or components of force that affect the dynamics of the end effector in an interacting system. By doing so, model error can be assigned to different sources. Model error can also be reduced by obtaining new measurements.

Integrated contact sensing can be used to improve state estimation. For example, state estimation is beneficial to close various types of loops. In some embodiments, the robotic massage system maintains a model for estimating state of the robotic system when it is not interacting with a body. It can be challenging with existing systems to estimate the state of the system when it is interacting with a body.

The integrated contact sensing described herein facilitates building or generation of various types of models, beyond movement models, dynamics models, or pressure models. For example, deformation models can be constructed, which can be used to understand or predict or estimate what parts of a contact patch will be more or less deformed. For example, given known properties or characteristics of the end effector, it is determined how the end effector would deform given a certain amount of pressure that is sensed. This provides further information on what is being contacted, as well as the environment that the end effector is interacting with. Such end effector deformation modeling can be determined over time and space (as the robotic system is a spatial system). Models of force and torque dynamics can also be constructed. The integrated contact sensing techniques described herein improve the ability to measure the state of the interacting system by facilitating collection of actual measurement data from the interacting system (versus having to infer such interaction forces).

### End Effector Force Feedback for Closed Loop Control

As described above, having force sensing embedded in the end effector itself facilitates providing of force feedback directly from the end effector, where the forces that are fed back are interaction forces experienced by the end effector when in contact with the body. As will be described in further detail below, such feedback of force that is directly measured at the end effector is usable to close various control loops (for controlling the robot and its dynamics). In some embodiments, control loop engine 1918 is configured to manage control loops using force feedback provided by the contact sensors embedded in the force sensitive end effector.

When performing a massage, the robot is given torque commands to control the robot to cause the end effector to engage with or otherwise make contact with the deformable body in an intended manner. For example, torque controller 1924 is configured to provide torque commands to control the robotic arm(s). The force feedback provided by the embedded force sensors in the end effector facilitates closed loop control, by making measurements of actual behavior that can be compared with target or intended behavior, where the results of the comparison can be used to guide control of the robot so that intended behavior is achieved.

In some embodiments, the robotic arm has accurate position encoders, as well as accurate torque sensors. In the context of robotic massage, two types of tasks are performed in some embodiments. One task is a positioning task, and the other task is a force application task. In some embodiments, to implement a massage stroke, both tasks are performed. In some embodiments, position control engine 1920 is configured to perform the positioning task, and force application control engine 1922 is configured to perform the force application task. With accurate position encoders, a torque can be applied, and whether an intended position of the end effector was achieved or reached can be determined via the position encoder by measuring the joint angle space (from which the cartesian space position can be determined). However, the torque sensors in the arm are not able to directly determine whether the intended amount of force was actually applied. In existing systems, the actual amount of applied force is inferred by evaluating the measured joint torque, evaluating a model, determining a difference between the two, and inferring that a certain amount of force was applied. Force could also be inferred in other ways, such as determining whether motion has stopped in the Z-direction. However, existing systems are unable to directly measure that the force actually being applied was the intended force to be applied at any given time. That is, existing systems are unable to close a feedback loop on the application of force.

Embodiments of the force sensitive end effector described herein can be used to more accurately determine that, given an intended amount of force to be applied, if there is a difference between the intended amount of applied force and the actual applied force (determined from the measured reaction force detected at the force sensitive end effector, where ideally the force applied is exactly the amount of reaction force that is measured by the embedded tactile sensors), the determined difference can be used by the system to adjust (e.g., increase or decrease) the joint torque that is being applied so that feedback control is facilitated on the force application. In this way, the loop on interaction dynamics is closed. Other information based on the different can be determined, such as stiffness or compliance information, which can also be compensated for via torque command adjustment and adaptation.

Existing control systems are model free, in that they do not leverage sophisticated models of the body due to missing actual applied force information. Improved model-based control is facilitated by being able to more accurately determine how much reaction force is being applied using the force sensitive end effector described herein (where force applied by the end effector to the deformable body is determined from the reaction force measured at the end effector and provided as force feedback).

The following are embodiments regarding closing a control loop on the positioning task. In some embodiments, the positioning task includes controlling the robot such that an intended part of the end effector comes in contact with an intended part of the deformable body. The force sensing described herein further facilitates localization in the interacting system of what part of the end effector came in contact with what part of the body. For example, force feedback about where forces are experienced on the end effector is indicative of the actual part of the end effector that came in contact with a deformable body.

For example, as described above, the contact patch is determined based on the force feedback, which can be mapped to a part of the end effector (e.g., using the force sensor cell coordinates, as described above). The point on the end effector with the maximum or largest force reading can be used as the origin of the contact patch, as described above. Where on the body surface the origin of the contact patch is placed is determined. Adjustment can then be performed if there is a delta or difference between intended (target) and actual positions. The direct force feedback provided by the contact sensors embedded in the end effector provides an accurate measurement of how much force is being exerted on the end effector, which can in turn be used to determine the force is being applied by the robot to the deformable body, and in what direction. Such information can be used to more accurately place or position the end effector on a massage recipient.

As the end effector makes contact with the body, a particular portion (or portions in some cases) of the end effector will come in contact with the recipient. For example, there may be an intended portion of the end effector (e.g., particular surface of the end effector) that is to come in contact with an intended portion of the recipient. As described above, the techniques described herein include localization of the contact patch to the massage recipient's body (identifying where on the body the end effector is making contact).

The following are further embodiments of using force feedback provided by the end effector to facilitate the aforementioned positioning task, including localization of the end effector relative to the deformable body.

By being usable to generate a force map, the array of embedded force sensors provides a form of force feedback that is usable to perform three-dimensional (3D) localization of where the end effector is positionally relative to the deformable body.

For example, when a body surface (e.g., as modeled using a body model) is considered as a two-dimensional (2D) plane, the position of the end effector on the body surface can be reasonably accurately determined on that 2D plane via projection. However, in reality, the body is not a 2D plane, but is a soft, deformable surface, and thus there is also penetration depth (due to the end effector pushing into the body)—that is, there is not only X-Y coordinates of where the end effector is on the body, but also a Z-depth component in the position of the end effector relative to the body.

Determination of penetration depth (e.g., how far into the body the end effector has penetrated) is difficult or challenging to accomplish by perception alone (e.g., via cameras). Embodiments of the embedded force sensing described herein are usable to determine Z-axis penetration depth of the end effector, relative to a deformable body that the end effector is contacting, thereby providing 3D localization of the end effector.

In some embodiments, how far into the body the end effector has penetrated is determined based on determining a stopping point of the end effector in interacting with the body. In some embodiments, the stopping point is associated with the point when the reaction force of the body is equal to the force being applied.

In some embodiments, using the embedded force sensing described herein, the amount of force being applied at the contact point is determined from the measured force on the end effector, which includes reaction force exerted on the end effector by the deformable body in response to the applied force. When it is determined how much force is being applied at the contact point, and the end effector has stopped sinking into the body, the penetration depth can be determined, and localization in 3D space can then be performed.

As shown in the above examples, the direct force feedback embedded in the end effector, as described herein, facilitates closing of at least two control loops, including closing a control loop on applying an intended amount of force by the robot, and also closing a control loop on positioning of the robot such that an intended part of the end effector comes into contact with an intended part of the deformable body. Using the direct force feedback embedded in embodiments of the force sensitive end effector described herein, an intended portion of the end effector can be accurately placed at an intended part of the deformable body to accurately apply an intended amount of force to facilitate a robotic massage.

The following are further embodiments of using forces measured at the end effector as feedback to robotic control.

In some embodiments, the characteristics of the forces that are being measured are used to infer whether the end effector is slipping, or whether the body is being contacted in the desired manner. In some embodiments, the feedback from the contact sensors is correlated with the motion of the robot itself. For example, the robotic arm (with end effector) can be controlled to move in a particular manner. The feedback from the contact sensors can be used to determine whether the robotic arm moved in an expected manner. Adjustments to the control of the robot can then be made such that actual motion of the robot aligns with intended motion.

In some embodiments, a pressure map is integrated into the control loop for controlling the robotic arm, where robotic arm force/torque is dynamically adjusted on the fly, depending on what pressure map is sensed or observed in a particular region.

As one example command or feedback, force applied by the robotic arm is controlled such that the measured pressure at any point across the end effector does not exceed a threshold (e.g., 20 Newtons per square centimeter). In this way, if a harder or less deformable portion of the subject is encountered (e.g., due to bone or harder muscle being encountered), the robotic arm is controlled to push down with or apply less force. In this example, the profile of the pressure map that is sensed is used as feedback to adjust the amount of force that is applied through the robotic arm.

As another example, the integrated force/pressure sensing described herein can be used to determine the location of the boundary of elements of the body (e.g., using the feature identification described above), and control movement of the robotic arm accordingly. For example, suppose that a robotic end effector is moving along a subject's body as part of a massage that is being performed by the robotic massage system. Suppose that a particularly tense set of muscle fibers is encountered, and that an objective of the robotic massage system is to target interaction with those muscle fibers. Such interaction of the end effector with a targeted body element involves various dynamics that are occurring simultaneously, such as slippage, deformation, etc. that is specific or localized to the targeted muscles (where the robotic massage system would be controlled differently if a different part of the subject's body were being interacted with). The pressure mappings collected using the techniques described herein can be used to facilitate determining the edges of the muscles of body element of interest. With the edges or bounds of the muscles identified, the robotic massage system can also be controlled to determine by “feel” (e.g., at least in part by the force, pressure, or tactile sensor readings) to determine when the end effector is on the edge of those muscles, and prevent the end effector from going over. The internal representation of the body model can also be updated with the detected bounds of the body element.

Different massage recipients also have different body types. In some embodiments, depending on body type, mapping is performed to correlate with body models. Such mapping further provides improved application of force (e.g., whether to control the robotic arm to have more or less force applied to a location on the subject's body). The use of integrated force sensors embedded in an end effector facilitates determination of where on the body the end effector is contacting, as well as the orientation of the end effector when it is making contact with the deformable body. Adjustments for offsets with respect to different body types and divergence with maintained body models can then be made.

### Refined Body Model

In some embodiments, end effector force feedback is used to update knowledge of a subject's body. This can include combining end effector force/pressure mappings with other sensor readings to update a body model. Aggregating various sensors measurements facilitates the robotic massage system in constructing a collection of properties of different bodies and patterns and segments. This allows, for example, for an improved understanding of anatomy.

FIG. 22 illustrates an embodiment of sensor fusion with contact mapping information from force/touch sensitive end effectors. The integrated touch sensing described herein can be used to update a body model of a body of a subject. As one example, a body model of a subject can be generated based on performing a scan of the subject's body using optical sensors (e.g., cameras). The body model can be further updated and refined based on the integrated touch sensing described herein. In some embodiments, sensor fusion includes incorporating communications and feedback received from users'/subjects' subjective measures in sensor fusion, where interaction between a robotic system and a subject is facilitated via user interfaces such as screens (e.g., to indicate user preferences or disinclinations).

In the example of FIG. 22, measurements collected by robot force/position sensors 2202 and touchpoint pressure mapping sensors 2204 (e.g., contact sensors described above from whose measurements can be used to determine force and/or pressure mappings) are combined with a vision system/body model 2206 (e.g., based on scanning of a subject's body using a vision system including optical cameras, depth sensors, Lidar (Light Detection and Ranging), etc.) to generate a refined body model.

As described above, in some embodiments, surface pressure sensor maps are used to update body models. For example, the pressure sensor maps provide further data for the robotic massage system to understand the subject. For example, the profile or distribution of detected pressures in a region of a subject's body can provide higher fidelity and resolution in indicating the location of certain body elements, such as the location of the end of the ribcage, the location of the shoulder blade, etc. The robotic massage system can then perform adaptations to determine an appropriate or more personalized massage for the particular subject.

For example, the body model can include a shape of the body. The internal structure of the body can be difficult to ascertain from a body model surface scan from external sensors (e.g., external cameras). Different people can have different structural configurations internally. For example, different people can have different varying skeletal structures, with pelvises and ribs in different locations. The integrated touch sensing in the end effector allows the robotic system to refine the knowledge of the internal structure of the body.

For example, output of the touch sensing can be used to update the body model and the understanding of where the bones are in a particular person. The understanding of the bone or skeletal structure of a specific person can be used to identify certain conditions. For example, conditions such as kyphosis, lordosis, or scoliosis can be identified based on the touch sensing capabilities described herein. Re-planning of treatment around such areas can then be performed.

As another example, the integrated touch sensing capabilities described herein are used to characterize a subject's body element, such as tissue. For example, the pattern of pressures in the observed pressure mapping can be used to determine the deformability of tissue in a part of the body. The pressure mapping (indicative of deformability) may then be used to classify or determine a level of adiposity or level of musculature of tissue, where adipose tissue is more deformable than muscle. For example, it can be difficult with external sensors (e.g., cameras that are not in contact with a subject's body) to determine, for a certain body shape, whether some part of the subject's body is dense from musculature, or light on musculature and heavy on adipose tissue. The assessment of what the end effector is in contact with, using the integrated touch sensor, can be used to re-characterize how force is to be applied to what body element is being interacted or engaged with. For example, the amount of force that is applied is a function of the density of the tissue or part of the body that is being interacted with, which is detected in part by the touch sensing integrated into the end effector that is in contact with the subject's body. For example, the pressure mappings determined from the outputs of the touch sensing can be used to determine, in the robotic arm control loop, how hard to push to reach muscles.

Such touch sensing information can be used to further update the map of the body, which can also include musculoskeletal information beneath the surface of the body. For example, a body model may include a UV or barycentric representation that includes a mesh with various triangles. As one example, the body model may be used to provide an a priori alignment of the right latissimus dorsi to a certain set of triangles. However, during physical interaction with the subject's body with the end effector, pressure measurements from the integrated touch sensing indicate that the area is relatively highly deformable, with some number of Newton's worth of deformation before muscle is reached. Such touch sensing integrated into the end effector that comes in contact with the subject is used to update the internal understanding of the body (e.g., that that portion of the body in the body model is not the latissimus dorsi, where the body model's indication of what is in the region is updated accordingly). Thus, the touch sensing integrated into the end effector provides improved internal sensing capabilities.

As another example, suppose the glutes. Across different subjects, the deformability of the glutes region or area can vary significantly. For example, the glutes on people can vary between more/less deformable, more/less solid, etc. As one example, suppose that the robotic arm is controlled to press down the end effector into the glutes region or a particular body area with a certain amount of force, suppose 100 Newtons of force. The profile or distribution of pressure on the 2D pressure map across the surface of the end effector will vary depending on the solidity or deformability of the particular region. For example, if the region is a particularly solid muscle mass, then the profile of the pressure will be more concentrated and localized to a smaller portion of the end effector. On the other hand, if the region is highly deformable, then the profile of the pressure map will be broader and more diffuse/spread out across the end effector.

The following are further embodiments of utilizing force feedback provided by contact sensors embedded in a force sensitive end effector.

In some embodiments, the integrated force sensor readings facilitate personalized body interaction (e.g., massage). For example, via user interfaces provided by the robotic massage system, the user can provide indications of their preferences (as well as dislikes or disinclination) as to how a massage is being performed. For example, the individual user can indicate their preferences for force in different strokes. The user preferences, as well as the properties of the strokes being performed when the preferences were provided (e.g., force measurement, as well as pressure readings) can be used to update the robotic massage system as a personalized component in which certain elements of the user's body can be addressed in a personalized manner.

The force readings taken using the end effector-integrated force sensors described herein can be used to facilitate both short term and long-term massage management and planning. For example, within a massage being performed, the real-time force/pressure mapping information can be used to adjust the force or torque applied to the robotic massage arm when executing a massage stroke or movement. As one example, the force/pressure readings are used as a factor in the robot arm control loop. On a longer-term scale, the force/pressure mapping data can be used to determine information that can influence longer term massage plans.

In some embodiments, the robot arm end effector incorporates a variety of sensing capabilities, such as the integrated pressure sensing described herein. As described above, in some embodiments, the output of the force sensing includes surface pressure maps. In some embodiments, such surface pressure maps are incorporated or fused with other sensor measurements, such as optical deformation measurements, as well as measurements for determining what is occurring beneath a subject's surface, such as with acoustic measurements (e.g., ultrasound), infrared spectroscopy (e.g., to determine tissue deformation, tissue characterization, blood flow monitoring, etc.), etc. Such integration of multiple sensor feeds allows, for example, the surface pressure measurements to be combined with under the skin (e.g., internal) measurements as well.

As described above, the touch sensing capabilities described herein can be used to provide advanced internal sensing capabilities to increase knowledge of a subject's internal structure and elements (e.g., musculoskeletal system below the skin). Such internal subject information, in combination with external shape data, provides an enhanced model of the body of the subject, both externally and internally that is complex, rich, and accurate. This enhanced model of a subject's body, including both internal and external information, can be used in various contexts, beyond massage. For example, the enhanced subject model can be used as diagnostic and therapeutic information in medical or clinical contexts. Further, the various sensor data, including the touch sensing data can be used to build or train learning models to provide analysis, understanding, as well as treatment.

In the above example, feedback or output (e.g., measured force values) from tactile sensors (e.g., force sensitive resistor sensors or optical force sensors) integrated in an end effector of a robotic arm is received. For example, the output from the contact sensors integrated in the end effector is received as the end effector is in contact with a subject (e.g., massage recipient). A control loop used to control the robotic arm (e.g., to control the positioning of and/or the force applied by the robotic arm) is updated based on the output from the tactile or contact sensors integrated in the end effector of the robotic arm.

FIG. 23 is a flow diagram illustrating an embodiment of a process for determining a contact patch using contact sensors embedded in an end effector coupled to a robotic manipulator. In some embodiments, process 2300 is executed by robotic system 1900 of FIG. 19.

At 2302, force feedback is received that is provided by contact sensors embedded in an end effector positioned at the end of a robotic arm, where the robotic arm is controlled to engage a deformable body with the end effector. At 2304, a contact patch where the end effector is contacting the deformable body is determined from the force feedback provided by the contact sensors embedded in the end effector.

In some embodiments, the end effector has a smoothly varying shape. In some embodiments, and as described above, different portions of the end effector are shaped differently in order to facilitate different types of contact between the end effector and the subject, such as to implement different types of massage content or techniques.

In some embodiments, different surfaces or tools of the end effector are associated with different configurations of touch/contact sensing. For example, different portions of the end effector may be configured with different spatial resolutions of force sensing (e.g., different physical densities of force sensor cells, such as the number of individual cells in a given area). Different portions of the end effector may also have sensor cells with different dynamic ranges of force detection (e.g., different ranges of minimum and maximum detectable force). For example, different portions of the end effector can have different spatial/force resolution/sensitivity based on the expected type of contact using the different portions of the end effector. In this way, force sensing for different regions or surfaces or tools of the end effector/touchpoint may be configured differently.

The embedding and packaging of sensor cells in various portions of the end effector can be dependent on properties of the sensing modality, such as the size and dynamic range of contact (e.g., force) sensors. Multiple types of force sensors with different properties (e.g., different sizes and/or dynamic ranges) can be utilized across the end effector.

As one example, the thumb surface or portion of the end effector has a finer point of contact and is used to press down hard on the user, and in some embodiments, the thumb surface is configured with a higher dynamic range for force sensing, as well as a higher density array of contact sensors (e.g., higher spatial resolution). That is, for a tool such as the thumb, which is an area that experiences a higher amount of force and also has a small contact patch (and thus experiences a higher pressure), force sensing can be configured such that there is a finer spatial resolution of sensing, as well as a wider (larger) range of pressure that can be sensed (e.g., to avoid saturating the force sensors in the thumb region).

Other surfaces, such as the knuckle and palm portions of the end effector have broader contact patches. In some embodiments, broader surfaces with larger contact patch areas that experience lower pressures are configured with lower spatial resolution and smaller ranges of force measurement, as compared with, for example, the thumb region. As one example, the palm-shaped surface may be associated with an assemblage of force sensors that is of lower spatial density, where the force sensors used in this region can be specified with a smaller dynamic range of force sensing.

In some embodiments, the embedded contact sensors of the force sensitive end effector are used to obtain mappings of force, which include the spatial distribution of forces exerted across the end effector caused by interaction between the end effector and the deformable body.

In some embodiments, force maps are used to determine contact patches. Using the force map determined from integrated force sensors that are arrayed across an end effector, what parts or subset of the end effector are actually in contact with the body, and to what degree, can be accurately measured by detecting which force sensors have detected non-zero amounts of force (and to what degree or intensity).

In some embodiments, a pressure map is generated based on the measured force and the determined contact area.

In some embodiments, the force/pressure maps are used to perform feature detection and identification, including determining or characterizing or identifying what element(s) or feature(s) of the subject are being encountered by the end effector. For example, the contact sensors provide measurements of force based on what the end effector is interfacing with. In some embodiments, the profile of the force/pressure map (or detected changes in the pressure/force profiles) is used to determine or classify or distinguish what of the subject's body the end effector is being interfaced/interacted with, such as a muscle, bone, a knot, etc.

In some embodiments, feature identification is based on determining stiffness. In some embodiments, stiffness of the part of the deformable body being interacted with by the end effector is determined based on: (1) the force being applied by the end effector to the part of the body (determined, for example, from reaction forces measured by the tactile/contact sensors embedded in the end effector); and (2) deformation of the part of the body due to the applied force (determined, for example, from position encoders of the robot arm to determine how far the end effector has sunk into the deformable body, where the position encoders may be used to determine joint position in joint angle space, and then converting to cartesian space). In some embodiments, stiffness is measured via probing of applied forces versus resulting deformation. As different body features may have different stiffness, detected stiffness can be used to identify what body feature the end effector is currently interacting with.

In some embodiments, the force that is directly measured at the end effector is provided as force feedback to close one or more control loops, such as a positioning control loop and/or a force application control loop.

For example, using the techniques described herein, there is direct force feedback from the end effector. With respect to the force application control loop, the reaction forces directly measured by the force sensitive end effector are indicative of how much force was applied. The amount of actual force applied can then be compared against an intended amount of force to be applied. Adjustments to torque applied to the joints can be made so that the actual force applied by the end effector is closer to the intended force to be applied. In some embodiments, the positioning task includes causing an intended portion of the end effector to come in contact with an intended portion of the deformable body. The direct force measurements from the force sensitive end effector can also be used as feedback in facilitating localization of where the end effector is relative to the subject, where torque adjustments to the robotic arm can be made in response to differences detected between actual and intended positions.

In some embodiments, based on the provided force feedback, massage planning is altered. For example, a massage plan is altered for maximum therapeutic effect. A massage plan can also be altered for safety purposes, such as to avoid contacting sensitive areas that have been identified based on the force feedback (e.g., using the feature identification described above).

Described herein are embodiments of a massage system including a robotic arm or manipulator. An end effector is positioned at the end of the robotic arm. The end effector includes multiple contact sensors that are embedded in the end effector. The robotic arm is controlled to engage or interact or otherwise make contact with a deformable body with the end effector. The contact sensors provide force feedback indicating a contact patch where the end effector is contacting the deformable body.

Described herein are embodiments of force sensitive robotic end effectors with integrated contact sensing. In some embodiments, contact sensing includes sensing, using tactile/contact sensors embedded in an end effector, measurements pertaining to the dynamics of contact or interaction between the end effector and a deformable body (e.g., a human recipient of a massage). In some embodiments, the measurements include measurements of force experienced by the contact sensors embedded in the end effector as the end effector is caused to interact with the deformable body (e.g., such as when the end effector is positioned or otherwise controlled by the robotic arm to apply force to a user to implement a massage technique).

Embodiments of integrating or embedding contact sensors into an end effector have been described above. In some embodiments, contact sensors are embedded into an end effector (also referred to herein as a touchpoint) that has a smoothly varying shape including multiple surfaces or tools. Different surfaces/tools of the end effector are usable to perform different types of massage techniques. In some embodiments, force sensors are placed throughout various portions of the end effector (e.g., to provide coverage across the surface of the end effector).

In some embodiments, the manner in which force sensing is implemented or configured for different tools is dependent on how a particular surface is utilized during interaction or contact with a subject. For example, the manner in which force sensing is integrated is different for different portions of the end effector. In some embodiments, force sensing is integrated into the end effector such that different portions of the end effector are configured with different spatial resolution and ranges of force sensing.

The use of tactile force sensors integrated directly into the end effector provides various benefits. For example, a six DOF (degree of freedom) force torque sensor at the end of the wrist of the robotic arm (e.g., link where the end effector attaches to the robotic arm) can be used to provide a higher level, overall force measurement of the touchpoint. The integrated pressure sensor described herein provides high resolution of how much pressure is across the surface of the end effector, which is a component that comes in contact with the subject.

For example, the 6-DOF force torque sensor provides a high-level vector of force. A force mapping sensor such as a force sensitive film provides further information, such as a picture or mapping of the force across the end effector based on direct contact of the end effector with the subject.

As described above, the force sensitive end effector and techniques for utilizing force feedback provided by the forces sensors embedded in the force sensitive end effector described herein also facilitate various types of localization. For example, localization of the end effector in 3D space relative to the body of the recipient can be determined.

As another example, localization of where contact is occurring on the end effector can be accurately determined. For example, the point of contact is not a single point, but a patch. The contact patch is also a function of not only where the end effector is on the body, and how the end effector is rotated, but also how deep the end effector has sunk into the body. In addition to localizing what part of the end effector is touching the body, the techniques described herein may also be used to localize where the end effector is relative to the body.

As described above, the integrated force sensing described herein also facilitates localization or identification of features that an end effector is interacting with. Further, using the embedded force sensing described herein, the robotic system can localize what part of the body the end effector is on, such as what landmark is being interacted with, such as whether it is bone, muscle, or some other landmark.

In some embodiments, the localizations described herein that are facilitated by the integrated force sensitivity described herein further facilitates the generation of improved of more personalized and accurate body models of recipients. For example, the same position and the same depth on different people will correspond to different tissue. Thus, it is beneficial to not only know positionally where the end effector is in 3D space, how far into the body the end effector is, and how much force that is being applied, but also what kind of tissue that is currently being interacted with.

As described above, in some embodiments, the integrated contact sensors are used to measure interaction forces. Embodiments of end effector-integrated force sensing, as described herein, facilitate higher degrees of resolution of direct sensing with respect to a massage recipient or subject. Having such a higher degree of direct sensing of the interaction that is occurring between the end effector and the deformable body provides various benefits and improvements over existing force sensing solutions, such as increasing the ability to react, understand, and deliver the highest quality treatment as a result.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic massage system, comprising:
a robotic arm;
an end effector positioned at an end of the robotic arm; and
a controller configured to control the robotic arm to engage a deformable body with the end effector;
wherein:
the end effector comprises a plurality of contact sensors embedded in the end effector; and
the plurality of contact sensors provide force feedback indicating a contact patch where the end effector is contacting the deformable body.

2. The robotic massage system of claim 1, wherein the force feedback is used to determine a spatial map of forces detected across the end effector as a result of engaging of the deformable body with the end effector.

3. The robotic massage system of claim 2, wherein the contact patch is determined using the spatial map of measured forces detected across the end effector.

4. The robotic massage system of claim 2, wherein the contact patch comprises locations on the end effector for which measured forces in the spatial map of measured forces exceed a threshold force value.

5. The robotic massage system of claim 1, wherein the controller is further configured to use the force feedback provided by the contact sensors embedded in the end effector to adapt control of the robotic arm to facilitate at least one of a positioning task or a force application task.

6. The robotic massage system of claim 5, wherein the force application task comprises applying an intended amount of force to the deformable body.

7. The robotic massage system of claim 5, wherein the positioning task comprises positioning of an intended portion of the end effector relative to an intended portion of the deformable body.

8. The robotic massage system of claim 5, wherein adapting control of the robotic arm includes providing torque commands based at least in part on the force feedback.

9. The robotic massage system of claim 1, wherein a pressure map is determined based on the contact patch.

10. The robotic massage system of claim 1, wherein a feature of the deformable body is identified based on the force feedback provided by the plurality of contact sensors embedded in the end effector.

11. A method, comprising:
controlling a robotic arm to engage a deformable body with an end effector positioned at an end of the robotic arm;
receiving force feedback provided by a plurality of contact sensors embedded in the end effector; and
determining a contact patch where the end effector is contacting the deformable body based at least in part on the force feedback provided by the plurality of contact sensors embedded in the end effector.

12. The method of claim 11, wherein the force feedback is used to determine a spatial map of forces detected across the end effector as a result of engaging of the deformable body with the end effector.

13. The method of claim 12, wherein the contact patch is determined using the spatial map of measured forces detected across the end effector.

14. The method of claim 12, wherein the contact patch comprises locations on the end effector for which measured forces in the spatial map of measured forces exceed a threshold force value.

15. The method of claim 11, further comprising using the force feedback provided by the contact sensors embedded in the end effector to adapt control of the robotic arm to facilitate at least one of a positioning task or a force application task.

16. The method of claim 15, wherein the force application task comprises applying an intended amount of force to the deformable body.

17. The method of claim 15, wherein the positioning task comprises positioning of an intended portion of the end effector relative to an intended portion of the deformable body.

18. The method of claim 15, wherein adapting control of the robotic arm includes providing torque commands based at least in part on the force feedback.

19. The method of claim 11, wherein a pressure map is determined based on the contact patch.

20. The method of claim 11, wherein a feature of the deformable body is identified based on the force feedback provided by the plurality of contact sensors embedded in the end effector.
